(19) United States
(12) Patent Application Publication
(10) Pub. No.: US 2026/0054585 A1
(43) Pub. Date: Feb. 26, 2026

(54) ELECTRIFIED VEHICLE

(71) Applicants: HYUNDAI MOTOR COMPANY, Seoul (KR); KIA CORPORATION, Seoul (KR); Seoul National University R&DB Foundation, Seoul (KR)

(72) Inventors: Yoo Jong Lee, Hwaseong-si (KR); Yong Jae Lee, Hwaseong-si (KR); Woo Young Kang, Hwaseong-si (CN); Gyu Cheol Lim, Seoul (KR); Junhyuk Yang, Seoul (KR); Cheolmin Hwang, Seoul (KR); Jung-lk Ha, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 19/228,548

(22) Filed: Jun. 4, 2025

(30) Foreign Application Priority Data
Aug. 23, 2024 (KR) 10-2024-0113798

(51) Int. Cl. B60L 53/24; B60L 15/00; B60L 50/60; B60L 53/62; B60L 58/22; H02J 1/10; H02M 7/539

(52) U.S. Cl. CPC B60L 53/24; B60L 15/007; B60L 50/60; B60L 53/62; B60L 58/22; H02J 1/10; H02M 7/539

(57) ABSTRACT

Disclosed is an electrified vehicle including a motor, a first inverter, a second inverter, a first battery, and a second battery. The electrified vehicle also includes a charging terminal, and a controller that controls switching states of the first inverter and the second inverter based on voltages and charging current commands of the first battery and the second battery and a maximum charging voltage applicable to the charging terminal such that the first battery and the second battery are charged.

### CROSS-REFERENCE TO THE RELATED APPLICATION

This application claims priority from Korean Patent Application No. 10-2024-0113798, filed on Aug. 23, 2024, in the Korean Intellectual Property Office, the disclosure of which is incorporated herein by reference in its entirety.

### TECHNICAL FIELD

The present disclosure relates to an electrified vehicle having multiple batteries connected to a dual inverter.

### BACKGROUND

Recently, with the increasing interest in the environment, eco-friendly vehicles equipped with electric motors as a power source are on the rise. Eco-friendly vehicles are also called electric vehicles, and representative examples include hybrid vehicles (HEVs) and electric vehicles (EVs).

For small or light electric vehicles, cost competitiveness is considered, and cost reduction of not only high-voltage batteries but also power electronics (PE) components is also considered. Among high-voltage power electronics components, an expensive component is the high-voltage battery, and the price of power electronics components can be reduced by minimizing the capacity of the high-voltage battery. However, if the capacity of the high-voltage battery is reduced, not only does the range of the electric vehicle decrease, but also the output of the motor and inverter decreases.

Therefore, a motor drive system having multiple independent batteries as a voltage source may be useful.

The matters described as background technology above are intended to enhance understanding of the background of the present disclosure and should not be taken as an acknowledgment that they correspond to prior art already known to those skilled in the art.

### SUMMARY

An object of the present disclosure is to provide an electrified vehicle capable of charging (e.g., all of) a plurality of batteries connected to a dual inverter by controlling a switching state of the dual inverter (e.g., even) when charging conditions of the plurality of batteries are different.

The object of the present disclosure is not limited to the object mentioned above, and other tasks not mentioned may be understood by those skilled in the art from the description below.

In accordance with an aspect of the present disclosure, the above and other objects may be accomplished by the provision of an electrified vehicle including a motor having a plurality of windings corresponding to a first phase, a second phase, and a third phase, a first inverter having a first DC link and a plurality of legs connected to one end of (e.g., each of) the plurality of windings, a second inverter having a second DC link and a plurality of legs connected to the other end (e.g., of each) of the plurality of windings, a first battery and a second battery respectively connected to the first DC link and the second DC link, a charging terminal having one electrode connected to one electrode of the first DC link and another electrode connected to one electrode of the second DC link, and a controller configured to control switching states of the first inverter and the second inverter based on voltages and charging current commands of the first battery and the second battery, and a maximum charging voltage applicable to the charging terminal such that the first battery and the second battery are charged.

For example, the controller may control the switching states of the first inverter and the second inverter based on relationships between the voltages of the first battery and the second battery and the maximum charging voltage.

For example, the controller may control the switching states based on first charging power of the first battery, second charging power of the second battery, and a constant for the second charging power when both the voltages of the first battery and the second battery are equal to or higher than the maximum charging voltage, wherein the first charging power may be determined according to the voltage and charging current command of the first battery, and the second charging power may be determined according to the voltage and charging current command of the second battery.

For example, the controller may control the switching states such that the first phase and the second phase charge only the second battery, and the third phase charges the first battery and the second battery in equal proportions when a condition expressed by P₁*<P_{2*}/a, is satisfied, wherein P₁* is the first charging power, P₂* is the second charging power, and a is a constant for the second charging power.

For example, the controller may control the switching states such that the first phase charges only the first battery, the second phase charges only the second battery, and the third phase charges the first battery and the second battery in equal proportions when a condition expressed by P_{2*}/a≤P₁*<aP₂* is satisfied, wherein P₁* is the first charging power, P₂* is the second charging power, and a is a constant for the second charging power.

For example, the controller may control the switching states such that the first phase and the second phase charge only the first battery, and the third phase charges the first battery and the second battery in equal proportions when a condition according to mathematical expression 3 expressed by aP₂*≤P₁*is satisfied, wherein P₁* is the first charging power, P₂* is the second charging power, and a is a constant for the second charging power.

For example, the controller may control the switching states on the basis the first charging power of the first battery, the second charging power of the second battery, and a voltage parameter for the second charging power when the voltage of the first battery is equal to or higher than the maximum charging voltage and the voltage of the second battery is less than the maximum charging voltage, wherein the first charging power may be determined according to the voltage and charging current command of the first battery, and the second charging power may be determined according to the voltage and charging current command of the second battery.

For example, the controller may control the switching states such that the first phase, the second phase, and the third phase charge both the first battery and the second battery with a proportion of charging the second battery being greater than a proportion of charging the first battery when a condition expressed by P₁*<((Vₘₐₓ−V₂)/V₂)P₂* is satisfied, wherein P₁* is the first charging power, P₂* is the second charging power, (Vₘₐₓ−V₂)/V₂ is the voltage parameter for the second charging power, Vₘₐₓ is the maximum charging voltage, and V₂ is the voltage of the second battery.

For example, the controller may control the switching states such that the first phase, the second phase, and the third phase charge both the first battery and the second battery, the first phase and the second phase charge the second battery in a greater proportion than a proportion of charging the first battery, and the third phase charges the first battery and the second battery in equal proportions when a condition according to mathematical expression 5 expressed by ((Vₘₐₓ−V₂)/V₂)P₂*≤P₁*<((bVₘₐₓ−V₂)/V₂)P₂* is satisfied, wherein P₁* is the first charging power, P₂* is the second charging power, (Vₘₐₓ−V₂)/V₂ and (bVₘₐₓ−V₂)/V₂ are voltage parameters for the second charging power, Vₘₐₓ is the maximum charging voltage, V₂ is the voltage of the second battery, and b is a constant.

For example, the controller may control the switching states such that the first phase charges only the first battery, the second phase and the third phase charge both the first battery and the second battery, the second phase charges the second battery in a greater proportion than a proportion of charging the first battery, and the third phase charges the first battery and the second battery in equal proportions when a condition expressed by ((bVₘₐₓ−V₂)/V₂)P₂*≤P₁*<((cVₘₐₓ−V₂)/V₂)P₂* is satisfied, wherein P₁* is the first charging power, P₂* is the second charging power, (bVₘₐₓ−V₂)/V₂ and (cVₘₐₓ−V₂)/V₂ are voltage parameters for the second charging power, Vₘₐₓ is the maximum charging voltage, V₂ is the voltage of the second battery, b and c are constants, and c is a value greater than b.

For example, the controller may control the switching states such that the first phase and the second phase charge only the first battery, and the third phase charges the first battery and the second battery in equal proportions when a condition expressed by. ((cVₘₐₓ−V₂)/V₂)P₂*≤P₁*is satisfied, wherein P₁* is the first charging power, P₂* is the second charging power, (cVₘₐₓ−V₂)/V₂ is voltage parameters for the second charging power, Vₘₐₓ is the maximum charging voltage, V₂ is the voltage of the second battery, and c is a constant.

For example, the controller may control the switching states based on the first charging power of the first battery, the second charging power of the second battery, and a voltage parameter for the second charging power when both the voltage of the first battery and the voltage of the second battery are equal to or less than the maximum charging voltage, and a sum of the voltages of the first battery and the second battery is equal to or higher than the maximum charging voltage, wherein the first charging power may be determined according to the voltage and charging current command of the first battery, and the second charging power may be determined according to the voltage and charging current command of the second battery.

For example, the controller may control the switching states such that the first phase, the second phase, and the third phase charge both the first battery and the second battery with a proportion of charging the second battery being greater than a proportion of charging the first battery when a condition expressed by P₁*≤((Vₘₐₓ−V₂)/V₂)P₂* is satisfied, wherein P₁* is the first charging power, P₂* is the second charging power, (Vₘₐₓ−V₂)/V₂ is a voltage parameter for the second charging power, Vₘₐₓ is the maximum charging voltage, and V₂ is the voltage of the second battery.

For example, the controller may control the switching states such that the first phase, the second phase, and the third phase charge both the first battery and the second battery, the first phase and the second phase charge the second battery in a greater proportion than a proportion of charging the first battery, and the third phase charges the first battery and the second battery in equal proportions when a condition according to mathematical expression 9 expressed by ((Vₘₐₓ−V₂)/V₂)P₂*≤P₁*<((dVₘₐₓ+V₁−dV₂)/(Vₘₐₓ−V₁+dV₂))P₂* is satisfied, wherein P₁* is the first charging power, P₂* is the second charging power, (Vₘₐₓ−V₂)/V₂ and (dVₘₐₓ+V₁−dV₂)/(Vₘₐₓ−V₁+dV₂) are voltage parameters for the second charging power, Vₘₐₓ is the maximum charging voltage, V₁ is the voltage of the first battery, V₂ is the voltage of the second battery, and d is a constant.

For example, the controller may control the switching states such that the first phase, the second phase, and the third phase charge both the first battery and the second battery, the first phase charges the second battery in a greater proportion than a proportion of charging the first battery, the second phase charges the first battery in a greater proportion than a proportion of charging the second battery, and the third phase charges the first battery and the second battery in equal proportions when a condition expressed by ((dVₘₐₓ+V₁−dV₂)/(Vₘₐₓ−V₁+dV₂))P₂*≤P₁*<((Vₘₐₓ+dV₁−V₂)/(dVₘₐₓ−dV₁+V₂))P₂* is satisfied, wherein P₁* is the first charging power, P₂* is the second charging power, (dVₘₐₓ+V₁−dV₂)/(Vₘₐₓ−V₁+dV₂) and (Vₘₐₓ+dV₁−V₂)/(dVₘₐₓ−dV₁+V₂) are voltage parameters for the second charging power, Vₘₐₓ is the maximum charging voltage, V₁ is the voltage of the first battery, V₂ is the voltage of the second battery, and d is a constant.

For example, the controller may control the switching states such that the first phase, the second phase, and the third phase charge both the first battery and the second battery are charged, the first phase and the second phase charge the first battery in a greater proportion than a proportion of charging the second battery, and the third phase charges the first battery and the second battery in equal proportions when a condition according to mathematical expression 11 expressed by ((Vₘₐₓ+dV₁−V₂)/(dVₘₐₓ−dV₁+V₂))P₂*≤P₁*<(V₁/(Vₘₐₓ−V₁))P₂* is satisfied, wherein P₁* is the first charging power, P₂* is the second charging power, (Vₘₐₓ+dV₁−V₂)/(dVₘₐₓ−dV₁+V₂) and V₁/(Vₘₐₓ−V₁) are voltage parameters for the second charging power, Vₘₐₓ is the maximum charging voltage, V₁ is the voltage of the first battery, V₂ is the voltage of the second battery, and d is a constant.

For example, the controller may control the switching states such that the first phase, the second phase, and the third phase charge both the first battery and the second battery with a proportion of charging the first battery being greater than a proportion of charging the second battery when a condition expressed by (V₁/(Vₘₐₓ−V₁))P₂*≤P₁* is satisfied, wherein P₁* is the first charging power, P₂* is the second charging power, V₁/(Vₘₐₓ−V₁) is a voltage parameter for the second charging power, Vₘₐₓ is the maximum charging voltage, V₁ is the voltage of the first battery, and V₂ is the voltage of the second battery.)

For example, the controller may control the switching states based on the charging current commands of the first battery and the second battery when both the voltage of the first battery and the voltage of the second battery are equal to or less than the maximum charging voltage, and the sum of the voltage of the first battery and the voltage of the second battery is equal to or less than the maximum charging voltage.

For example, the controller may control the switching states such that the first phase, the second phase, and the third phase charge both the first battery and the second battery with a proportion of charging the first battery being greater than a proportion of charging the second battery when a value of the charging current command of the first battery is equal to or greater than a value of the charging current command of the second battery.

For example, the controller may control the switching states such that the first phase, the second phase, and the third phase charge both the first battery and the second battery with a proportion of charging the second battery being greater than a proportion of charging the first battery when the value of the charging current command of the first battery is less than the value of the charging current command of the second battery.

### BRIEF DESCRIPTION OF THE DRAWINGS

The above and other objects, features and other advantages of the present disclosure will be understood from the following detailed description taken in conjunction with the accompanying drawings, in which:

FIG. 1 is a diagram showing a configuration of an electrified vehicle according to an embodiment of the present disclosure; and

FIGS. 2A, 2B, 3A, 3B, 4A, 4B, 4C, 5A, 5B, 6A, 6B, 7A, 7B, 7C, 8A, 8B, 9A, 9B, 10A, 10B, 10C, 11A, 11B, 12A, 12B, 13A, 13B, 14A, 14B, 15A, 15B, 16A, 16B, 16C, 16D, 17A, 17B, 18A, 18B, 19A, 19B, 19C, 19D, 20A, 20B, 21A, 21B, 22A, 22B, 22C, 22D, 23A, 23B, 24A, 24B, 25A, 25B, 26A, 26B, 27A, 27B, 28A, 28B, 28C, 28D, 29A, 29B, 30A, 30B, 31A, 31B, 31C, 31D, 32A, 32B, 33A, 33B, 34A, 34B, 34C, 34D, 35A, 35B, 36A, 36B, 37A, 37B, 38A, 38B, 39A, 39B, 40A, 40B, 41A, 41B, 42A, 42B, 43A, and 43B are diagrams for describing switching state control methods for battery charging according to an embodiment of the present disclosure.

### DETAILED DESCRIPTION

Specific structural and functional descriptions of the embodiments of the present disclosure, disclosed in the present application, are illustrative for the purpose of explaining the embodiments according to the present disclosure, and the embodiments according to the present disclosure may be implemented in various forms and should not be construed as being limited to the embodiments described in this application.

Since the embodiments according to the present disclosure can be modified in various manners and have various forms, specific embodiments will be illustrated in the drawings and described in detail in the application. However, this is not intended to limit the embodiments according to the concept of the present disclosure to a specific disclosed form, and should be understood to include (e.g., all) changes, equivalents, and substitutes included in the spirit and technical scope of the present disclosure.

Terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, the same or similar components will be assigned the same reference numeral, and redundant descriptions thereof will be omitted.

In the description of the following embodiments, the term “preset” discloses that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit or part” used to signify components are used herein to help the understanding of the components and thus should not be considered as having specific meanings or roles.

In the following description of the embodiments disclosed in the present application, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to distinguish one component from another component.

When a component is “coupled” or “connected” to another component, it should be understood that a third component may be present between the two components although the component may be (e.g., directly) coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) may be used in naming a control device that controls specific vehicle functions and may not mean a generic functional unit.

A controller may include a communication device that communicates with other controllers or sensors to control the functions of the controller, a memory that stores an operating system, logic instructions, input/output information, or the like, and one or more processors that perform determination, computation, and decisions (e.g., necessary) to control the functions.

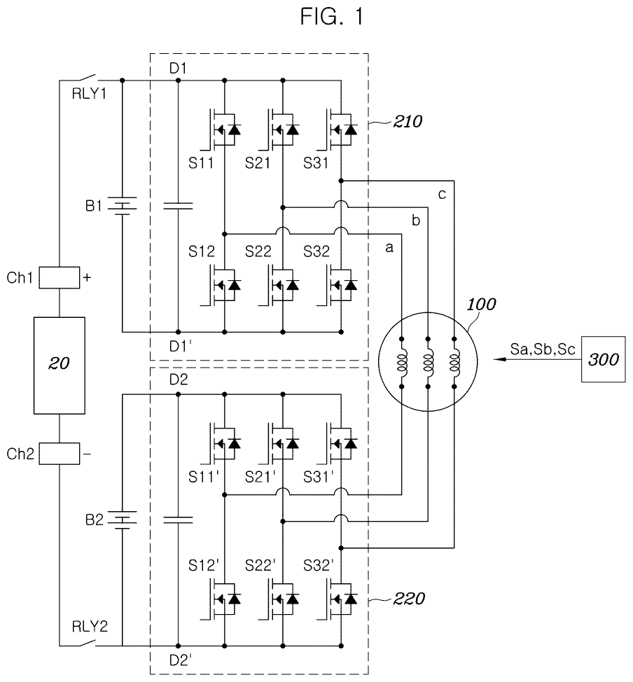

Referring to FIG. 1, an electrified vehicle according to an embodiment of the present disclosure includes a motor 100, a first inverter 210, a second inverter 220, a first battery B1, a second battery B2, a charging terminal Ch1 and Ch2, and a controller 300.

Referring to FIG. 1, the motor 100 has a plurality of windings corresponding to a first phase a, a second phase b, and a third phase c. The first inverter 210 has a first DC link D1 and D1′ and a plurality of legs S11-S12, S21-S22, and S31-S32 connected to one end of each of the plurality of windings, and the second inverter 220 has a second DC link D2 and D2′ and a plurality of legs S11′-S12′, S21′-S22′, and S31′-S32′ connected to the other end of each of the plurality of windings. The legs are connected to top switching elements S11, S21, S31, S11′, S21′, and S31′ and bottom switching elements S12, S22, S32, S12′, S22′, and S32′, and each element may be implemented as a transistor such as a metal-oxide-semiconductor field effect transistor (MOSFET) or an insulated gate bipolar transistor (IGBT).

The charging terminal Ch1 and Ch2 may have one electrode Ch1 connected to one electrode D1 of the first DC link D1 and D1′, and the other electrode Ch2 connected to one electrode D2′ of the second DC link D2 and D2′. An external charger 20 may be connected to the charging terminal Ch1 and Ch2 to apply a charging voltage, and in this case, relays RLY1 and RLY2 may be provided between the charging terminal Ch1 and Ch2 and the first DC link D1 and the second DC link D2′.

The first battery B1 is connected to the first DC link D1 and D1′, the second battery B2 is connected to the second DC link D2 and D2′, and the first battery B1 and the second battery B2 may be charged by the charging voltage applied to the charging terminal Ch1 and Ch2. In this case, the first battery B1 and the second battery B2 may be charged independently, for example, only the first battery B1 may be charged, or only the second battery B2 may be charged. In addition, the first battery B1 and the second battery B2 may be different types and have different specifications, and thus may have different voltages.

The controller 300 may control switching states of the first inverter 210 and the second inverter 220 based on voltages and charging current commands of the first battery B1 and the second battery B2 and a maximum charging voltage applicable to the charging terminal Ch1 and Ch2, thereby charging the first battery B1 and the second battery B2.

In an embodiment, the controller 300 may be implemented as a motor control unit (MCU) and may be connected to a battery management system (BMS) equipped in the vehicle to obtain the voltages and charging current commands of the first battery B1 and the second battery B2. Alternatively, the controller 300 may be implemented as a high-level controller such as a vehicle control unit (VCU) or a hybrid control unit (HCU) having the functions of the motor control unit (MCU) and the battery management system (BMS). In addition, the maximum charging voltage is a maximum value of a charging voltage applicable to the charging terminal Ch1 and Ch2, and the value thereof may be determined according to the specifications of the external charger connected to the charging terminal. The controller 300 may obtain the maximum charging voltage, for example, through communication with the external charger.

Switching state control of the first inverter 210 and the second inverter 220 may be performed by controlling on/off of the top switching elements and the bottom switching elements of the legs S11-S12, S21-S22, S31-S32, S11′-S12′, S21′-S22′, and S31′-S32′ included in the first inverter 210 and the second inverter 220 through switching signals Sa, Sb, and Sc for respective phases. In this case, the controller 300 controls the currents flowing through the phases a, b, and c such that they have the same value, thereby preventing rotation of the connected motor 100 while the first battery B1 and the second battery B2 are being charged through the first inverter 210 and the second inverter 220.

According to the aforementioned electrified vehicle, even when the charging conditions of the first battery B1 and the second battery B2 serving as a dual voltage source in a dual inverter structure having a dual voltage source are different, both the first battery B1 and the second battery B2 can be charged with a single power source, and accordingly, it may perform battery charging with (e.g., optimal) efficiency in various charging scenarios according to the charging conditions of the first battery B1 and the second battery B2.

Here, the charging conditions of the first battery B1 and the second battery B2 may be determined according to voltages of the first and second batteries B1 and B2, charging current commands, and the relationship between the voltages and the maximum charging voltage.

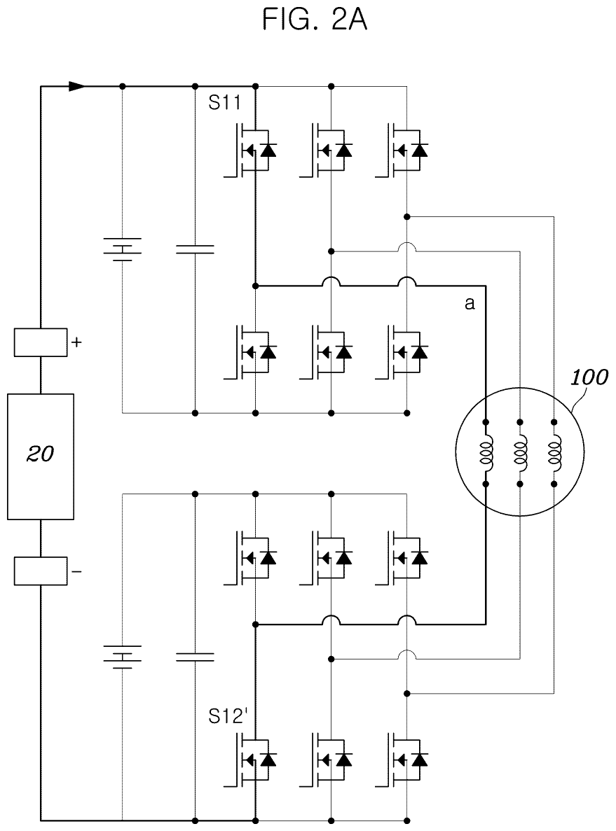

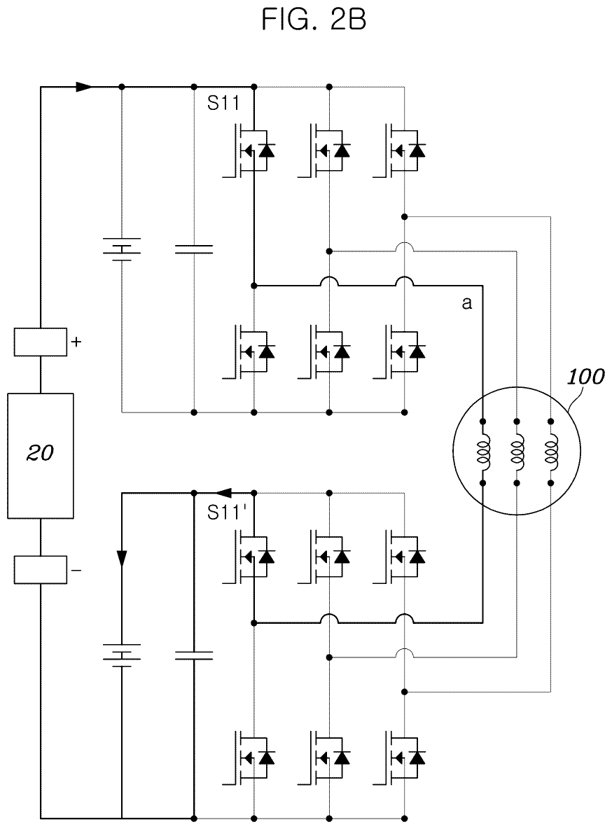

Hereinafter, specific control methods for (e.g., efficiently) charging both the first battery B1 and the second battery B2, in cases where the charging conditions of the first battery B1 and the second battery B2 are different, will be described with reference to FIG. 2A to FIG. 43B.

FIG. 2A to FIG. 43B are diagrams for describing switching state control methods for battery charging according to an embodiment of the present disclosure.

The controller 300 may control switching states of the first inverter 210 and the second inverter 220 based on the relationship between the voltage of each of the first battery B1 and the second battery B2 and the maximum charging voltage. A control method in each charging scenario will be described below with reference to FIG. 2A to FIG. 43B.

### Charging Scenario 1

The controller 300 may control switching states based on first charging power of the first battery B1, second charging power of the second battery B2, and a constant for the second charging power when the voltages of the first battery B1 and the second battery B2 are both equal to or higher than the maximum charging voltage. In this case, the first charging power is determined according to the voltage and charging current command of the first battery B1, the second charging power is determined according to the voltage and charging current command of the second battery B2, and each charging power may be calculated by multiplying the voltage each battery B1 and B2 by the charging current thereof.

### Charging Scenario 1-1

In this case, the controller 300 may control the switching states of the first inverter 210 and the second inverter 220 such that the first phase a and the second phase b charge only the second battery B2 and the third phase c charges the first battery B1 and the second battery B2 in equal proportions when the condition according to mathematical expression 1 below is satisfied.

### Mathematical Expression 1

$${P}_{1}^{⋆} < {P}_{2}^{⋆} / a$$

Here, P₁* denotes the first charging power, P₂* denotes the second charging power, and a denotes a constant for the second charging power, and may be, for example, “2”.

The switching state control method for this case is illustrated in FIG. 2A to FIG. 4C.

The controller 300 may control the switching states such that turn-on of the top switching element S11 of the first inverter 210 is maintained and the top switching element S11′ and the bottom switching element S12′ of the second inverter 220 are turned on and turned off complementarily, and thus the first phase a charges only the second battery B2, as illustrated in FIG. 2A and FIG. 2B.

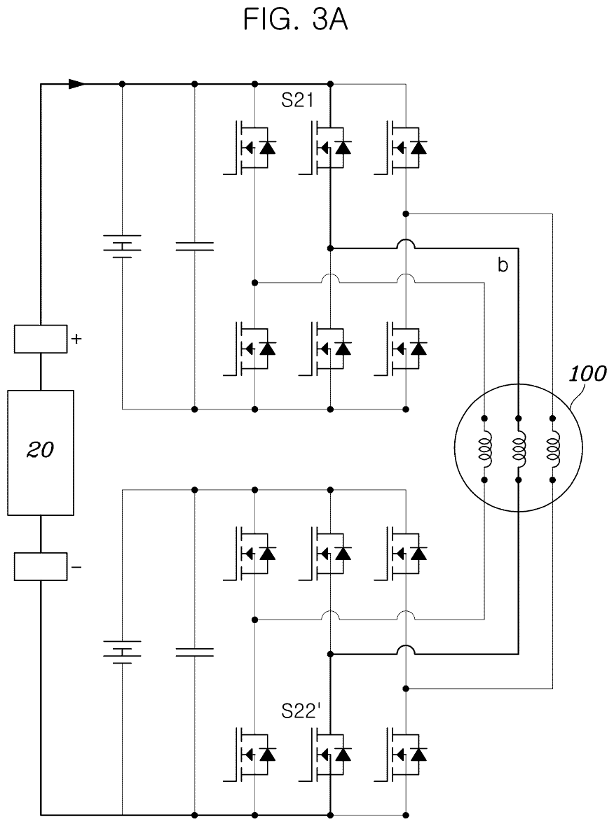

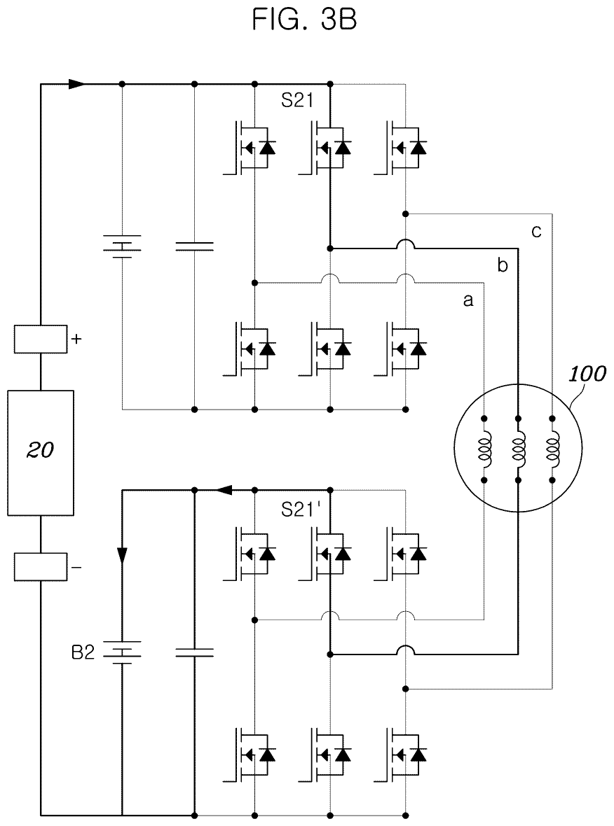

The controller 300 may control the switching states such that turn-on of the top switching element S21 of the first inverter 210 is maintained, and the top switching element S21′ and the bottom switching element S22′ of the second inverter 220 are turned on and turned off complementarily, and thus the second phase b charges only the second battery B2, as illustrated in FIG. 3A and FIG. 3B.

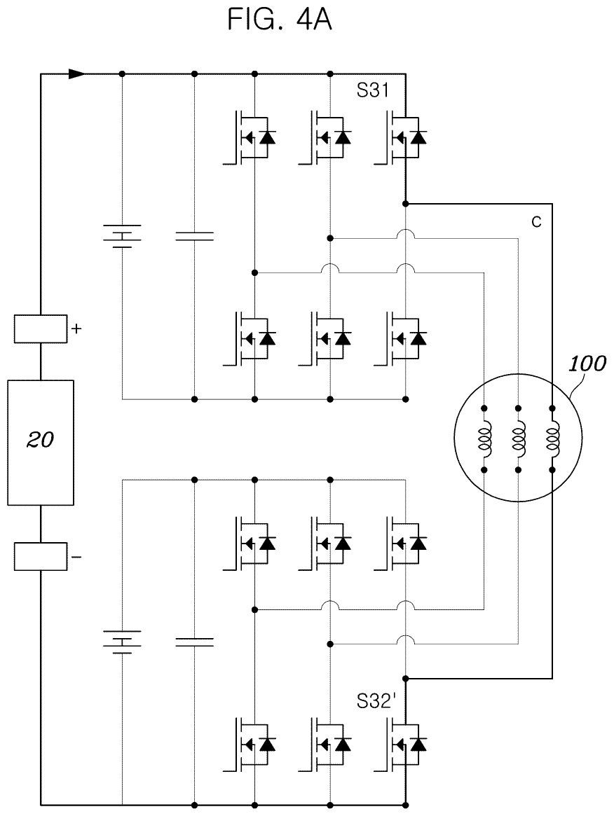

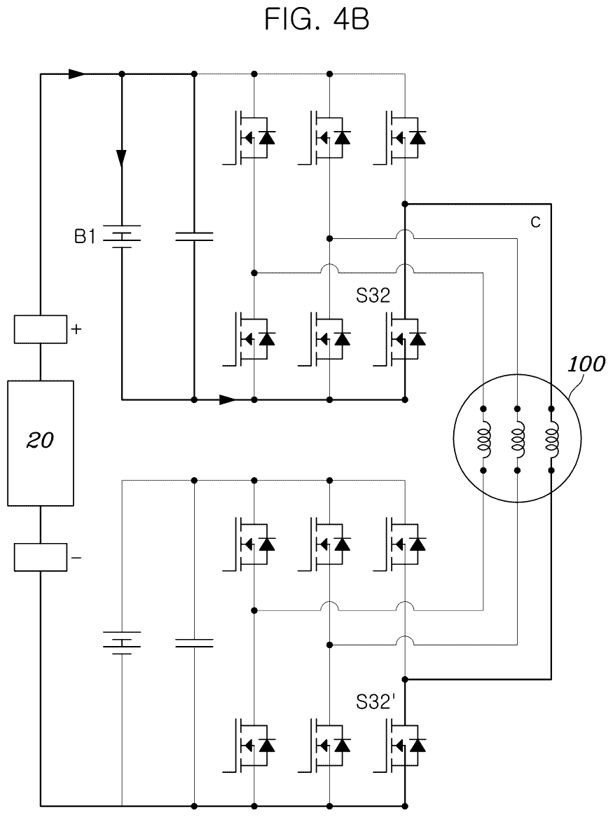

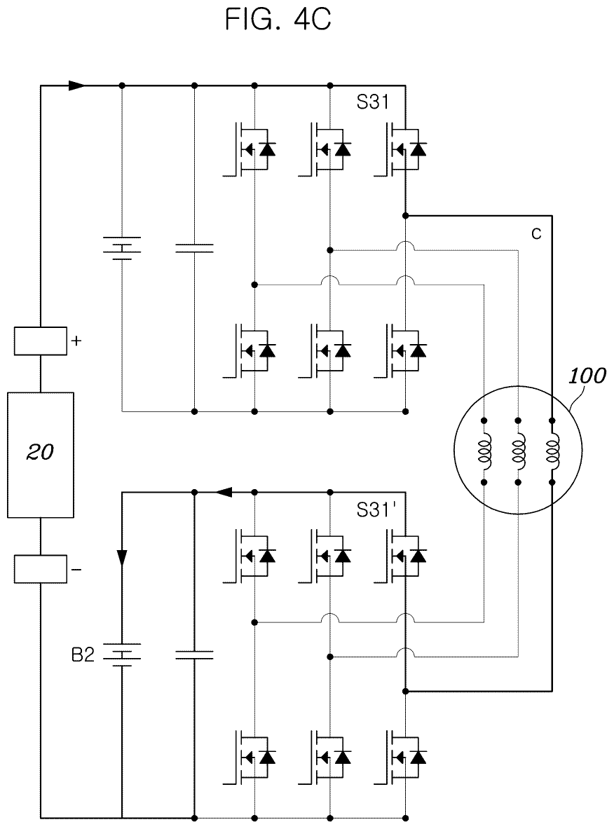

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, and a turn-on state of the top switching element S31 of the first inverter 210 and the top switching element S31′ of the second inverter 220 are repeated, and thus the third phase c charges the first battery B1 and the second battery B2 in equal proportions, as illustrated in FIG. 4A, FIG. 4B and FIG. 4C.

According to the above control, even if the charging conditions of the first battery B1 and the second battery B2 are different, both the first battery B1 and the second battery B2 can be charged by switching only eight elements per cycle.

### Charging Scenario 1-2

In this case, the controller 300 may control the switching states of the first inverter 210 and the second inverter 220 such that the first phase a charges only the first battery B1, the second phase b charges only the second battery B2, and the third phase c charges the first battery B1 and the second battery B2 in equal proportions when the condition according to mathematical expression 2 below is satisfied.

### Mathematical Expression 2

$${P}_{2}^{⋆} / a \leq {P}_{1}^{⋆} < {aP}_{2}^{⋆}$$

Here, P₁* denotes the first charging power, P₂* denotes the second charging power, and a denotes a constant for the second charging power, and may be, for example, “2”.

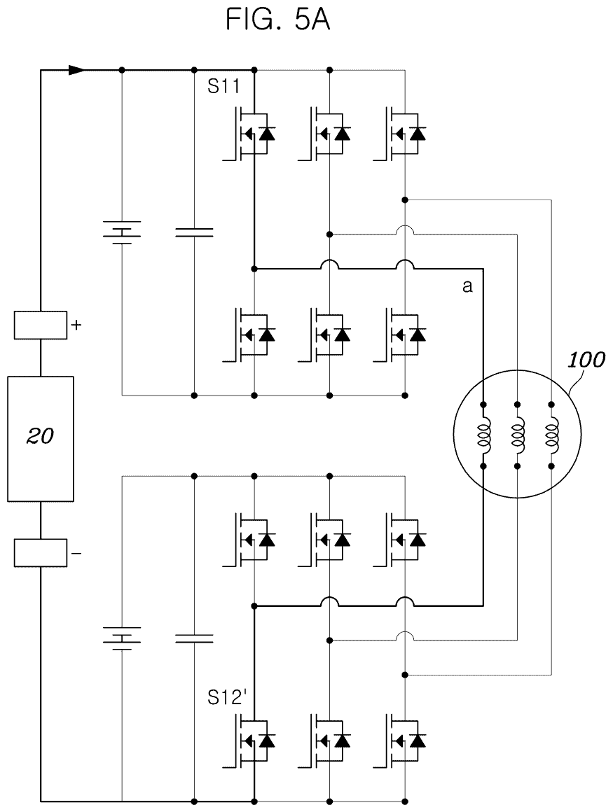

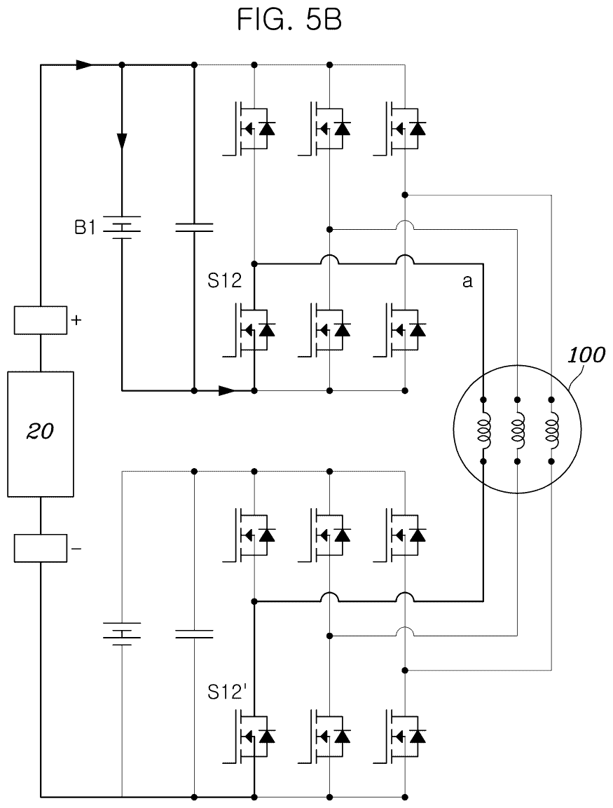

The switching state control method for this case is illustrated in FIG. 5A to FIG. 7C.

The controller 300 may control the switching states such that the top switching element S11 and the bottom switching element S12 of the first inverter 210 are turned on and turned off complementarily, and turn-on of the bottom switching element S12′ of the second inverter 220 is maintained, and thus the first phase a charges only the first battery B1, as illustrated in FIG. 5A and FIG. 5B.

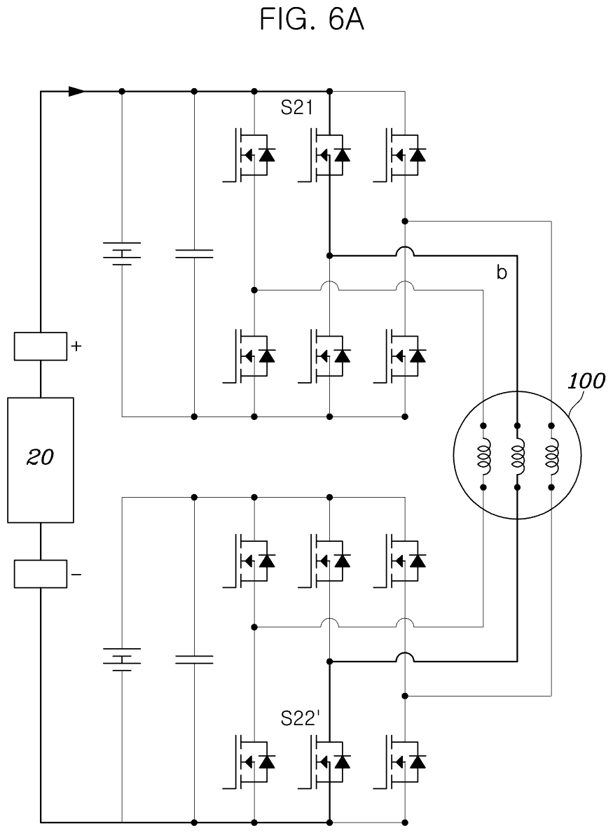

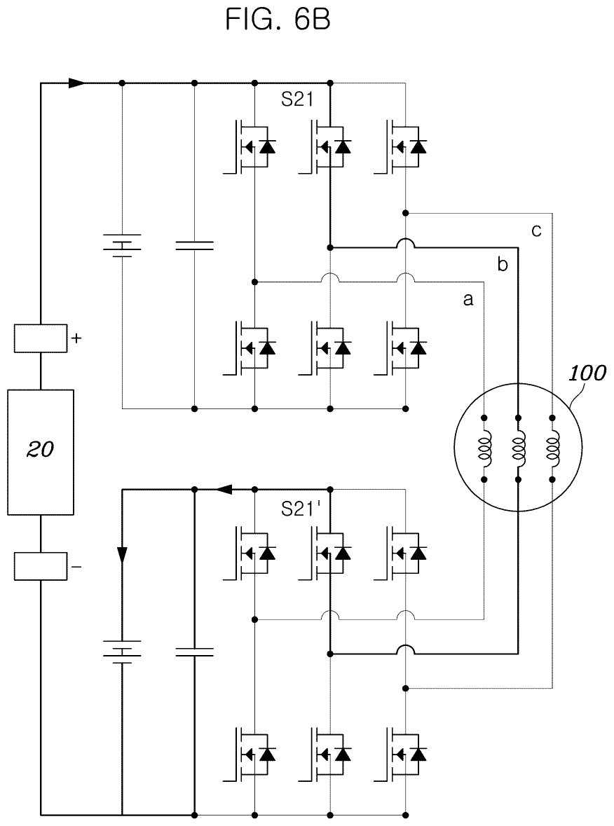

The controller 300 may control the switching states such that turn-on of the top switching element S21 of the first inverter 210 is maintained, and the top switching element S21′ and the bottom switching element S22′ of the second inverter 220 are turned on and turned off complementarily, and thus the second phase b charges only the second battery B2, as illustrated in FIG. 6A and FIG. 6B.

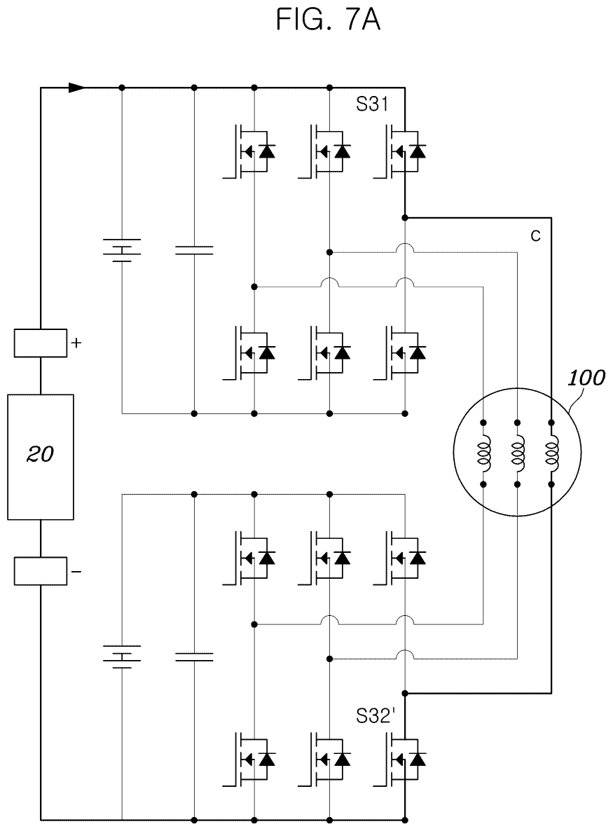

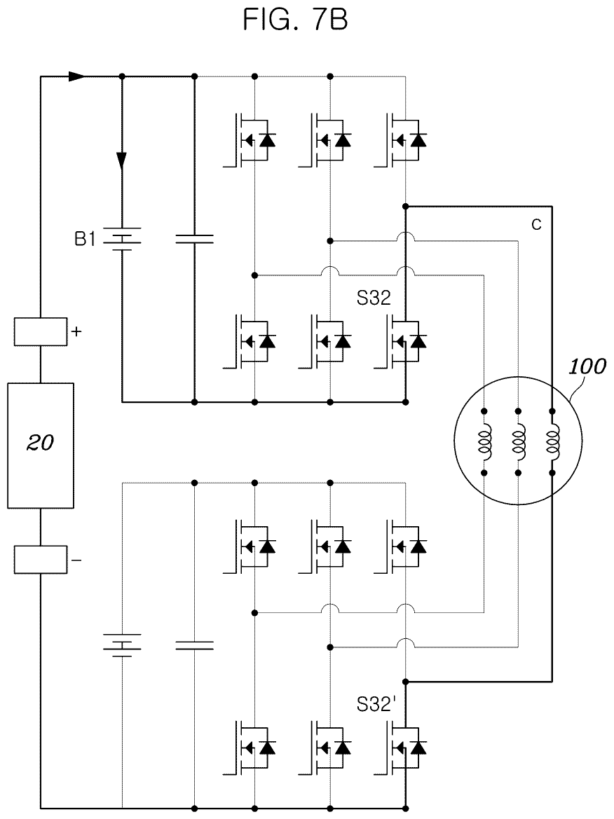

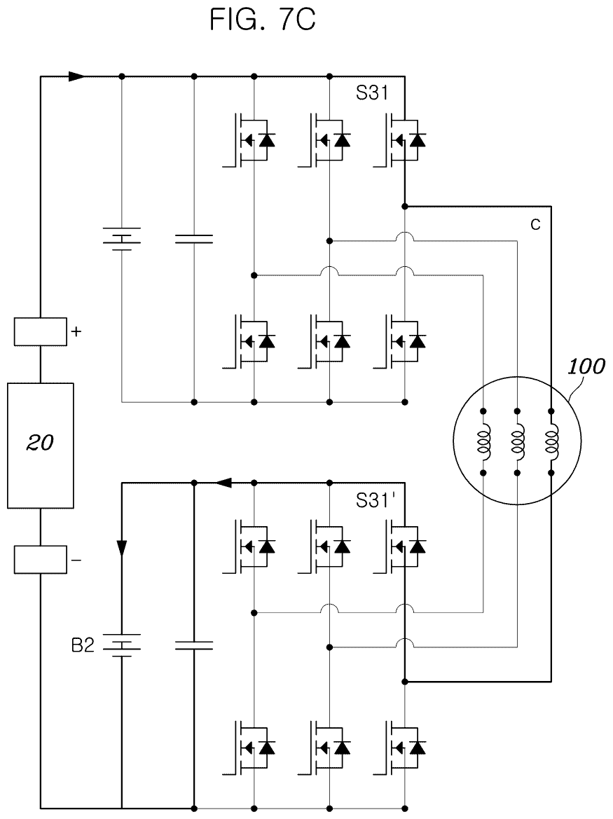

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, and a turn-on state of the top switching element S31 of the first inverter 210 and the top switching element S31′ of the second inverter 220 are repeated, and thus the third phase c charges the first battery B1 and the second battery B2 in equal proportions, as illustrated in FIG. 7A, FIG. 7B and FIG. 7C.

In the case of the control as above, even if the charging conditions of the first battery B1 and the second battery B2 are different, both the first battery B1 and the second battery B2 can be charged by switching only eight elements per cycle.

### Charging Scenario 1-3

The controller 300 may control the switching states of the first inverter 210 and the second inverter 220 such that the first phase a and the second phase b charge only the first battery B1, and the third phase c charges the first battery B1 and the second battery B2 in equal proportions when the condition according to mathematical expression 3 below is satisfied.

### Mathematical Expression 3

$${aP}_{2}^{⋆} \leq {P}_{1}^{⋆}$$

Here, P₁* denotes the first charging power, P₂* denotes the second charging power, and a denotes a constant for the second charging power, and may be, for example, “2”.

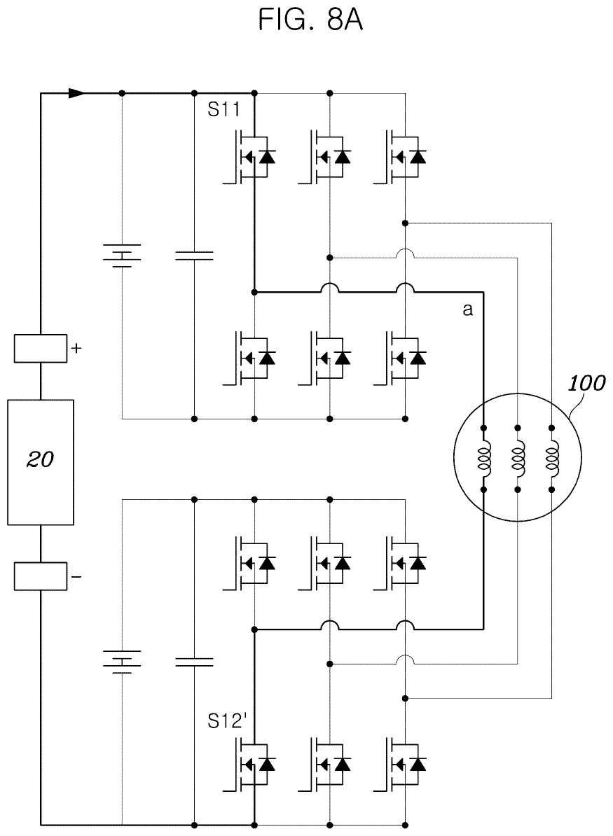

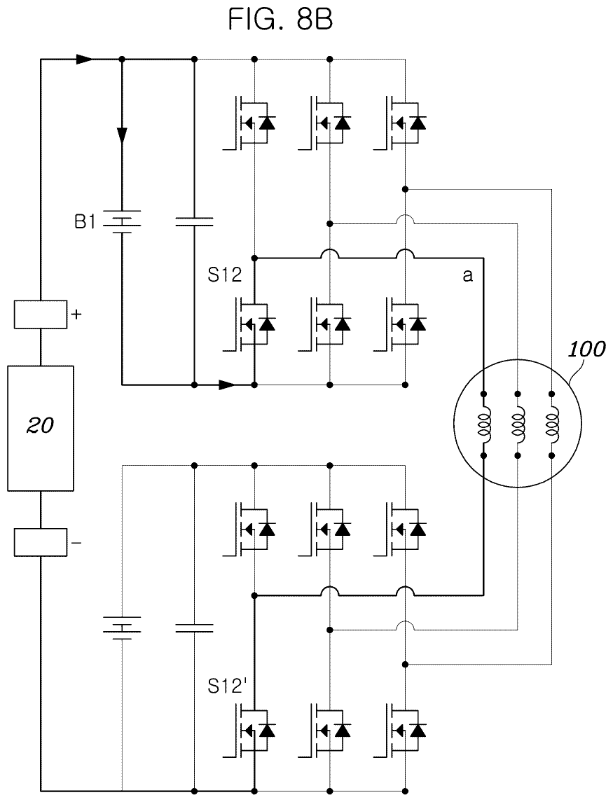

The switching state control method for this case is illustrated in FIG. 8A to FIG. 10C.

As illustrated in FIG. 8A and FIG. 8B, the controller 300 may control the switching states such that the top switching element S11 and the bottom switching element S12 of the first inverter are turned on and turned off complementarily, and turn-on of the bottom switching element S12′ of the second inverter 220 is maintained, and thus the first phase a charges only the first battery B1.

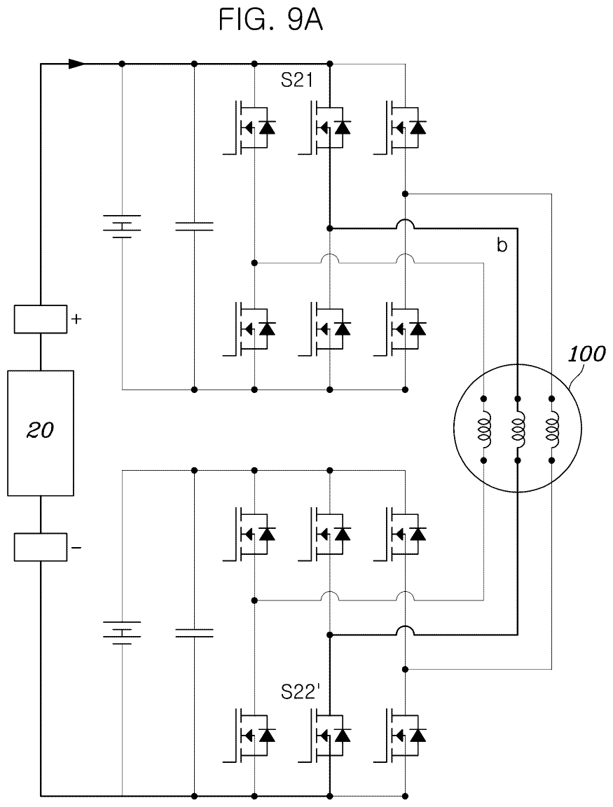

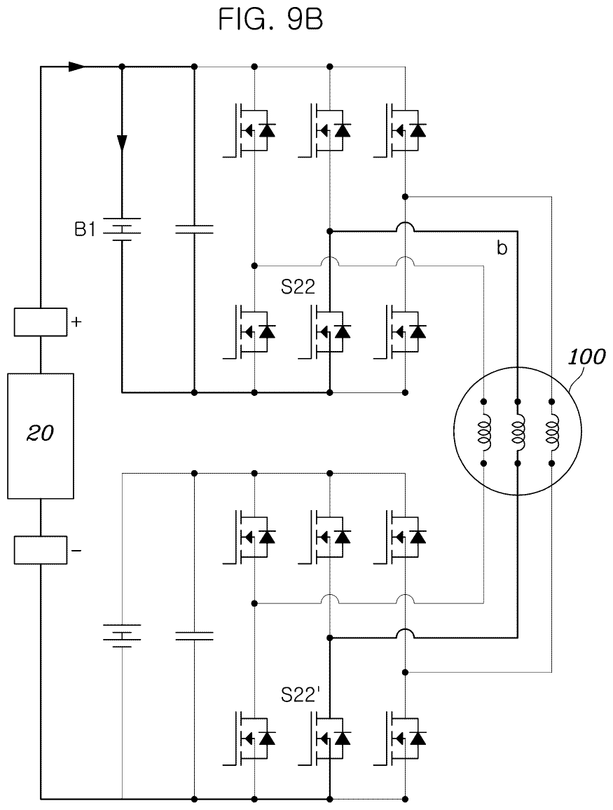

The controller 300 may control the switching states such that the top switching element S21 and the bottom switching element S22 of the first inverter 210 are turned on and turned off complementarily, and turn-on of the bottom switching element S22′ of the second inverter 220 is maintained, and thus the second phase b charges only the first battery B1, as illustrated in FIG. 9A and FIG. 9B.

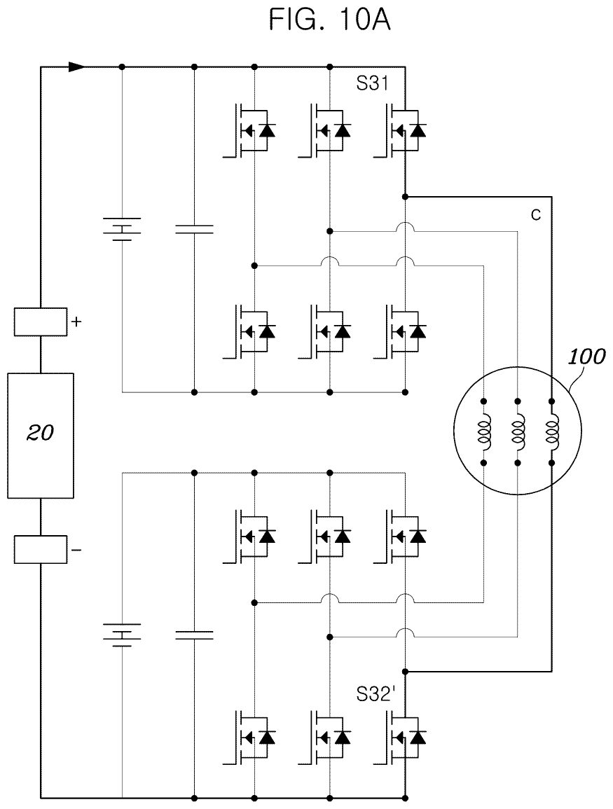

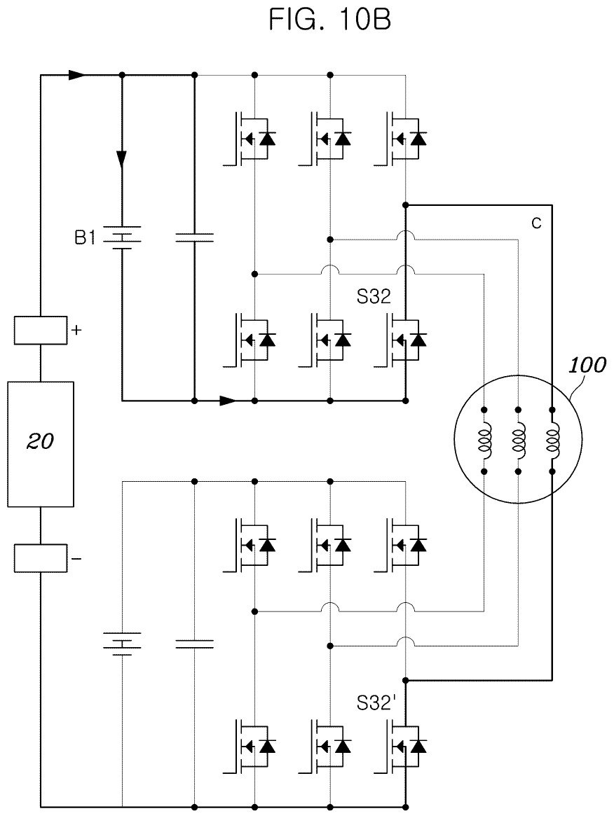

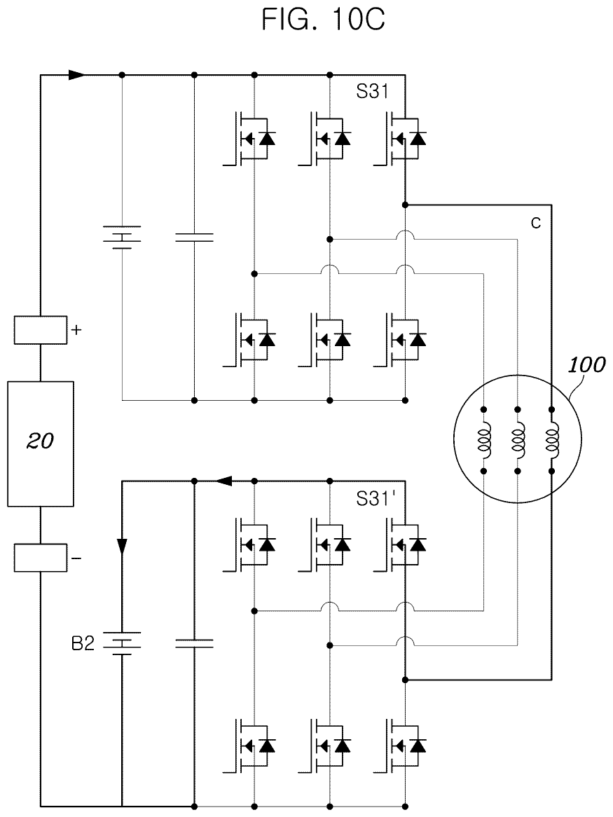

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, and a turn-on state of the top switching element S31 of the first inverter 210 and the top switching element S31′ of the second inverter 220 are repeated, and thus the third phase c charges the first battery B1 and the second battery B2 in equal proportions, as illustrated in FIG. 10A, FIG. 10B and FIG. 10C.

According to the above control, even if the charging conditions of the first battery B1 and the second battery B2 are different, both the first battery B1 and the second battery B2 can be charged by switching only eight elements per cycle.

### Charging Scenario 2

The controller 300 may control the switching states of the first inverter 210 and the second inverter 220 based on the first charging power of the first battery B1, the second charging power of the second battery B2, and a voltage parameter for the second charging power when the voltage of the first battery B1 is equal to or higher than the maximum charging voltage and the voltage of the second battery B2 is lower than the maximum charging voltage.

In this case, the first charging power is determined according to the voltage and charging current command of the first battery B1, the second charging power is determined according to the voltage and charging current command of the second battery B2, and each charging power may be calculated by multiplying the voltage of each battery B1 and B2 by the charging current thereof.

### Charging Scenario 2-1

In this case, the controller 300 may control the switching states of the first inverter 210 and the second inverter 220 such that the first phase a, the second phase b, and the third phase c charge both the first battery B1 and the second battery B2 with the proportion of charging the second battery B2 being greater than the proportion of charging the first battery B1 when the condition according to mathematical expression 4 below is satisfied.

### Mathematical Expression 4

$${P}_{1}^{⋆} < ( ( {V}_{max} - {V}_{2} ) / {V}_{2} ) {P}_{2}^{⋆}$$

Here, P₁* denotes the first charging power, Pₛ* denotes the second charging power, (Vₘₐₓ−V₂)/V₂ denotes a voltage parameter for the second charging power, Vₘₐₓ denotes the maximum charging voltage, and V₂ denotes the voltage of the second battery.

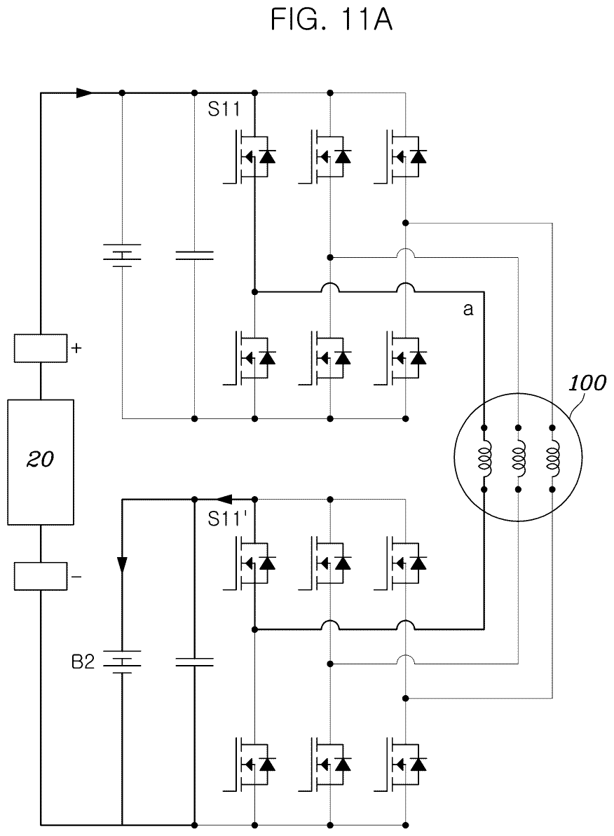

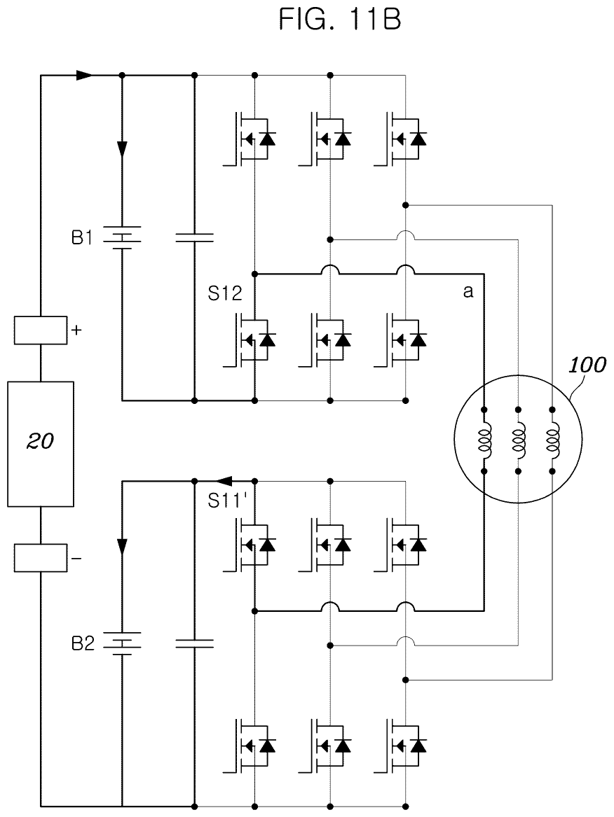

The switching state control method for this case is illustrated in FIG. 11A to FIG. 13B.

The controller 300 may control the switching states such that the top switching element S11 and the bottom switching element S12 of the first inverter 210 are turned on and turned off complementarily, and turn-on of the top switching element S11′ of the second inverter 220 is maintained, and thus the first phase a charges both the first battery B1 and the second battery B2 with the proportion of charging the second battery B2 being greater than the proportion of charging the first battery B1, as illustrated in FIG. 11A and FIG. 11B.

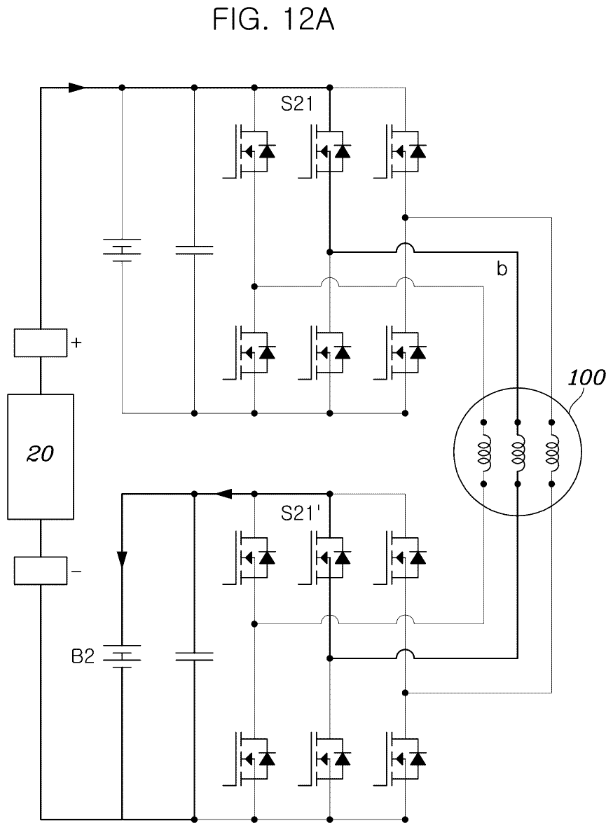

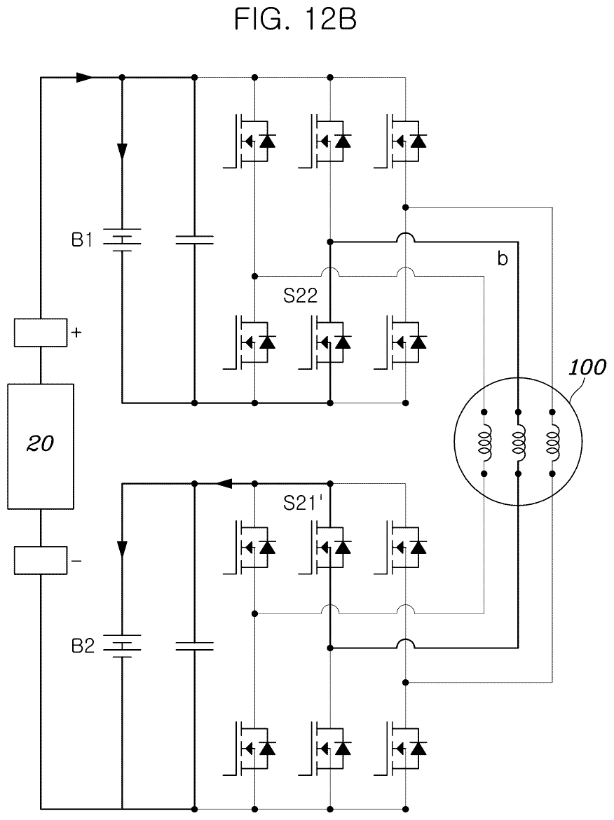

The controller 300 may control the switching states such that the top switching element S21 and the bottom switching element S22 of the first inverter 210 are turned on and turned off complementarily, and turn-on of the top switching element S21′ of the second inverter 220 is maintained, and thus the second phase b charges both the first battery B1 and the second battery B2 with the proportion of charging the second battery B2 being greater than the proportion of charging the first battery B1, as illustrated in FIG. 12A and FIG. 12B.

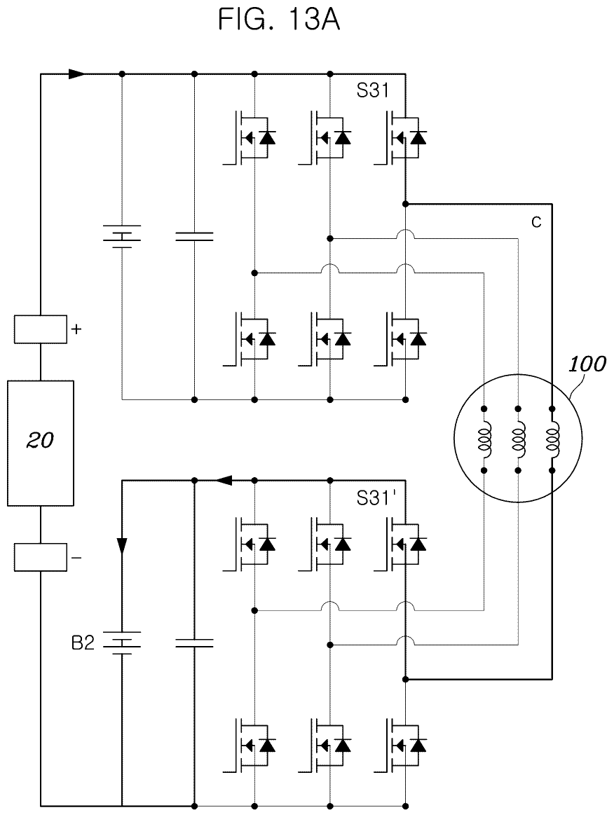

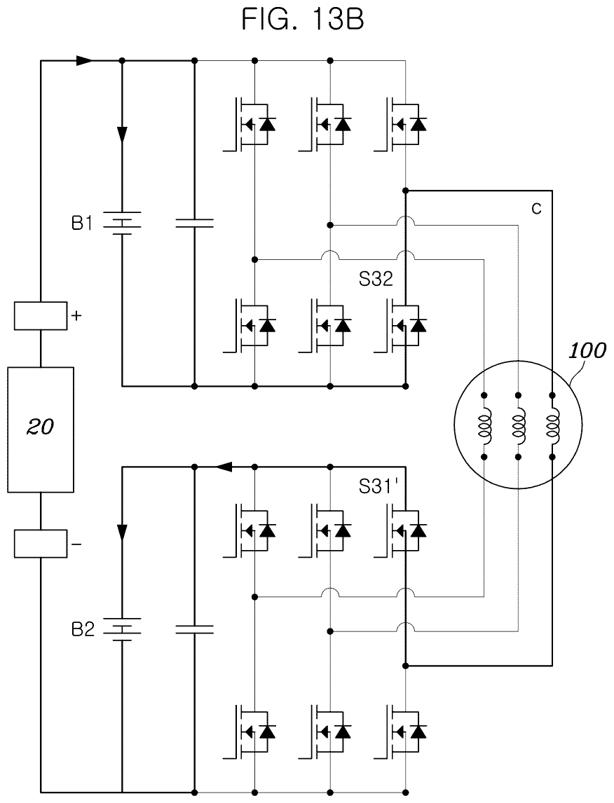

The controller 300 may control the switching states such that the top switching element S31 and the bottom switching element S32 of the first inverter 210 are turned on and turned off complementarily, and turn-on of the top switching element S31′ of the second inverter 220 is maintained, and thus the third phase c charges both the first battery B1 and the second battery B2 with the proportion of charging the second battery B2 being greater than the proportion of charging the first battery B1, as illustrated in FIG. 13A and FIG. 13B.

In the case of the control, as described above, even if the charging conditions of the first battery B1 and the second battery B2 are different, both the first battery B1 and the second battery B2 can be charged by switching only six elements per cycle.

### Charging Scenario 2-2

In this case, the controller 300 may control the switching states of the first inverter 210 and the second inverter 220 such that the first phase a, the second phase b, and the third phase c charge both the first battery B1 and the second battery B2, the first phase a and the second phase b charge the second battery B2 in a greater proportion than the proportion of charging the first battery B1, and the third phase c charges the first battery B1 and the second battery B2 in equal proportions when the condition according to mathematical expression 5 below is satisfied.

### Mathematical Expression 5

$$( ( {V}_{max} - {V}_{2} ) / {V}_{2} ) {P}_{2}^{⋆} \leq {P}_{1}^{⋆} < ( ( b {V}_{max} - {V}_{2} ) / {V}_{2} ) {P}_{2}^{⋆}$$

Here, P₁* denotes the first charging power, P₂* denotes the second charging power, (Vₘₐₓ−V₂)/V₂ and (bVₘₐₓ−V₂)/V₂ represent voltage parameters for the second charging power, Vₘₐₓ is the maximum charging voltage, V₂ is the voltage of the second battery, and b is a constant, which is “1.5”, for example.

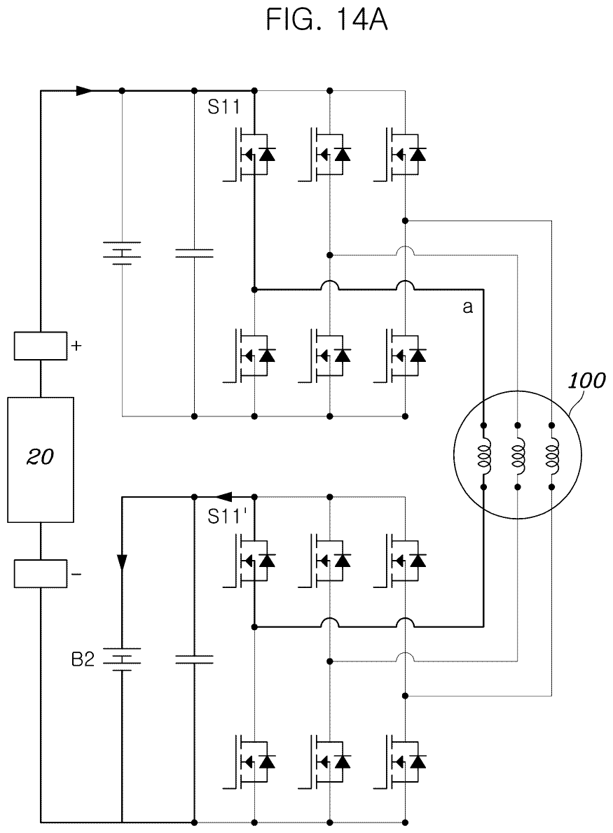

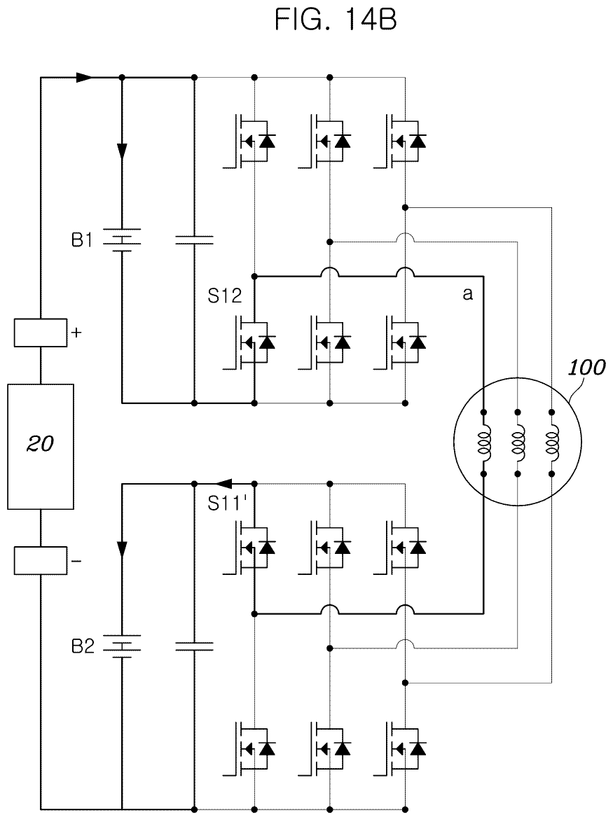

The switching state control method for this case is illustrated in FIG. 14A to FIG. 16D.

The controller 300 may control the switching states such that the top switching element S11 and the bottom switching element S12 of the first inverter 210 are turned on and turned off complementarily, and turn-on of the top switching element S11′ of the second inverter 220 is maintained, and thus the first phase a charges both the first battery B1 and the second battery B2 with the proportion of charging the second battery B2 being greater than the proportion of charging the first battery B1, as illustrated in FIG. 14A and FIG. 14B.

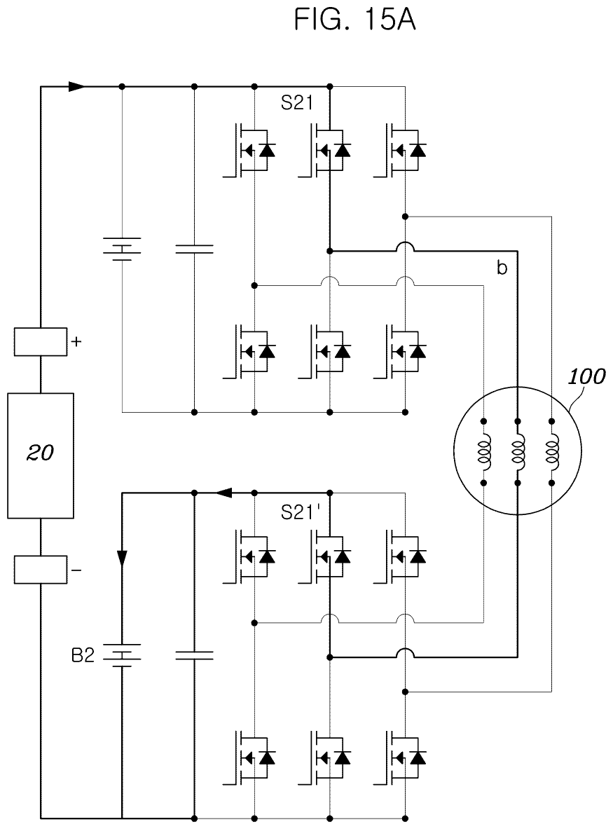

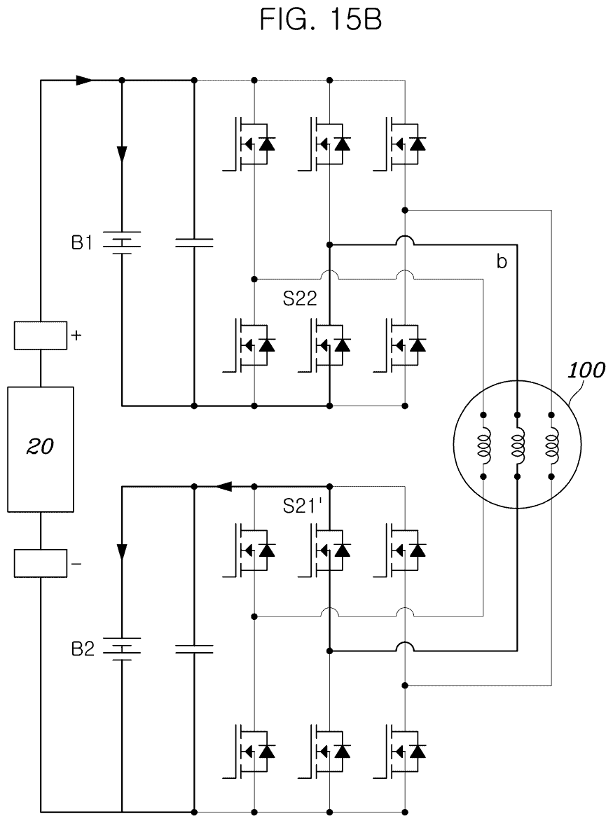

The controller 300 may control the switching states such that the top switching element S21 and the bottom switching element S22 of the first inverter 210 are turned on and turned off complementarily, and turn-on of the top switching element S21′ of the second inverter 220 is maintained, and thus the second phase b charges both the first battery B1 and the second battery B2 with the proportion of charging the second battery B2 being greater than the proportion of charging the first battery B1, as illustrated in FIG. 15A and FIG. 15B.

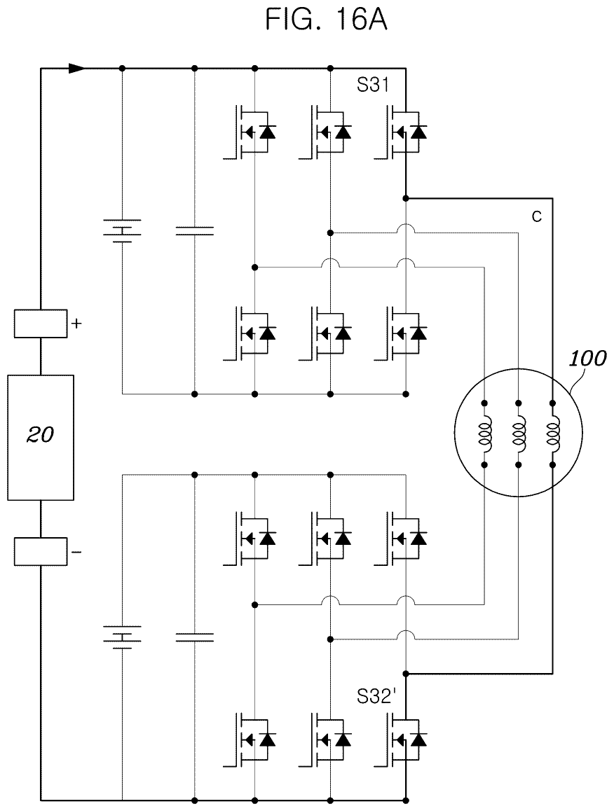

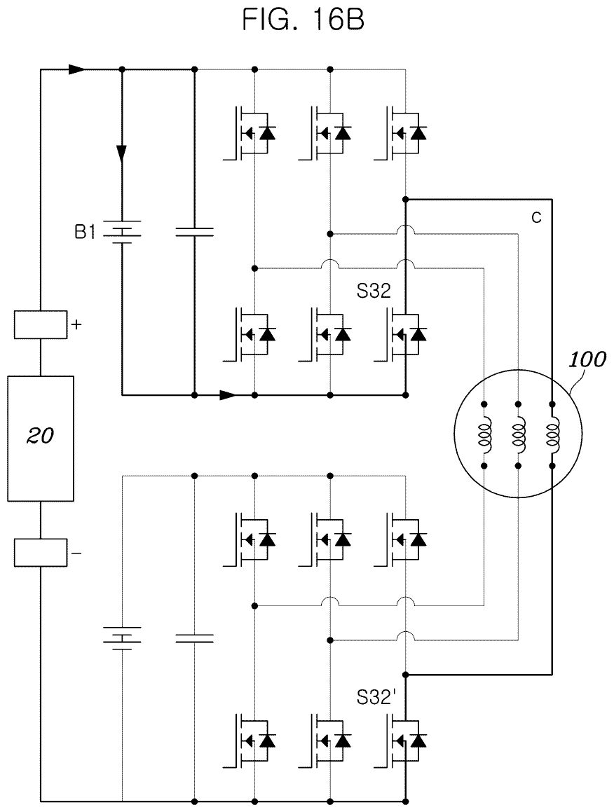

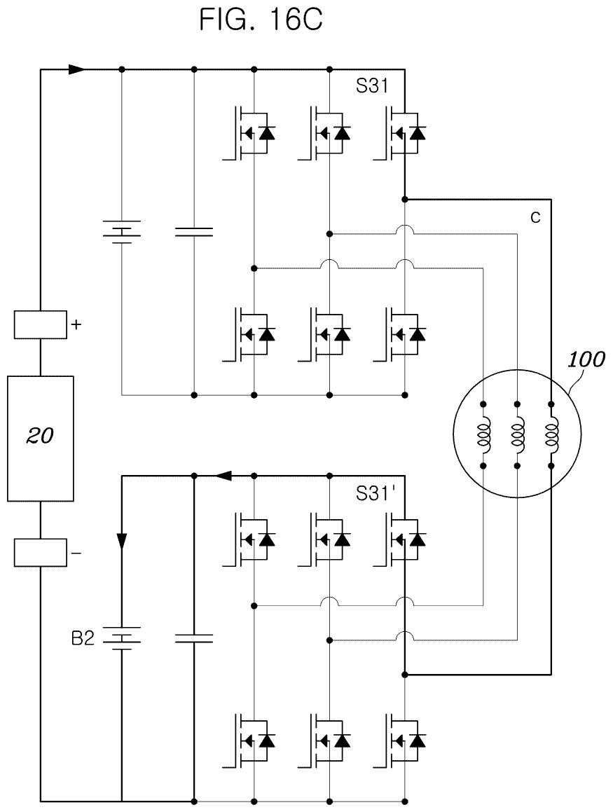

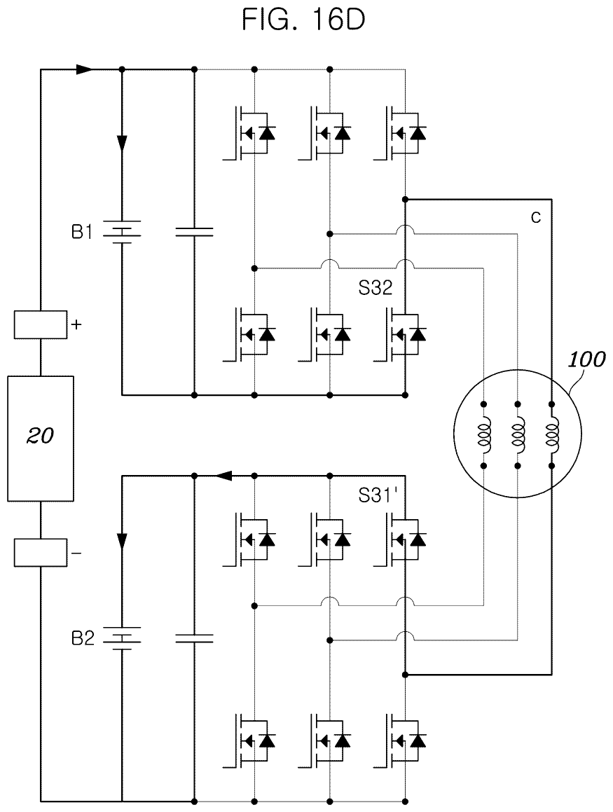

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, a turn-on state of the top switching element S31 of the first inverter 210 and the top switching element S31′ of the second inverter 220, and a turn-on state of the bottom switching element S32 of the first inverter 210 and the top switching element S31′ of the second inverter 220 are repeated, and thus the third phase c charges the first battery B1 and the second battery B2 in equal proportions, as illustrated in FIG. 16A, FIG. 16B, FIG. 16C and FIG. 16D.

According to the above control, even if the charging conditions of the first battery B1 and the second battery B2 are different, both the first battery B1 and the second battery B2 can be charged by switching only eight elements per cycle.

### Charging Scenario 2-3

In this case, the controller 300 may control the switching states of the first inverter 210 and the second inverter 220 such that the first phase a charges only the first battery B1, the second phase b and the third phase c charge both the first battery B1 and the second battery B2, the second phase b charges the second battery B2 in a greater proportion than the proportion of charging the first battery B1, and the third phase c charges the first battery B1 and the second battery B2 in equal proportions when the condition according to mathematical expression 6 below is satisfied.

### Mathematical Expression 6

$$( ( b {V}_{max} - {V}_{2} ) / {V}_{2} ) {P}_{2}^{⋆} \leq {P}_{1}^{⋆} < ( ( c {V}_{max} - {V}_{2} ) / {V}_{2} ) {P}_{2}^{⋆}$$

Here, P₁* denotes the first charging power, P₁* denotes the second charging power, (Vₘₐₓ−V₂)/V₂ and (bVₘₐₓ−V₂)/V₂ are voltage parameters for the second charging power, Vₘₐₓ is the maximum charging voltage, V₂ is the voltage of the second battery, b and c are constants, and c is a value greater than b. For example, b is “1.5” and c is “3”.

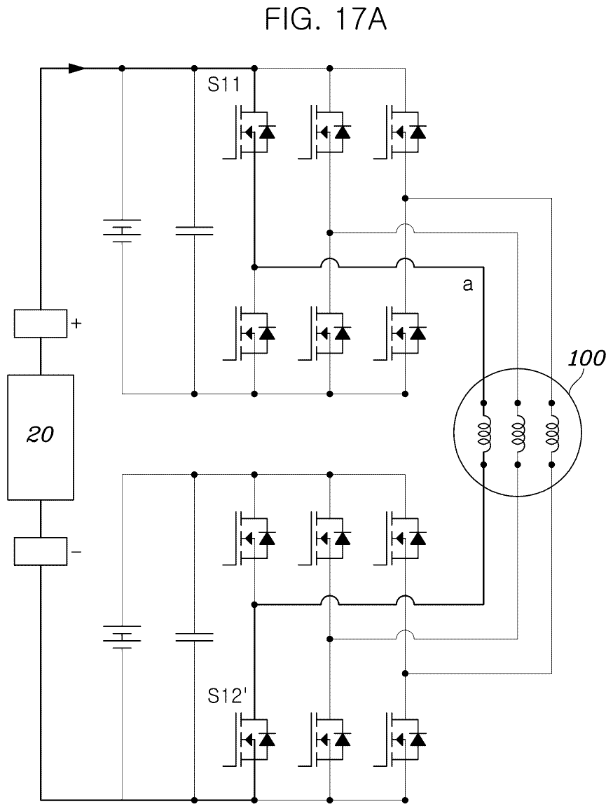

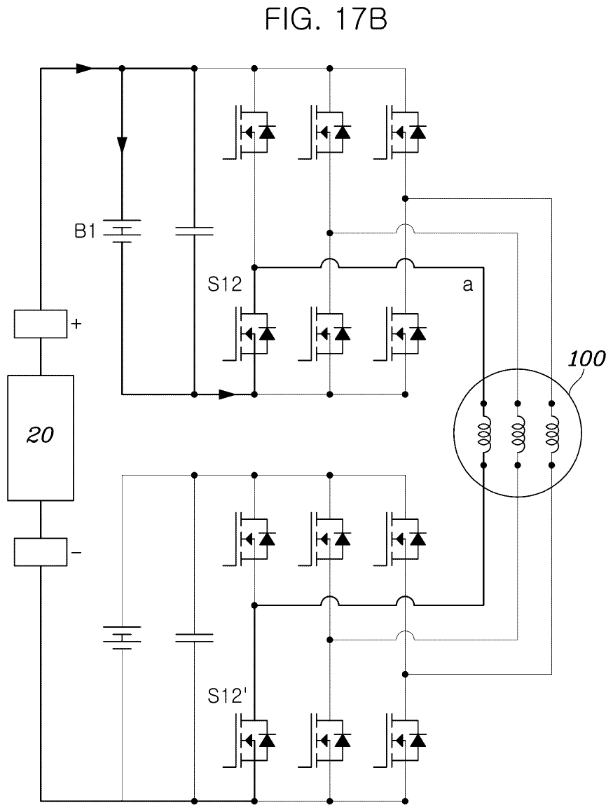

The switching state control method for this case is illustrated in FIG. 17A to FIG. 19D.

The controller 300 may control the switching states such that the top switching element S11 and the bottom switching element S12 of the first inverter 210 are turned on and turned off complementarily, and turn-on of the bottom switching element S12′ of the second inverter 220 is maintained, and thus the first phase a charges only the first battery B1, as illustrated in FIG. 17A and FIG. 17B.

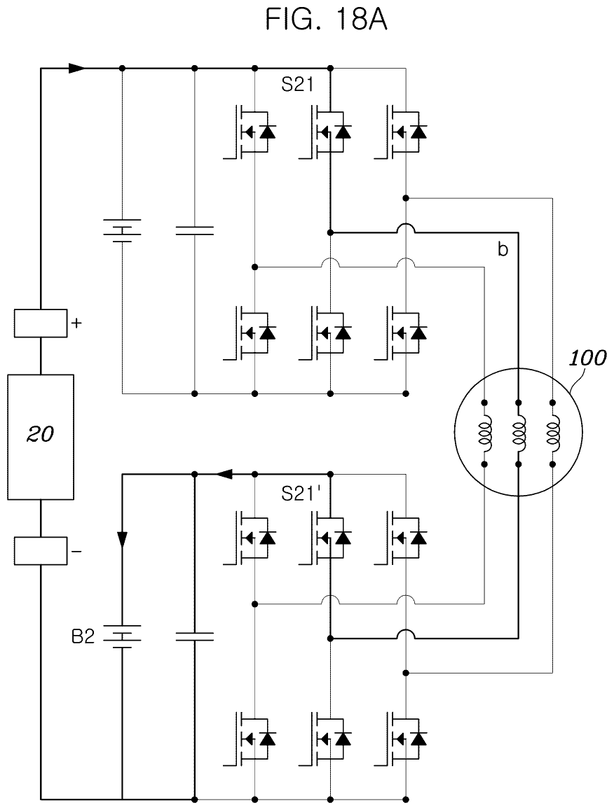

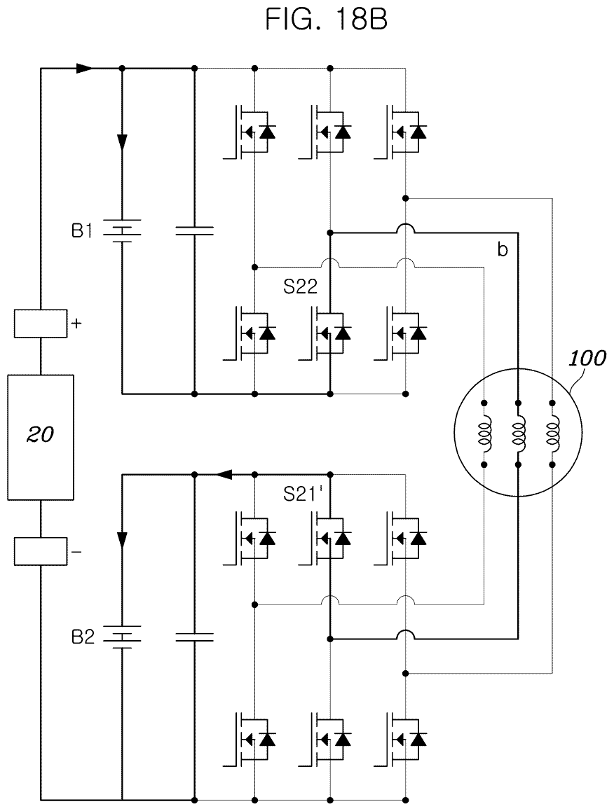

The controller 300 may control the switching states such that the top switching element S21 and the bottom switching element S22 of the first inverter 210 are turned on and turned off complementarily, and turn-on of the bottom switching element S22′ of the second inverter 220 is maintained, and thus the second phase b charges both the first battery B1 and the second battery B2 with the proportion of charging the second battery B2 being greater than the proportion of charging the first battery B1, as illustrated in FIG. 18A and FIG. 18B.

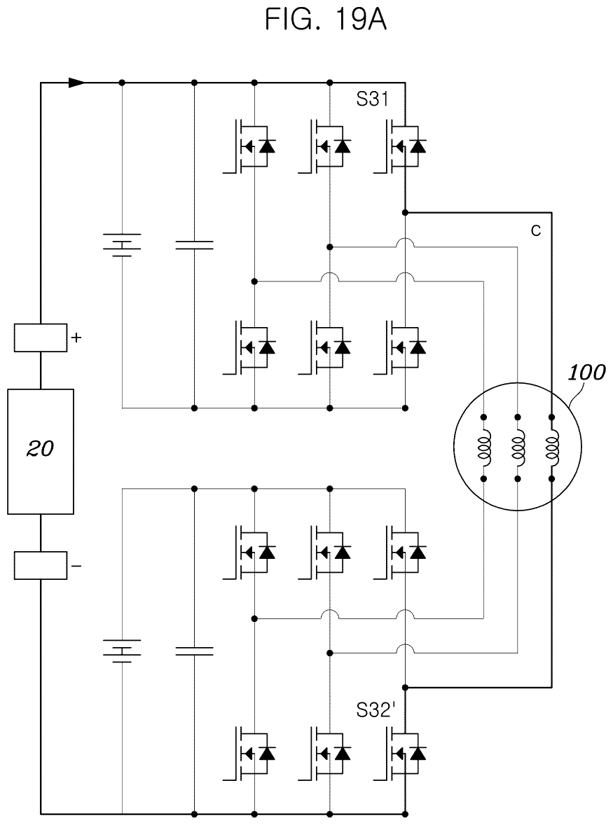

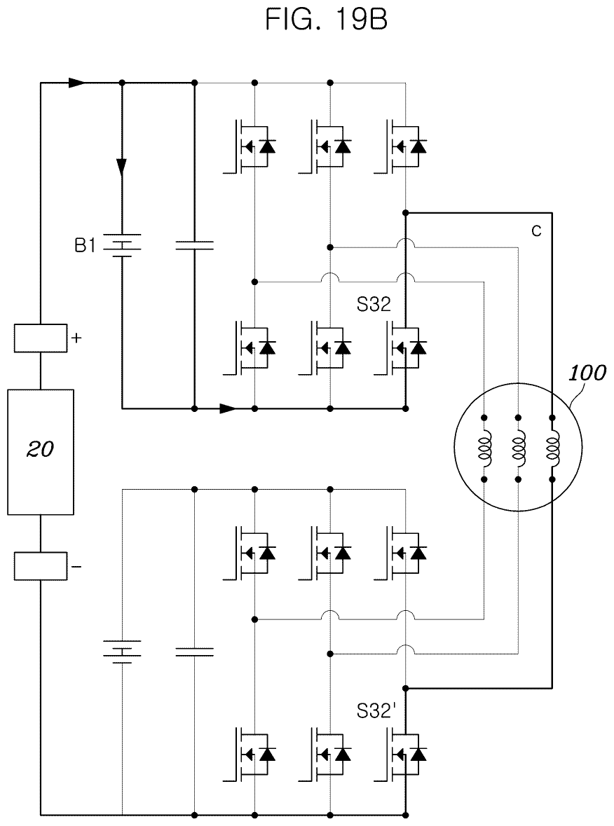

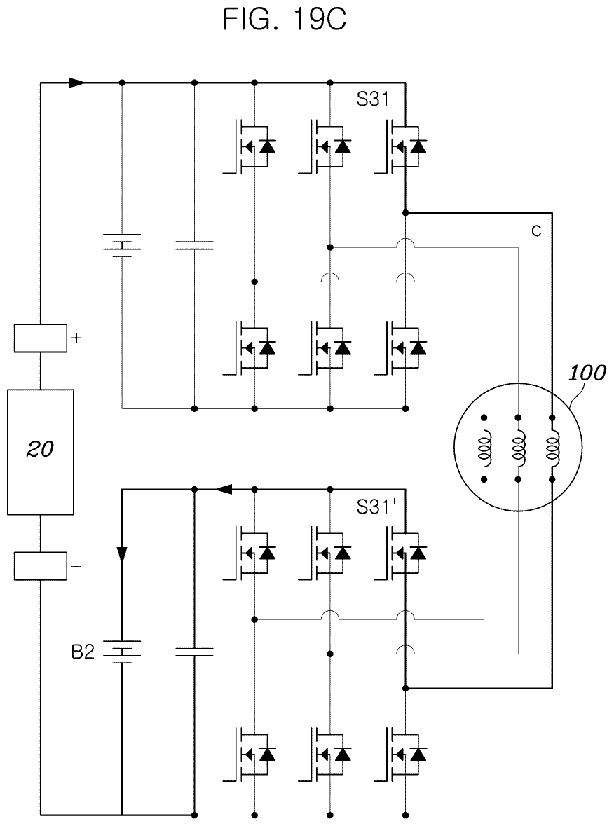

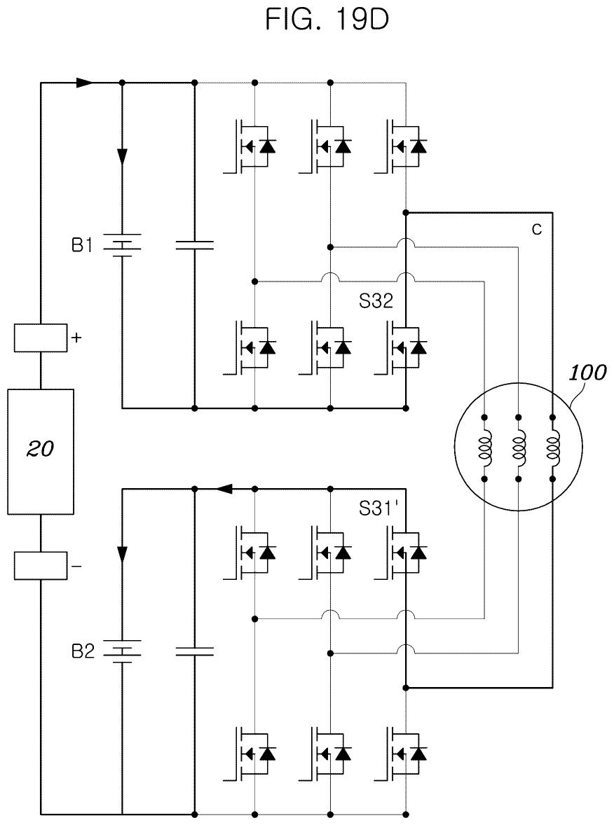

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, a turn-on state of the top switching element S31 of the first inverter 210 and the top switching element S31′ of the second inverter 220, and a turn-on state of the bottom switching element S32 of the first inverter 210 and the top switching element S31′ of the second inverter 220 are repeated, and thus the third phase c charges the first battery B1 and the second battery B2 in equal proportions, as illustrated in FIG. 19A, FIG. 19B, FIG. 19C and FIG. 19D.

According to the above control, even if the charging conditions of the first battery B1 and the second battery B2 are different, both the first battery B1 and the second battery B2 can be charged by switching only eight elements per cycle.

### Charging Scenario 2-4

In this case, the controller 300 controls the switching states such that the first phase a and the second phase b charge only the first battery, and the third phase charges the first battery and the second battery in equal proportions when the condition according to mathematical expression 7 below is satisfied.

### Mathematical Expression 7

$$( ( c {V}_{max} - {V}_{2} ) / {V}_{2} ) {P}_{2}^{⋆} \leq {P}_{1}^{⋆}$$

Here, P₁* denotes the first charging power, P₂* denotes the second charging power, (Vₘₐₓ−V₂)/V₂ and (bVₘₐₓ−V₂)/V₂ are voltage parameters for the second charging power, Vₘₐₓ is the maximum charging voltage, V₂ is the voltage of the second battery, and c is a constant. For example, c is “3”.

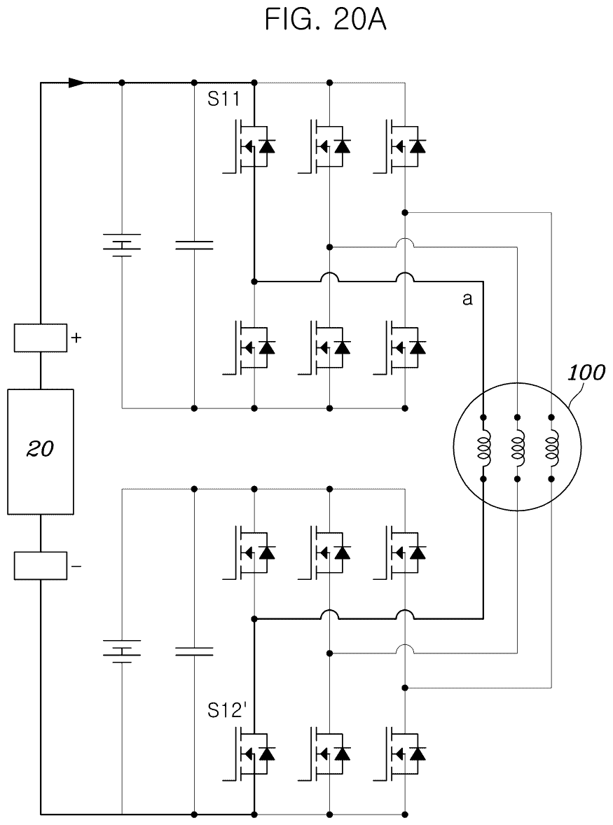

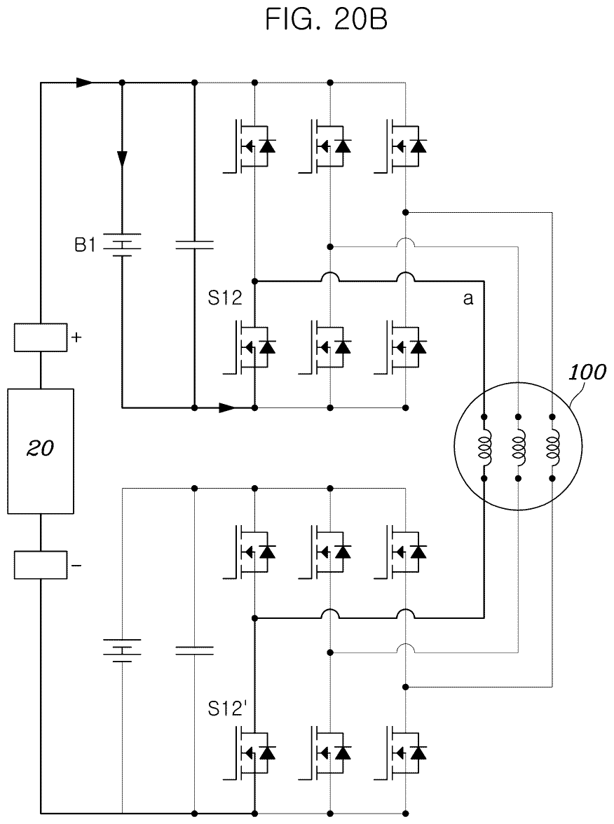

The switching state control method for this case is illustrated in FIG. 20A to FIG. 22D.

The controller 300 may control the switching states such that the top switching element S11 and the bottom switching element S12 of the first inverter 210 are turned on and turned off complementarily, and turn-on of the bottom switching element S12′ of the second inverter 220 is maintained, such that the first phase a charges only the first battery B1, as illustrated in FIG. 20A and FIG. 20B.

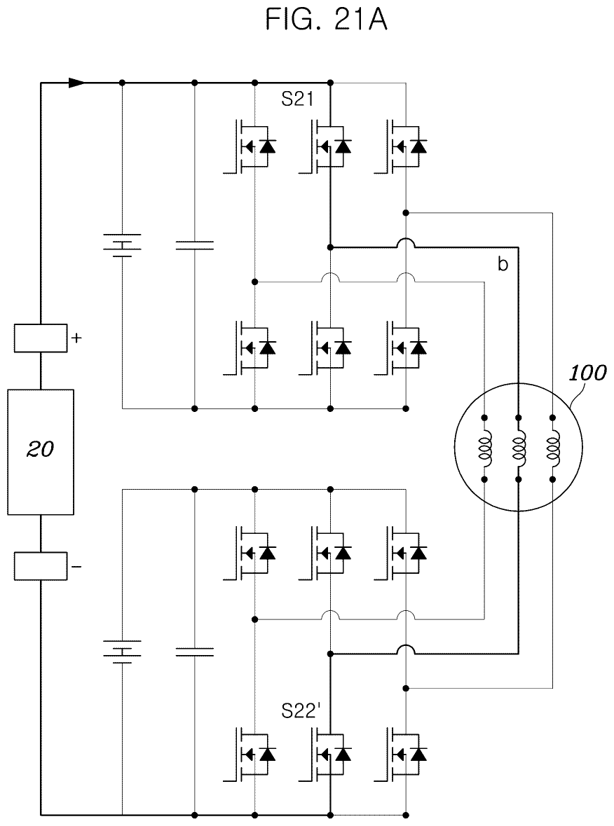

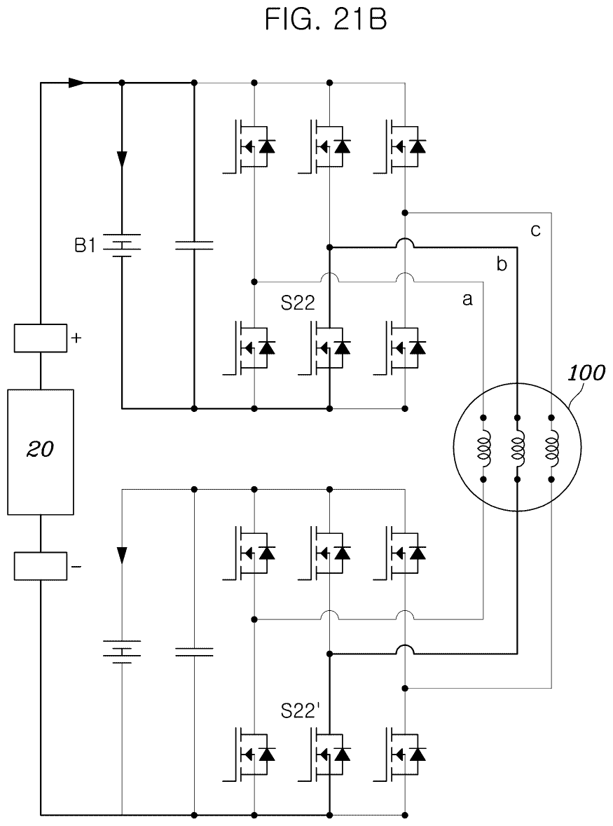

The controller 300 may control the switching states such that the top switching element S21 and the bottom switching element S22 of the first inverter 210 are turned on and turned off complementarily, and turn-on of the bottom switching element S22′ of the second inverter 220 is maintained, such that the second phase b charges only the first battery B1, as illustrated in FIG. 21A and FIG. 21B.

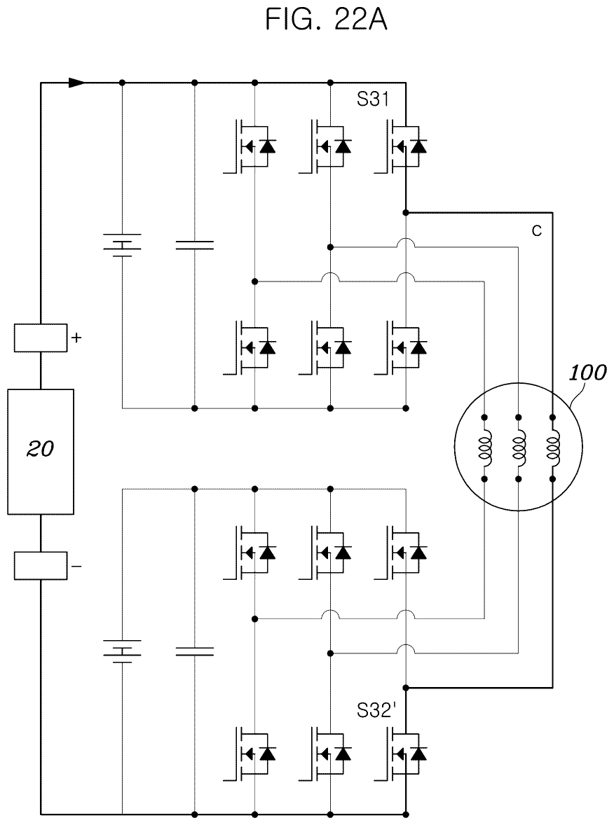

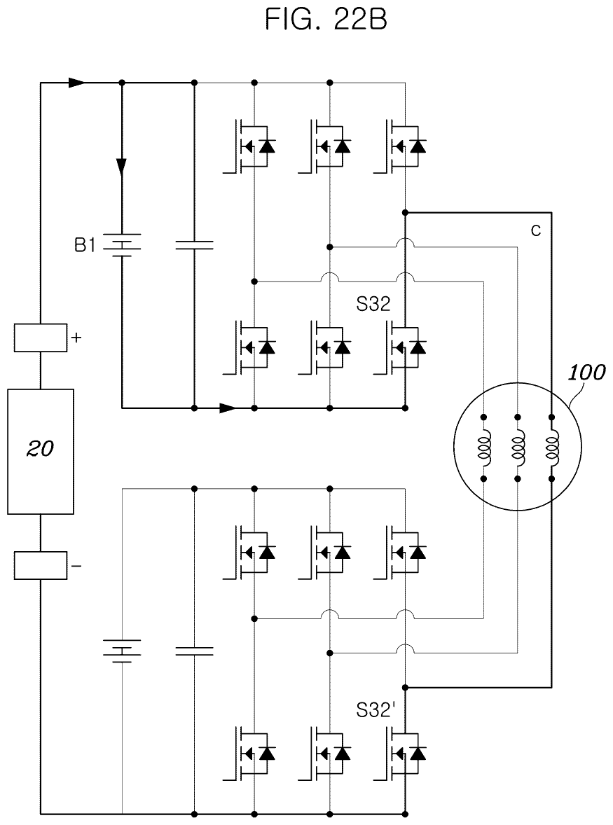

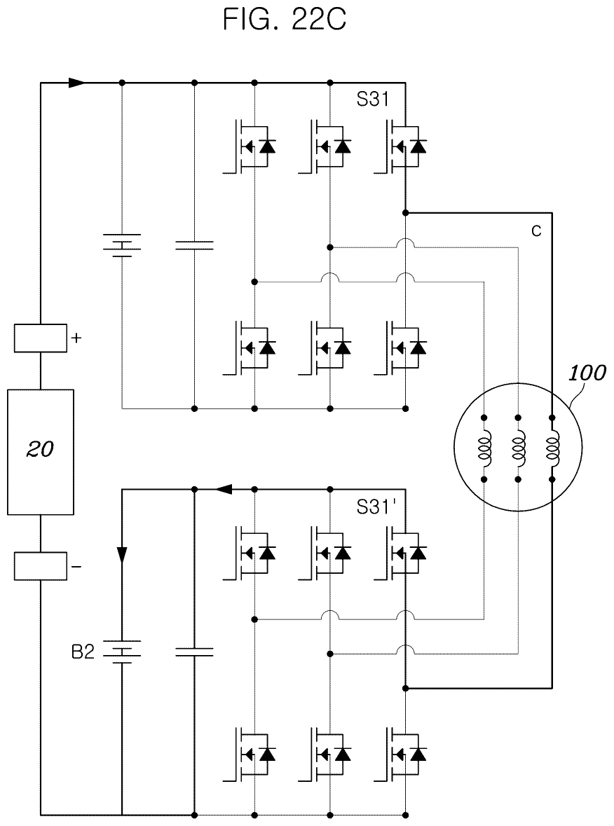

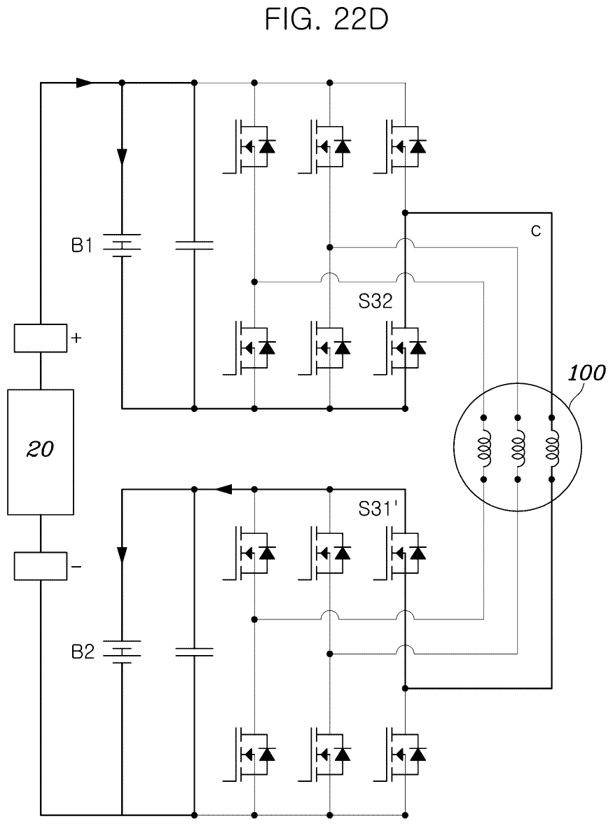

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, a turn-on state of the top switching element S31 of the first inverter 210 and the top switching element S31′ of the second inverter 220, and a turn-on state of the bottom switching element S32 of the first inverter 210 and the top switching element S31′ of the second inverter 220 are repeated, and thus the third phase c charges the first battery B1 and the second battery B2 in equal proportions, as illustrated in FIG. 22A, FIG. 22B, FIG. 22C and FIG. 22D.

According to the above control, even if the charging conditions of the first battery B1 and the second battery B2 are different, both the first battery B1 and the second battery B2 can be charged by switching only eight elements per cycle.

### Charging Scenario 3

The controller 300 may control the switching states based on the first charging power of the first battery B1, the second charging power of the second battery B2, and a voltage parameter for the second charging power when both the voltage of the first battery B1 and the voltage of the second battery B2 are equal to or lower than the maximum charging voltage and the sum of the voltage of the first battery B1 and the voltage of the second battery B2 is equal to or greater than the maximum charging voltage.

In this case, the first charging power is determined according to the voltage and charging current command of the first battery B1, and the second charging power is determined according to the voltage and charging current command of the second battery B2, and each charging power may be calculated by multiplying the voltage of each battery B1 and B2 by the charging current thereof.

### Charging Scenario 3-1

In this case, the controller 300 may control the switching states such that the first phase a, the second phase b, and the third phase c charge both the first battery B1 and the second battery B2 with the proportion of charging the second battery B2 being greater than the proportion of charging the first battery B1 when the condition according to mathematical expression 8 below is satisfied.

### Mathematical Expression 8

$${P}_{1}^{⋆} < ( ( {V}_{max} - {V}_{2} ) / {V}_{2} ) {P}_{2}^{⋆}$$

Here, P₁* is the first charging power, P₂* is the second charging power, (Vₘₐₓ−V₂)/V₂ is a voltage parameter for the second charging power, Vₘₐₓ is the maximum charging voltage, and V₂ means the voltage of the second battery.

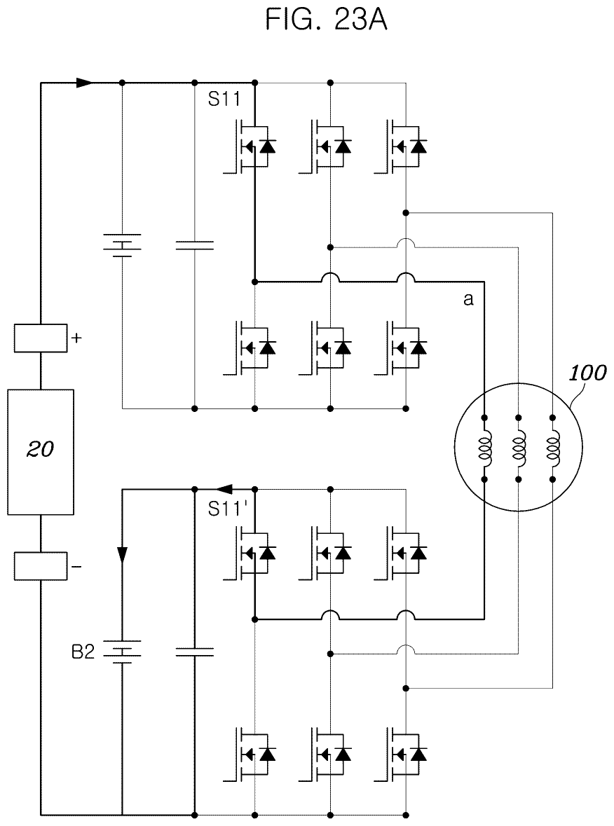

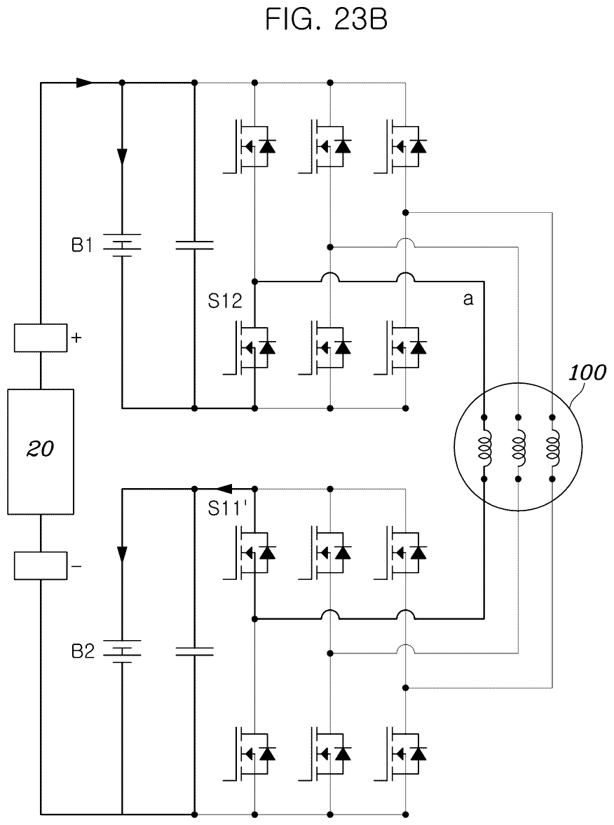

The switching state control method for this case is illustrated in FIG. 23A to FIG. 25B.

The controller 300 may control the switching states such that the top switching element S11 and the bottom switching element S12 of the first inverter 210 are turned on and turned off complementarily, and turn-on of the top switching element S11′ of the second inverter 220 is maintained, and thus the first phase a charges both the first battery B1 and the second battery B2 with the proportion of charging the second battery B2 being greater than the proportion of charging the first battery B1, as illustrated in FIG. 23A and FIG. 23B.

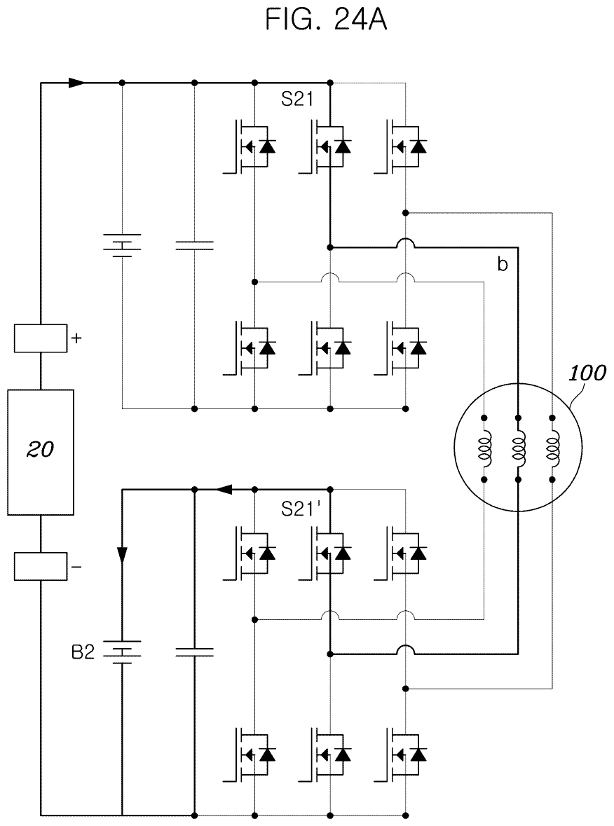

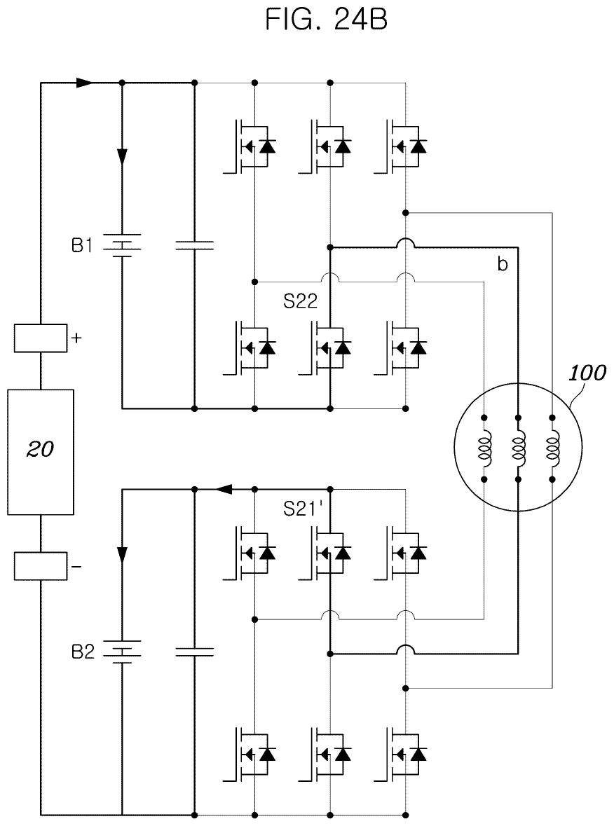

The controller 300 may control the switching states such that the top switching element S21 and the bottom switching element S22 of the first inverter 210 are turned on and turned off complementarily, and turn-on of the top switching element S21′ of the second inverter 220 is maintained, and thus the second phase b charges both the first battery B1 and the second battery B2 with the proportion of charging the second battery B2 being greater than the proportion of charging the first battery B1, as illustrated in FIG. 24A and FIG. 24B.

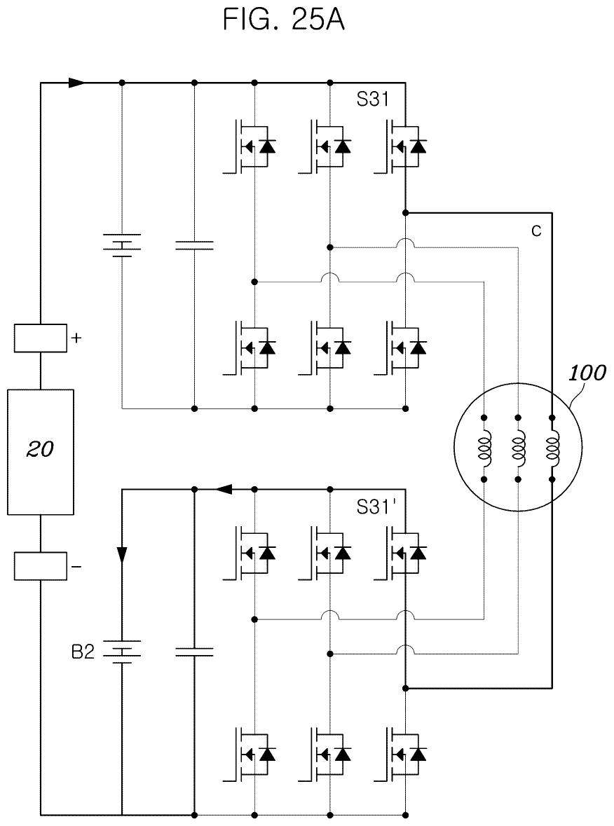

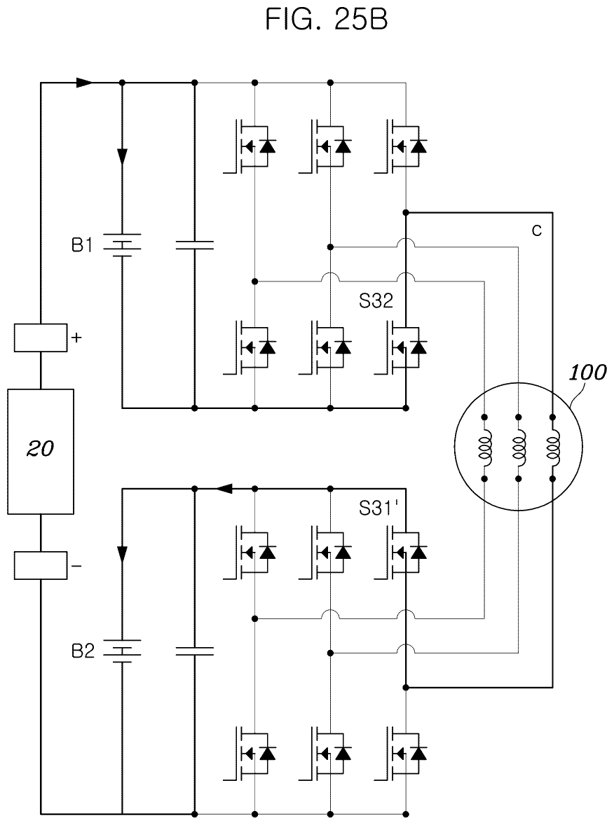

The controller 300 may control the switching states such that the top switching element S31 and the bottom switching element S32 of the first inverter 210 are turned on and turned off complementarily, and turn-on of the top switching element S31′ of the second inverter 220 is maintained, and thus the third phase c charges both the first battery B1 and the second battery B2 with the proportion of charging the second battery B2 being greater than the proportion of charging the first battery B1, as illustrated in FIG. 25A and FIG. 25B.

In the case of the control as described above, even if the charging conditions of the first battery B1 and the second battery B2 are different, both the first battery B1 and the second battery B2 can be charged by switching only six elements per cycle.

### Charging Scenario 3-2

In this case, the controller 300 may control the switching states of the first inverter 210 and the second inverter 220 such that the first phase a, the second phase b, and the third phase c charge both the first battery B1 and the second battery B2, the first phase a and the second phase b charge both the second battery B2 in a greater proportion than the proportion of charging the first battery B1, and the third phase c charges the first battery B1 and the second battery B2 in equal proportions when the condition according to mathematical expression 9 below is satisfied.

### Mathematical Expression 9

$$( ( {V}_{max} - {V}_{2} ) / {V}_{2} ) {P}_{2}^{⋆} \leq {P}_{1}^{⋆} < ( ( d {V}_{max} + {V}_{{1}^{-}} d {V}_{2} ) / ( {V}_{max} - {V}_{1} + d {V}_{2} ) ) {P}_{2}^{⋆}$$

Here, P₁* is the first charging power, P₂* is the second charging power, (Vₘₐₓ−V₂)/V₂ and (dVₘₐₓ+V₁−dV₂)/(Vₘₐₓ−V₁+dV₂) are voltage parameters for the second charging power, Vₘₐₓ is the maximum charging voltage, V₁ is the voltage of the first battery, V₂ is the voltage of the second battery, and d is a constant. For example, d is “2”.

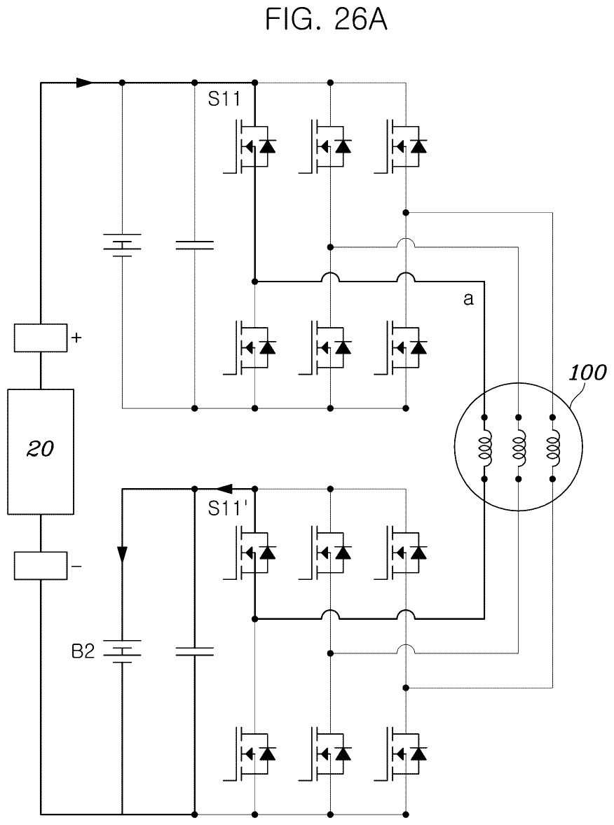

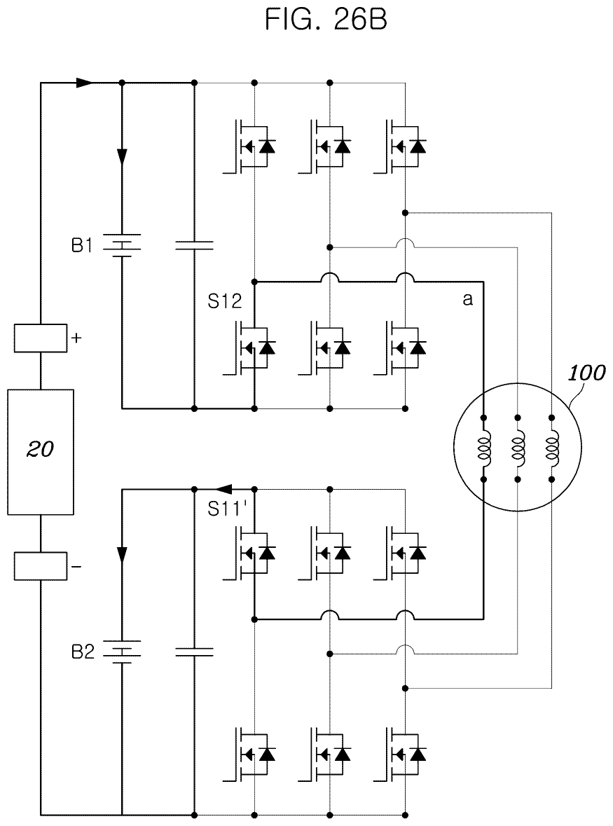

The switching state control method for this case is illustrated in FIG. 26A to FIG. 28D.

The controller 300 may control the switching states such that the top switching element S11 and the bottom switching element S12 of the first inverter 210 are turned on and turned off complementarily, and turn-on of the top switching element S11′ of the second inverter 220 is maintained, and thus the first phase a charges both the first battery B1 and the second battery B2 with the proportion of charging the second battery B2 being greater than the proportion of charging the first battery B1, as illustrated in FIG. 26A and FIG. 26B.

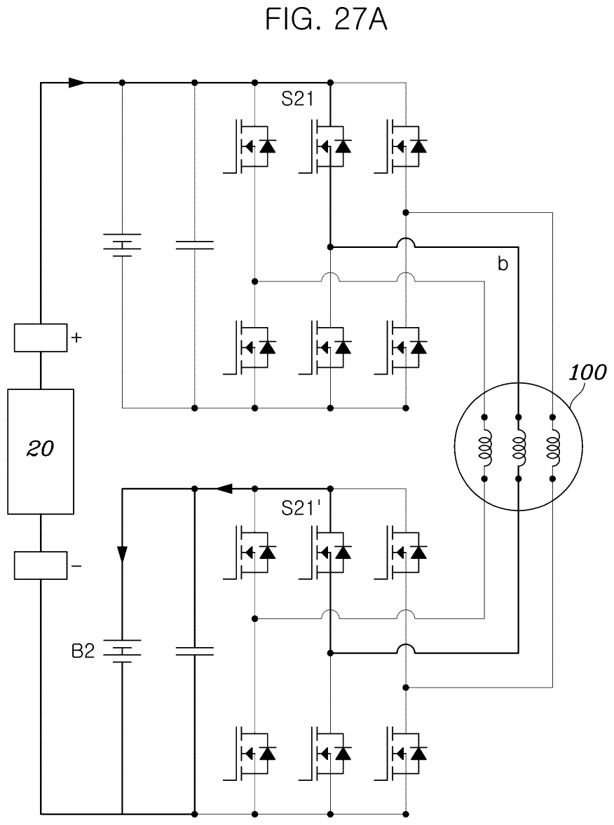

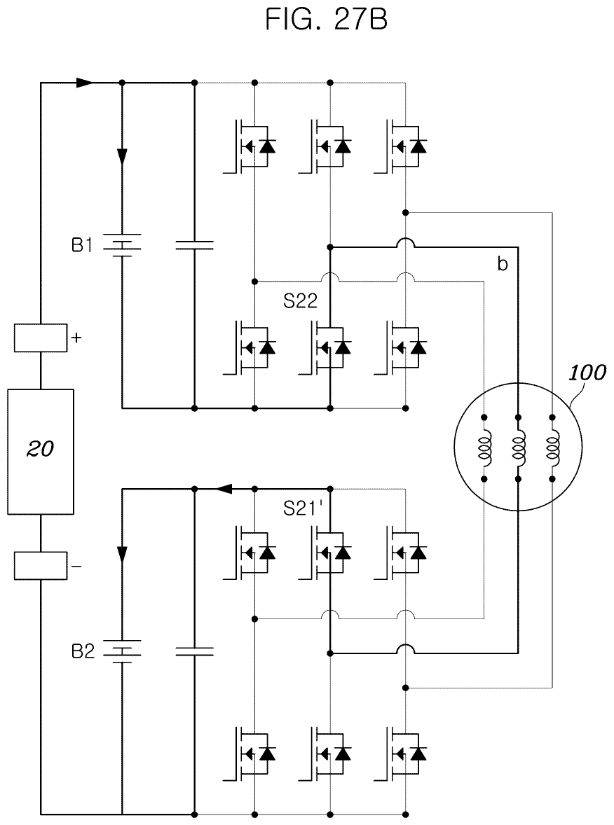

The controller 300 may control the switching states such that the top switching element S12 and the bottom switching element S22 of the first inverter 210 are turned on and turned off complementarily, and turn-on of the top switching element S21′ of the second inverter 220 is maintained, and thus the second phase b charges both the first battery B1 and the second battery B2 with the proportion of charging the second battery B2 being greater than the proportion of charging the first battery B1, as illustrated in FIG. 27A and FIG. 27B.

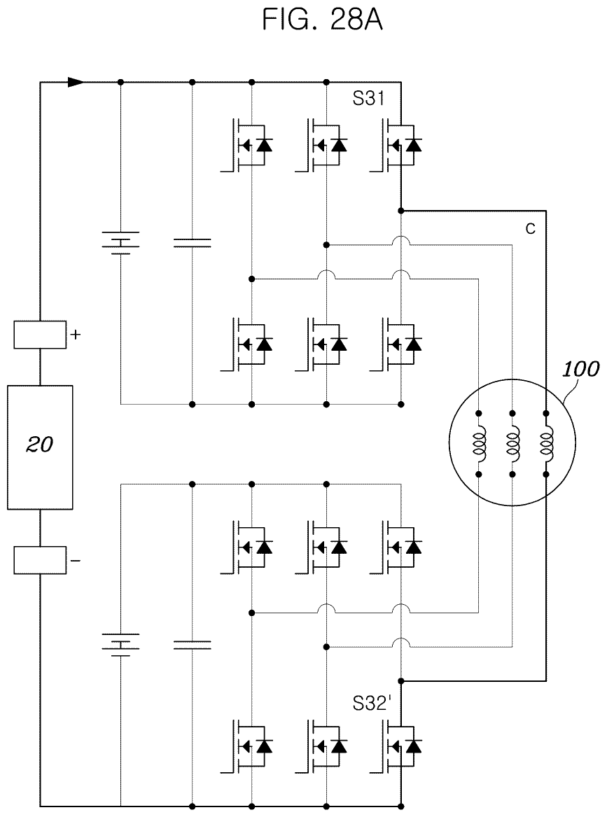

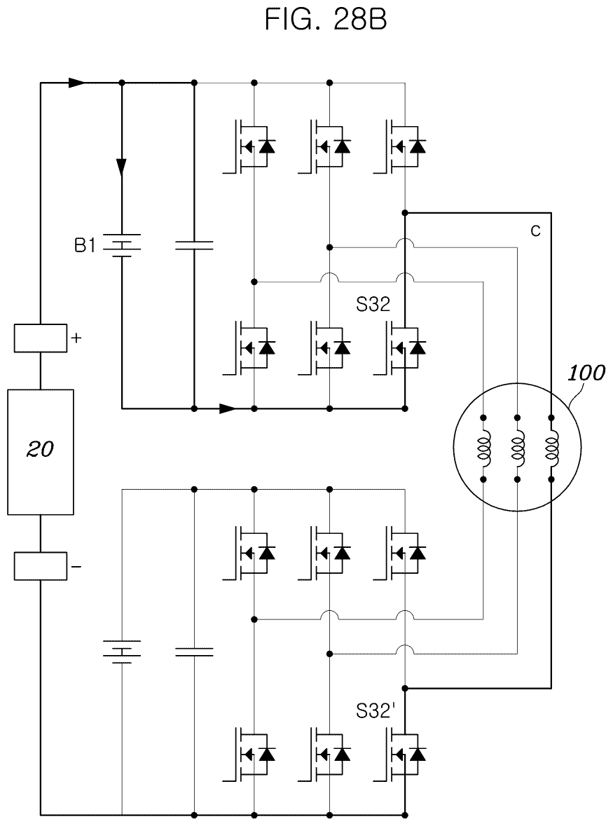

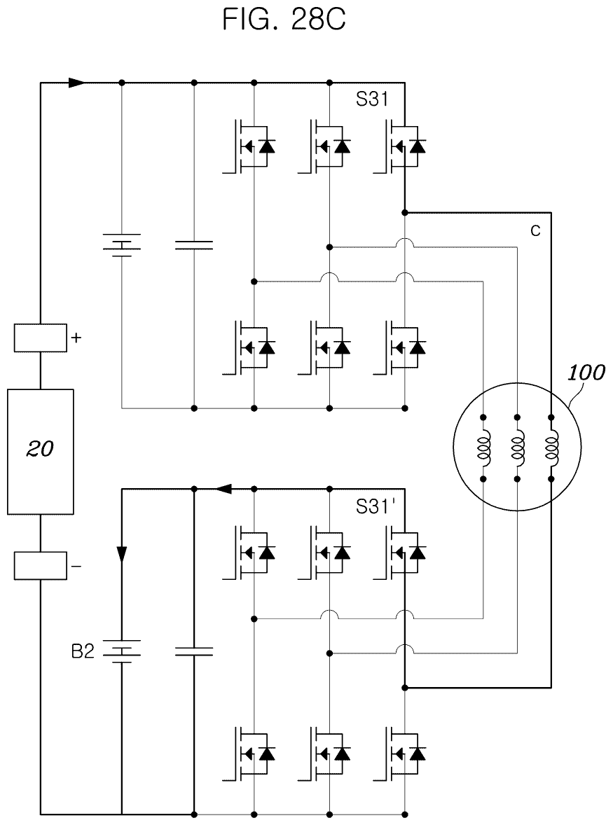

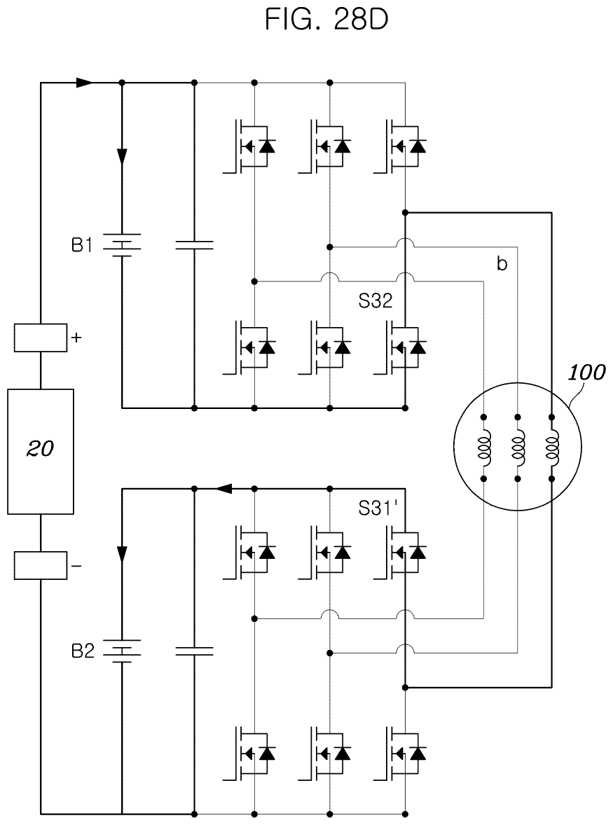

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, a turn-on state of the top switching element S31 of the first inverter 210 and the top switching element S31′ of the second inverter 220, and a turn-on state of the bottom switching element S32 of the first inverter 210 and the top switching element S31′ of the second inverter 220 are repeated, and thus the third phase c charges the first battery B1 and the second battery B2 in equal proportions, as illustrated in FIG. 28A, FIG. 28B, FIG. 28C and FIG. 28D.

According to the above control, even if the charging conditions of the first battery B1 and the second battery B2 are different, both the first battery B1 and the second battery B2 can be charged by switching only eight elements per cycle.

### Charging Scenario 3-3

In this case, the controller 300 may control the switching states of the first inverter 210 and the second inverter 220 such that the first phase a, the second phase b, and the third phase c charge both the first battery B1 and the second battery B2, the first phase a charges the second battery B2 in a greater proportion than the proportion of charging the first battery B1, the second phase b charges the first battery B1 in a greater proportion than the proportion of charging the second battery B2, and the third phase c charges the first battery B1 and the second battery B2 in equal proportions when the condition according to mathematical expression 10 below is satisfied.

### Mathematical Expression 10

$$( ( {dV}_{max} + {V}_{1} - {dV}_{2} ) / ( {V}_{max} - {V}_{1} + {dV}_{2} ) ) {P}_{2}^{*} \leq {P}_{1}^{*} < ( ( {V}_{max} + {dV}_{1} - {V}_{2} ) / ( {dV}_{max} - {dV}_{1} + {V}_{2} ) ) {P}_{2}^{*}$$

Here, P₁* is the first charging power, P₂* is the second charging power, (dVₘₐₓ+V₁−dV₂)/(Vₘₐₓ−V₁+dV₂) and (Vₘₐₓ+dV₁−V₂)/(dVₘₐₓ−dV₁+V₂) are voltage parameters for the second charging power, Vₘₐₓ is the maximum charging voltage, V₁ is the voltage of the first battery, V₂ is the voltage of the second battery, and d is a constant. For example, dis “2”.

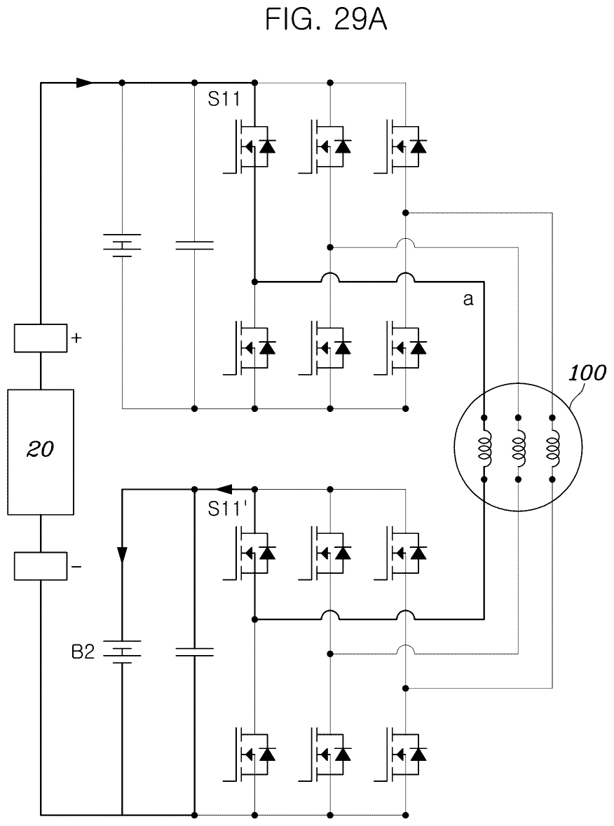

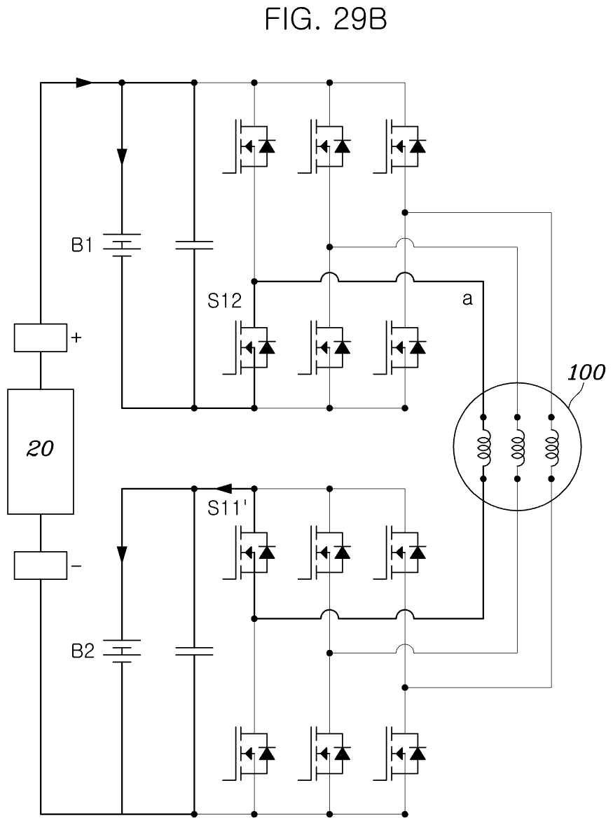

The switching state control method for this case is illustrated in FIG. 29A to FIG. 31D.

The controller 300 may control the switching states such that the top switching element S11 and the bottom switching element S12 of the first inverter 210 are turned on and turned off complementarily, and turn-on of the top switching element S11′ of the second inverter 220 is maintained, and thus the first phase a charges both the first battery B1 and the second battery B2 with the proportion of charging the second battery B2 being greater than the proportion of charging the first battery B1, as illustrated in FIG. 29A and FIG. 29B.

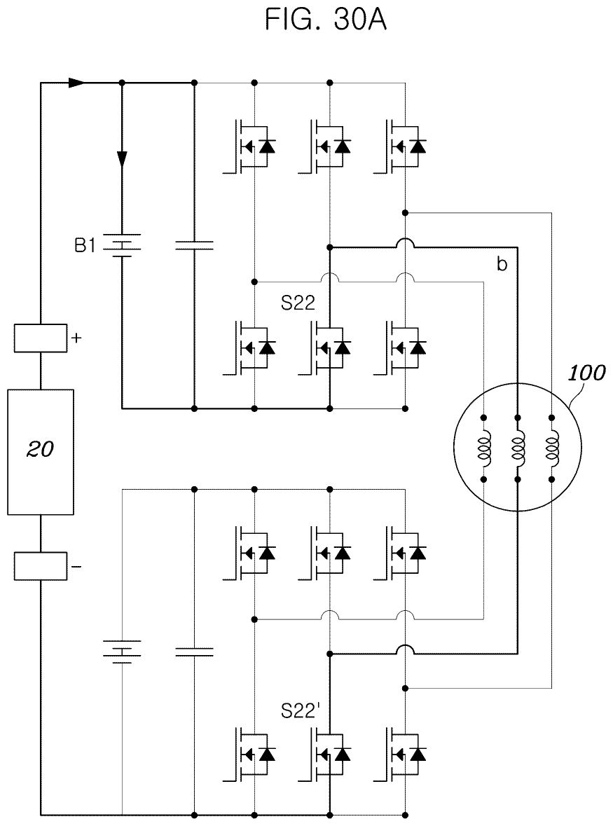

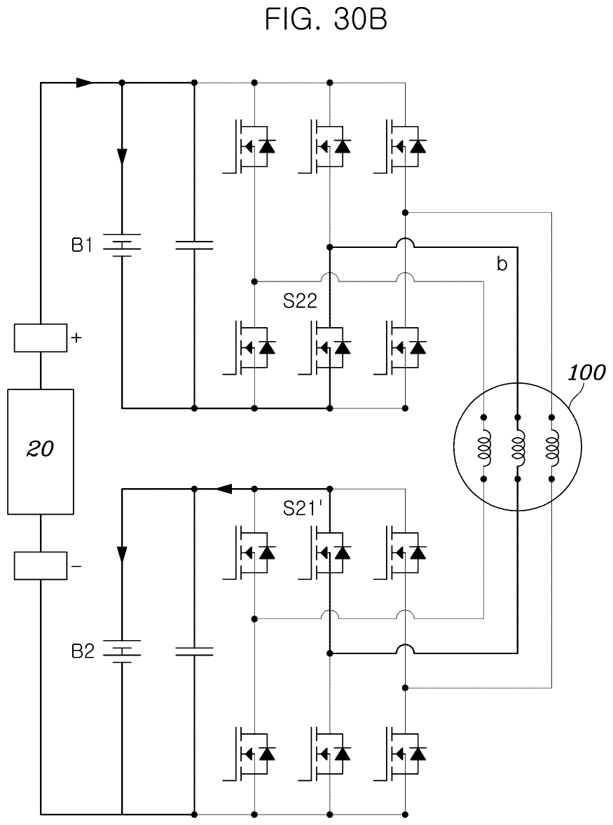

The controller 300 may control the switching states such that turn-on of the bottom switching element S22 of the first inverter 210 is maintained, and the top switching element S21′ and the bottom switching element S22′ of the second inverter 220 are turned on and turned off complementarily, and thus the second phase b charges both the first battery B1 and the second battery B2 with the proportion of charging the first battery B1 being greater than the proportion of charging the second battery B2, as illustrated in FIG. 30A and FIG. 30B.

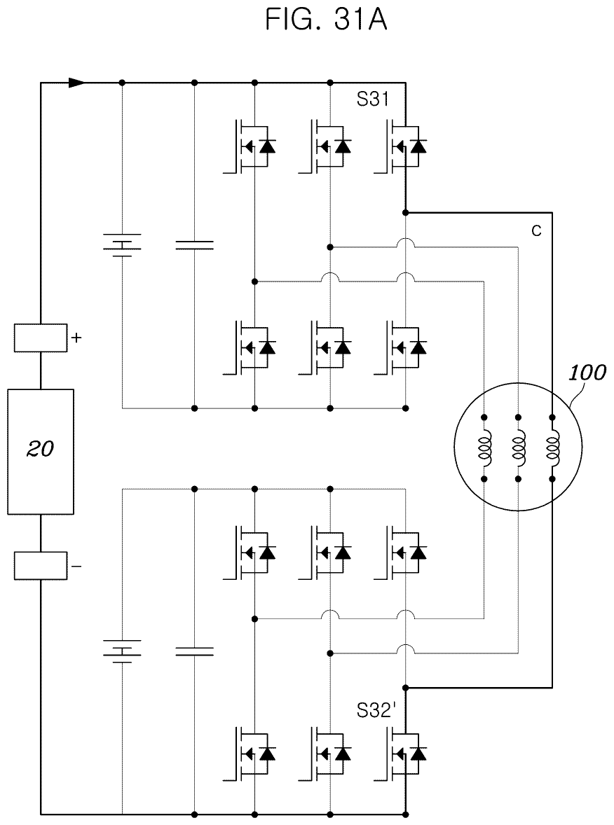

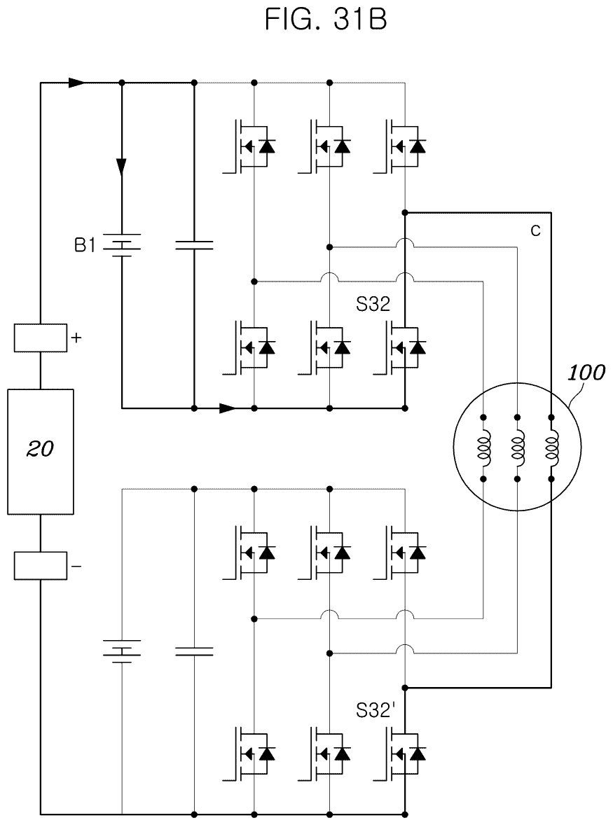

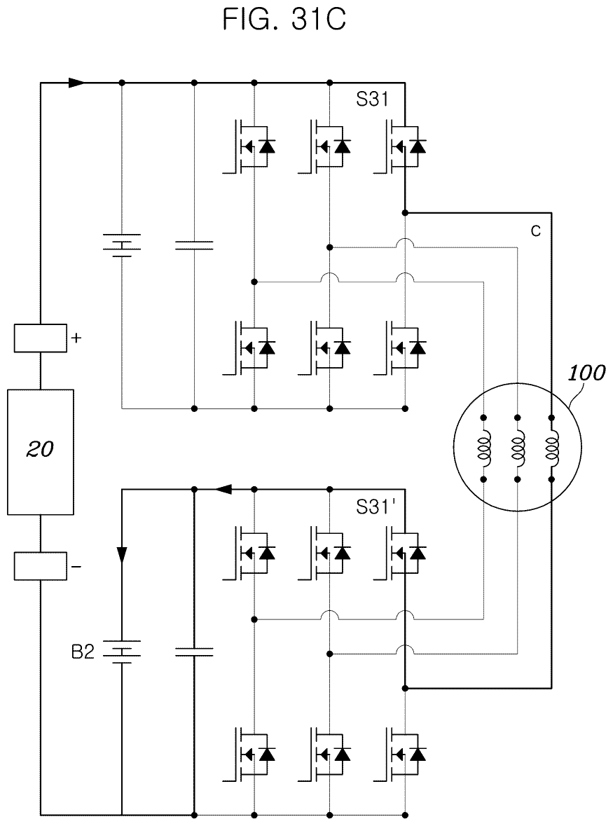

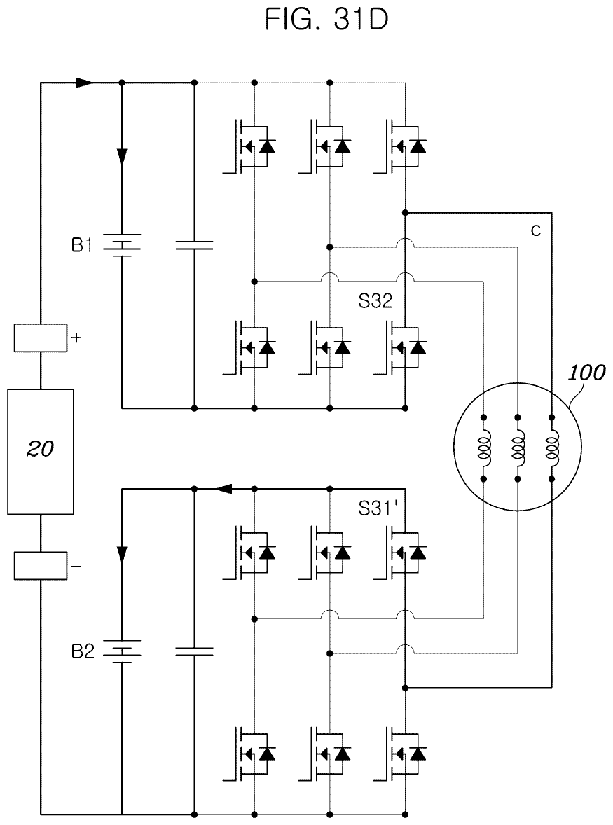

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, a turn-on state of the top switching element S31 of the first inverter 210 and the top switching element S31′ of the second inverter 220, and a turn-on state of the bottom switching element S32 of the first inverter 210 and the top switching element S31′ of the second inverter 220 are repeated, and thus the third phase c charges the first battery B1 and the second battery B2 in equal proportions, as illustrated in FIG. 31A, FIG. 31B, FIG. 31C and FIG. 31D.

According to the above control, even if the charging conditions of the first battery B1 and the second battery B2 are different, both the first battery B1 and the second battery B2 can be charged by switching only eight elements per cycle.

### Charging Scenario 3-4

In this case, the controller 300 may control the switching states of the first inverter 210 and the second inverter 220 such that the first phase a, the second phase b, and the third phase c charge both the first battery B1 and the second battery B2, the first phase a and the second phase b charge the first battery B1 in a greater proportion than the proportion of charging the second battery B2, and the third phase c charges the first battery B1 and the second battery B2 in equal proportions when the condition according to mathematical expression 11 below is satisfied.

### Mathematical Expression 11

$$( ( {V}_{max} + {dV}_{1} - {V}_{2} ) / ( {dV}_{max} - {dV}_{1} + {V}_{2} ) ) {P}_{2}^{*} \leq {P}_{1}^{*} < ( {V}_{1} / ( {V}_{max} - {V}_{1} ) ) {P}_{2}^{*}$$

Here, P₁* is the first charging power, P₂* is the second charging power, (Vₘₐₓ+dV₁−V₂)/(dVₘₐₓ−dV₁+V₂) and V₁/(Vₘₐₓ−V₁) are voltage parameters for the second charging power, Vₘₐₓ is the maximum charging voltage, V₁ is the voltage of the first battery, V₂ is the voltage of the second battery, and d is a constant. For example, d is “2”.

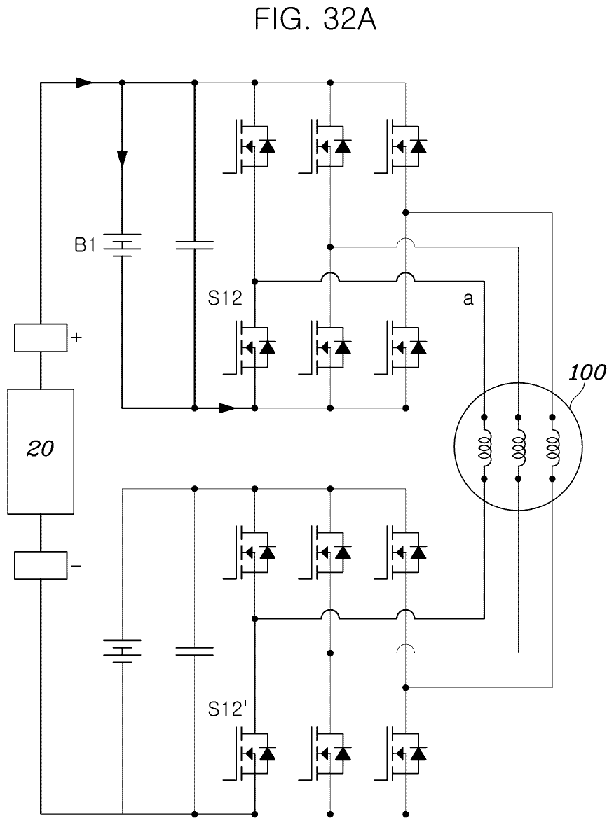

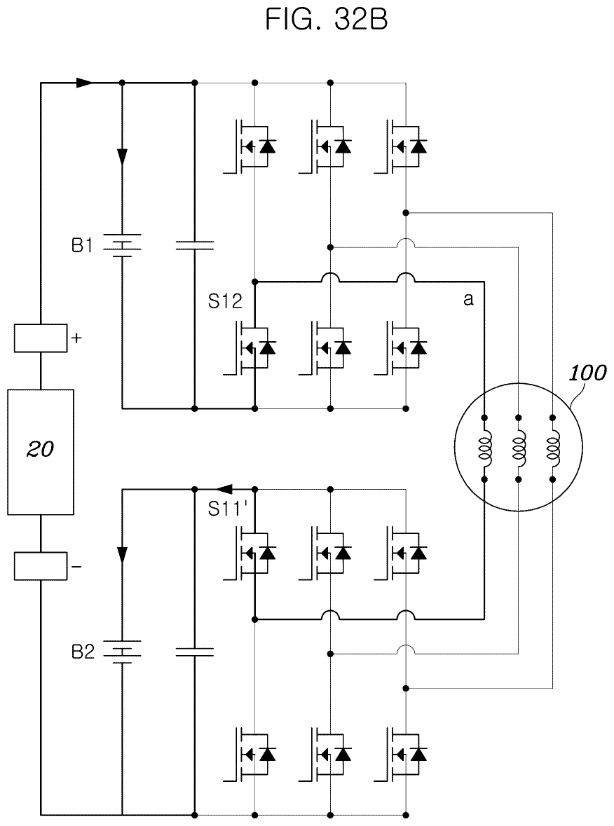

The switching state control method for this case is illustrated in FIG. 32A to FIG. 34D.

The controller 300 may control the switching states such that turn-on of the bottom switching element S12 of the first inverter 210 is maintained, and the top switching element S11′ and the bottom switching element S12′ of the second inverter 220 are turned on and turned off complementarily, and thus the first phase a charges both the first battery B1 and the second battery B2 with the proportion of charging the first battery B1 being greater than the proportion of charging the second battery B2, as illustrated in FIG. 32A and FIG. 32B.

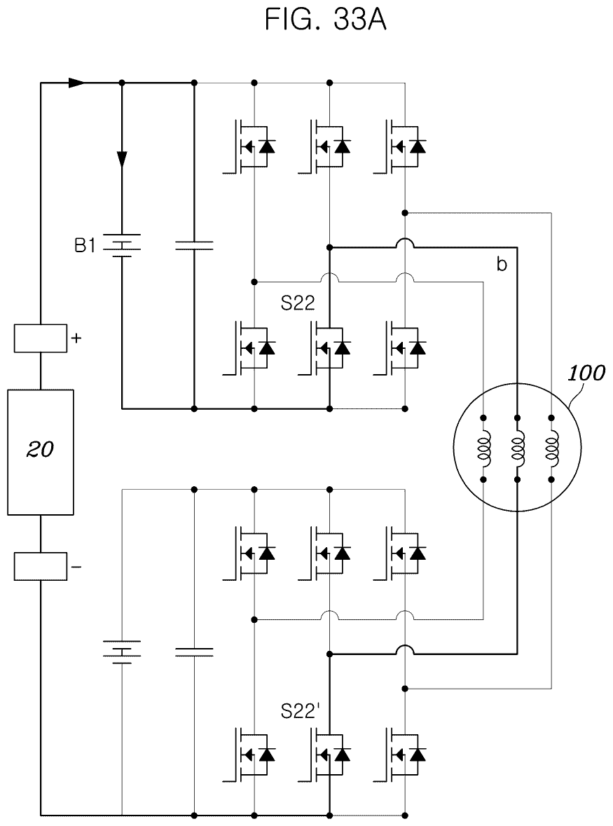

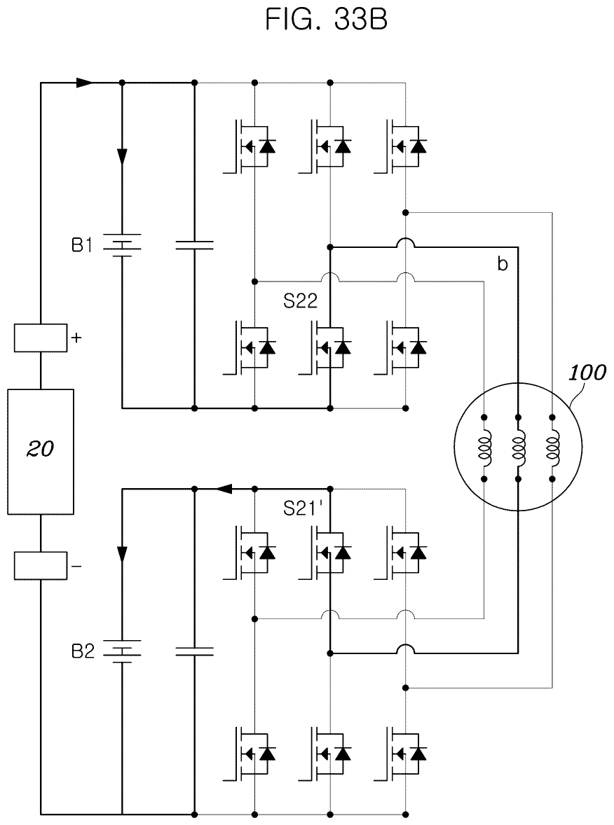

The controller 300 may control the switching states such that turn-on of the bottom switching element S22 of the first inverter 210 is maintained, and the top switching element S21′ and the bottom switching element S22′ of the second inverter 220 are turned on and turned off complementarily, and thus the second phase b charges both the first battery B1 and the second battery B2 with the proportion of charging the first battery B1 being greater than the proportion of charging the second battery B2, as illustrated in FIG. 33A and FIG. 33B.

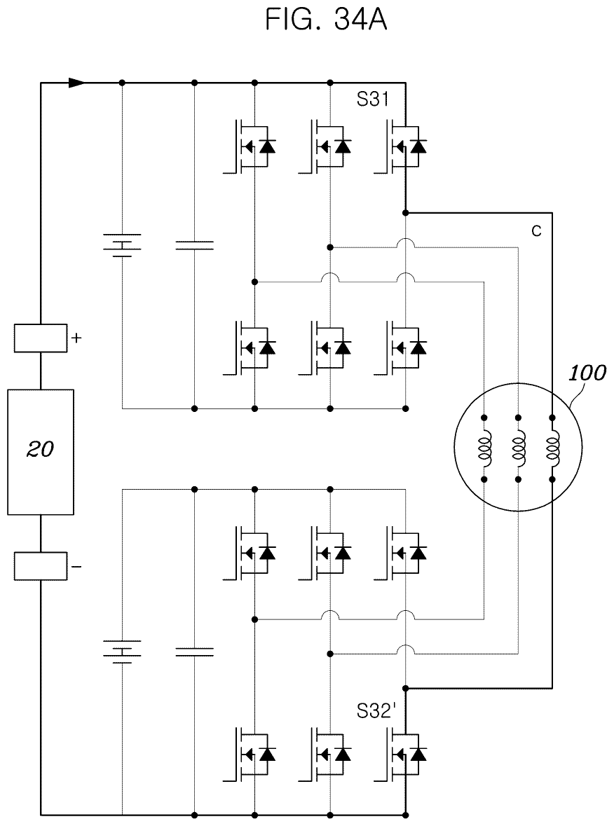

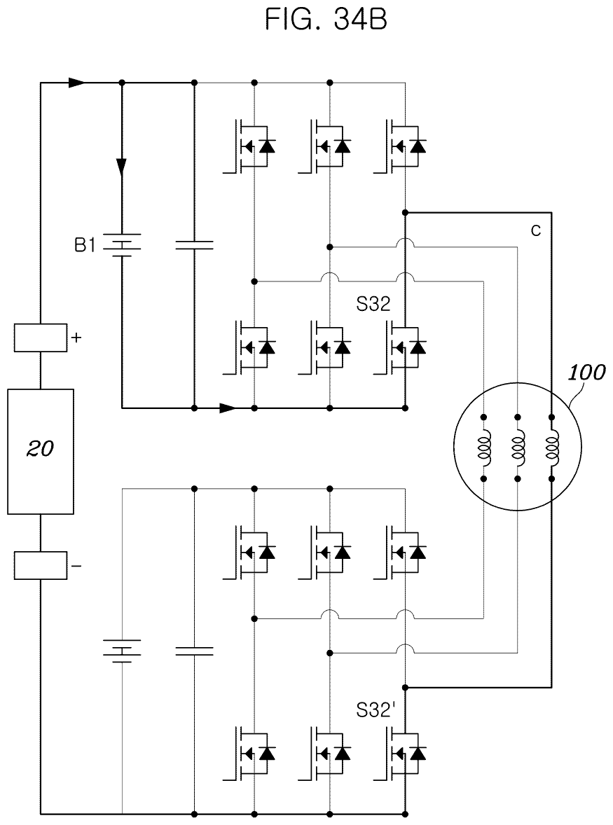

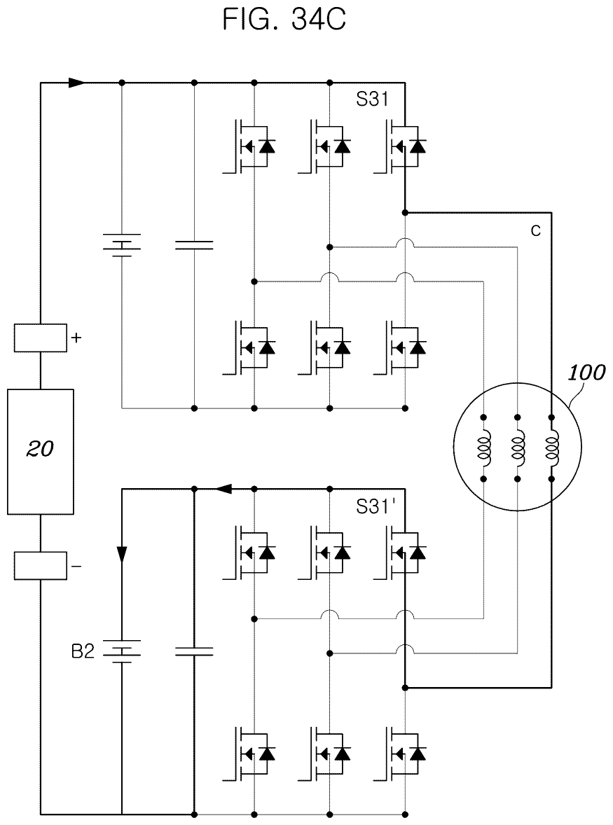

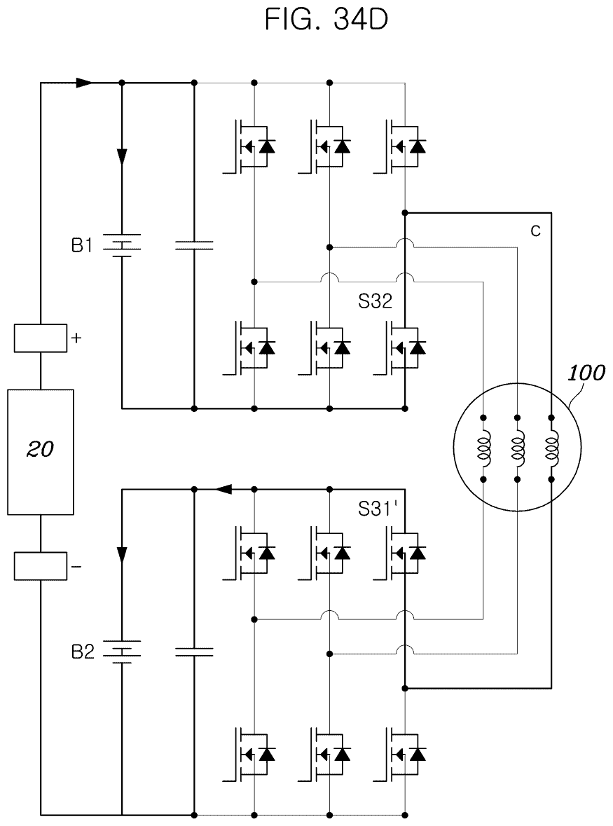

The controller 300 may control the switching states such that a turn-on state of the top switching element S31 of the first inverter 210 and the bottom switching element S32′ of the second inverter 220, a turn-on state of the bottom switching element S32 of the first inverter 210 and the bottom switching element S32′ of the second inverter 220, a turn-on state of the top switching element S31 of the first inverter 210 and the top switching element S31′ of the second inverter 220, and a turn-on state of the bottom switching element S32 of the first inverter 210 and the top switching element S31′ of the second inverter 220 are repeated, and thus the third phase c charges the first battery B1 and the second battery B2 in equal proportions, as illustrated in FIG. 34A, FIG. 34B, FIG. 34C and FIG. 34D.

According to the above control, even if the charging conditions of the first battery B1 and the second battery B2 are different, both the first battery B1 and the second battery B2 can be charged by switching only eight elements per cycle.

### Charging Scenario 3-5

In this case, the controller 300 may control the switching states of the first inverter 210 and the second inverter 220 such that the first phase a, the second phase b, and the third phase c charge both the first battery B1 and the second battery B2 with the proportion of charging the first battery B1 being greater than the proportion of charging the second battery B2 when the condition according to mathematical expression 12 below is satisfied.

### Mathematical Expression 12

$$( {V}_{1} / ( {V}_{max} - {V}_{1} ) ) {P}_{2}^{*} \leq {P}_{1}^{*}$$

Here, P₁* is the first charging power, P₂* is the second charging power, V₁/(Vₘₐₓ−V₁) is a voltage parameter for the second charging power, Vₘₐₓ is the maximum charging voltage, V₁ is the voltage of the first battery, and V₂ is the voltage of the second battery.

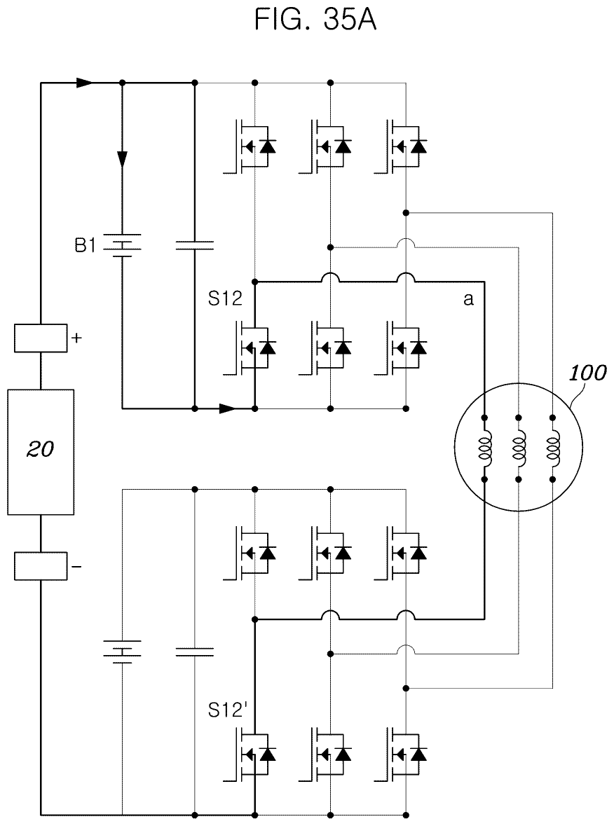

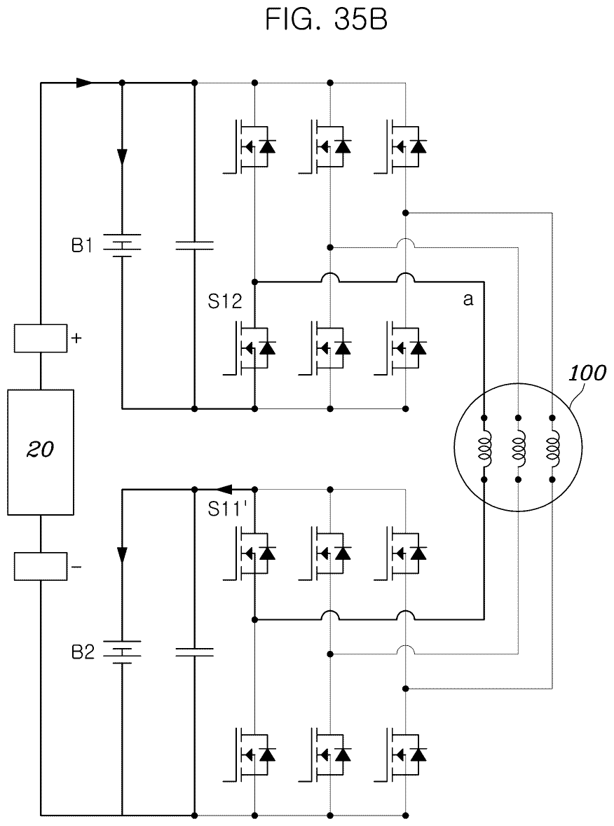

The switching state control method for this case is illustrated in FIG. 35A to FIG. 37B.

The controller 300 may control the switching states such that turn-on of the bottom switching element S12 of the first inverter 210 is maintained, and turn-on and turn-off of the top switching element S11′ and the bottom switching element S12′ of the second inverter 220 are maintained, and thus the first phase a charges both the first battery B1 and the second battery B2 with the proportion of charging the first battery B1 being greater than the proportion of charging the second battery B2, as illustrated in FIG. 35A and FIG. 35B.

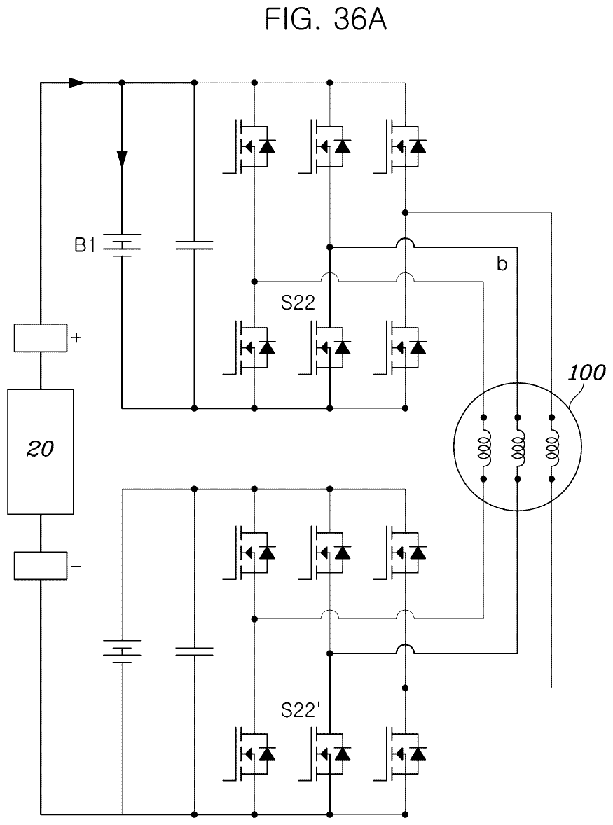

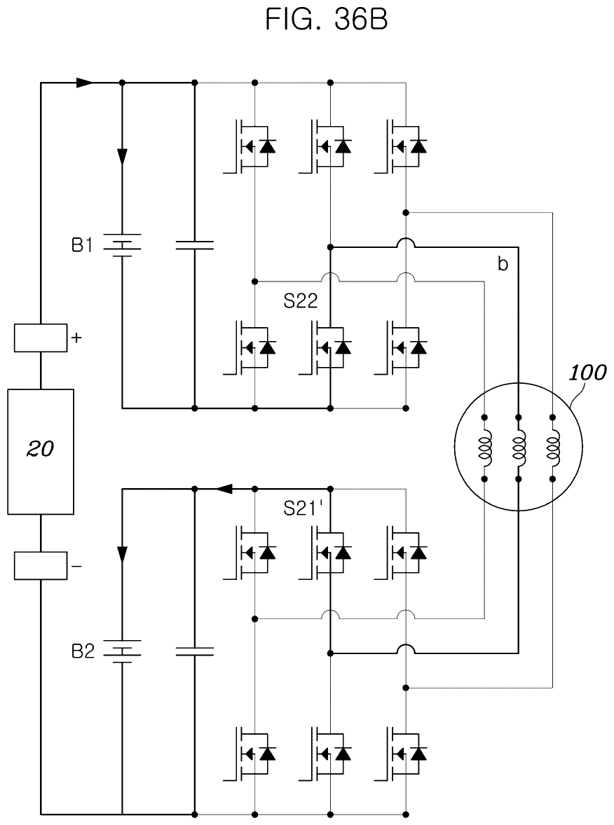

The controller 300 may control the switching states such that turn-on of the bottom switching element S22 of the first inverter 210 is maintained, and the top switching element S21′ and the bottom switching element S22′ of the second inverter 220 are turned on and turned off complementarily, and thus the second phase b charges both the first battery B1 and the second battery B2 with the proportion of charging the first battery B1 being greater than the proportion of charging the second battery B2, as illustrated in FIG. 36A and FIG. 36B.

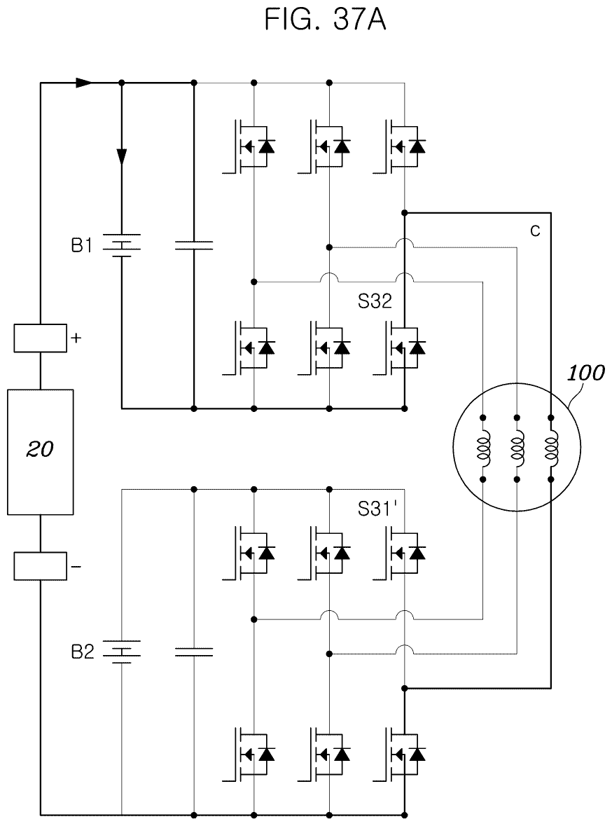

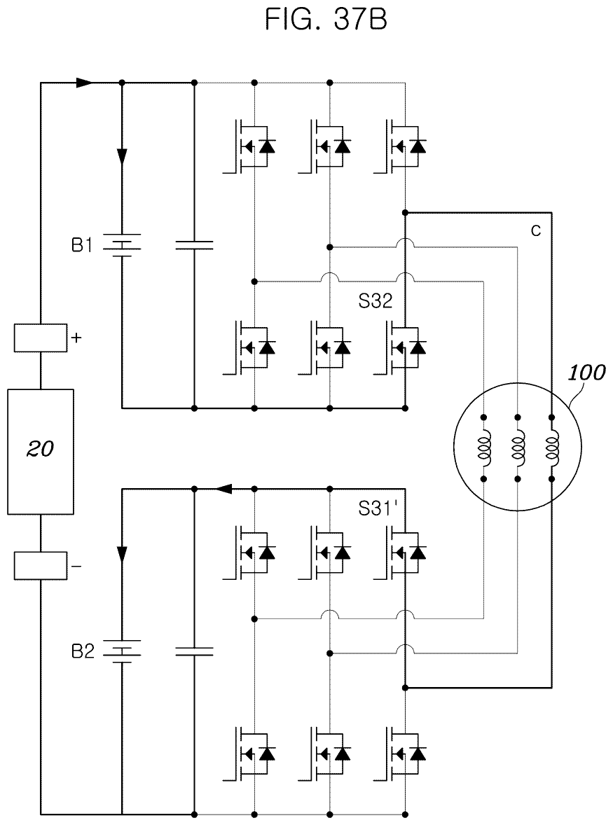

The controller 300 may control the switching states such that turn-on of the bottom switching element S32 of the first inverter 210 is maintained, and the top switching element S31′ and the bottom switching element S32′ of the second inverter 220 are turned on and turned off complementarily, and thus the third phase c charges both the first battery B1 and the second battery B2 with the proportion of charging the first battery B1 being greater than the proportion of charging the second battery B2, as illustrated in FIG. 37A and FIG. 37B.

According to the above control, even if the charging conditions of the first battery B1 and the second battery B2 are different, both the first battery B1 and the second battery B2 can be charged by switching only six elements per cycle.

### Charging Scenario 4

The controller 300 may control the switching states of the first inverter 210 and the second inverter 220 based on the charging current command of each of the first battery B1 and the second battery B2 when both the voltage of the first battery B1 and the voltage of the second battery B2 are equal to or lower than the maximum charging voltage and the sum of the voltage of the first battery B1 and the voltage of the second battery B2 is equal to or lower than the maximum charging voltage.

### Charging Scenario 4-1

In this case, when the value of the charging current command of the first battery B1 is equal to or greater than the value of the charging current command of the second battery B2, the controller 300 may control the switching states of the first inverter 210 and the second inverter 220 such that the first phase a, the second phase b, and the third phase c charge both the first battery B1 and the second battery B2 with the proportion of charging the first battery B1 being greater than the proportion of charging the second battery B2.

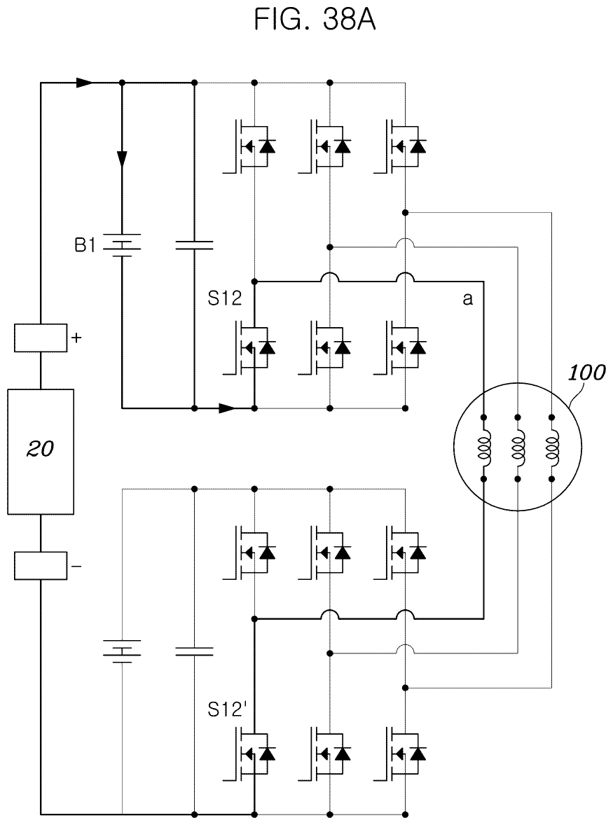

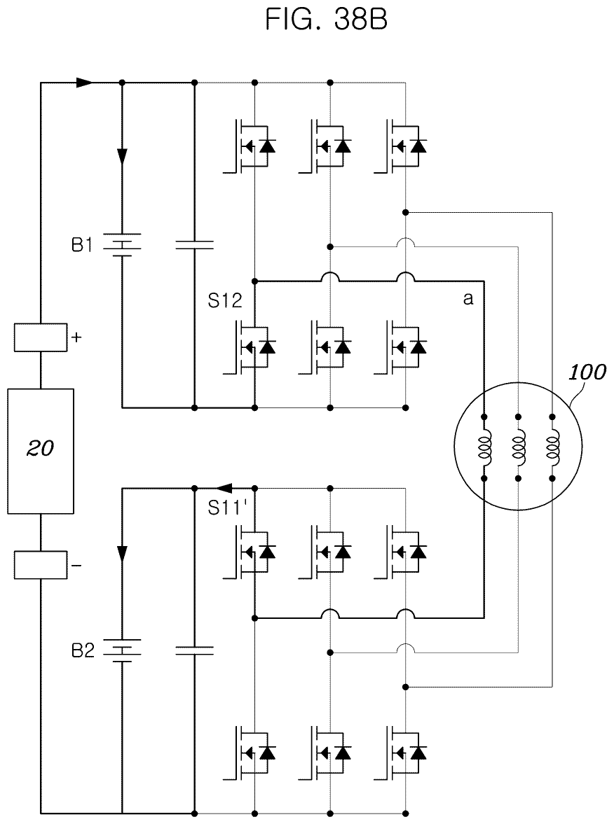

The switching state control method for this case is illustrated in FIG. 38A to FIG. 40B.

The controller 300 may control the switching states such that turn-on of the bottom switching element S12 of the first inverter 210 is maintained and turn-on and turn-off of the top switching element S11′ and the bottom switching element S12′ of the second inverter 220 are maintained, and thus the first phase a charges both the first battery B1 and the second battery B2 with the proportion of charging the first battery B1 being greater than the proportion of charging the second battery B2, as illustrated in FIG. 38A and FIG. 38B.

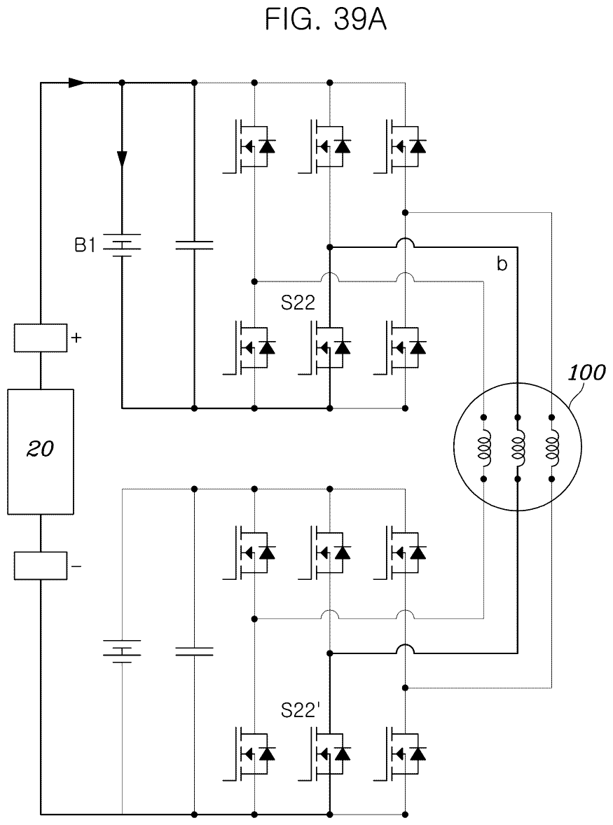

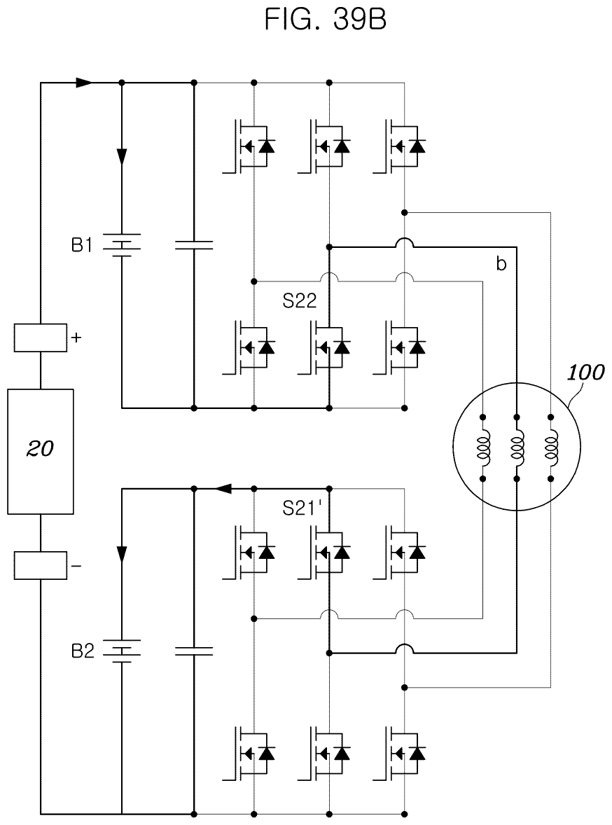

The controller 300 may control the switching states such that turn-on of the bottom switching element S22 of the first inverter 210 is maintained, and the top switching element S21′ and the bottom switching element S22′ of the second inverter 220 are turned on and turned off complimentarily, and thus the second phase b charges both the first battery B1 and the second battery B2 with the proportion of charging the first battery B1 being greater than the proportion of charging the second battery B2, as illustrated in FIG. 39A and FIG. 39B.

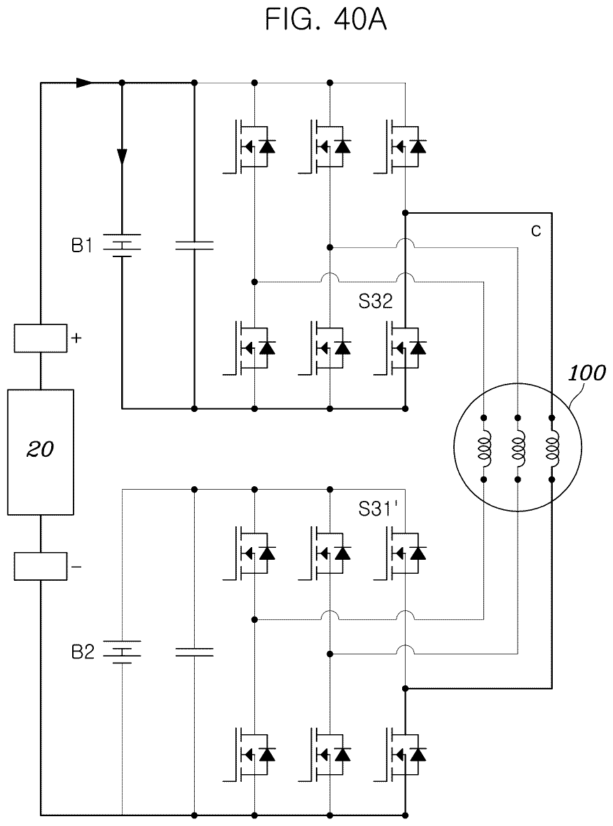

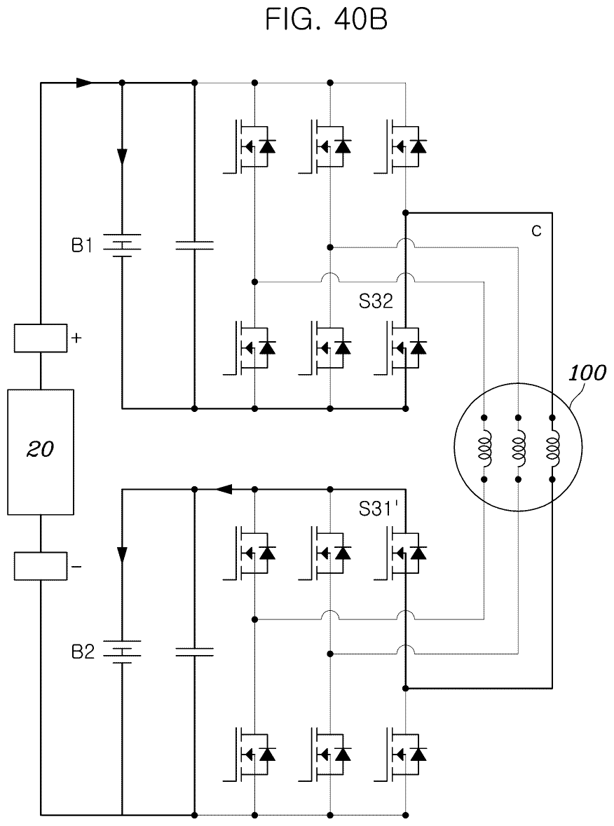

The controller 300 may control the switching states such that turn-on of the bottom switching element S32 of the first inverter 210 is maintained, and the top switching element S31′ and the bottom switching element S32′ of the second inverter 220 are turned on and turned off complimentarily, and thus the third phase c charges both the first battery B1 and the second battery B2 with the proportion of charging the first battery B1 being greater than the proportion of charging the second battery B2, as illustrated in FIG. 40A and FIG. 40B.

According to the above control, even if the charging conditions of the first battery B1 and the second battery B2 are different, both the first battery B1 and the second battery B2 can be charged by switching only six elements per cycle.

### Charging Scenario 4-2

In this case, when the value of the charging current command of the first battery B1 is less than the value of the charging current command of the second battery B2, the controller 300 may control the switching states of the first inverter 210 and the second inverter 220 such that the first phase a, the second phase b, and the third phase c charge both the first battery B1 and the second battery B2 with the proportion of charging the second battery B2 being greater than the proportion of charging the first battery B1.

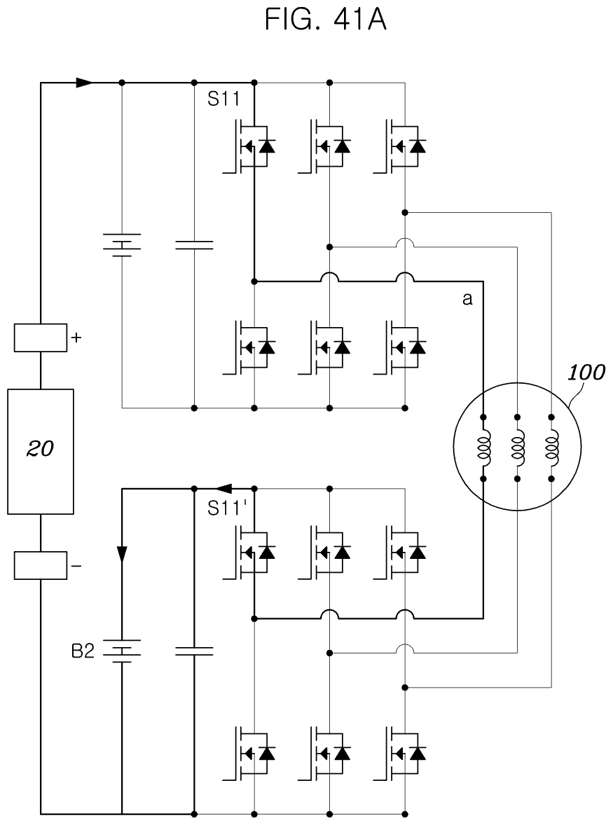

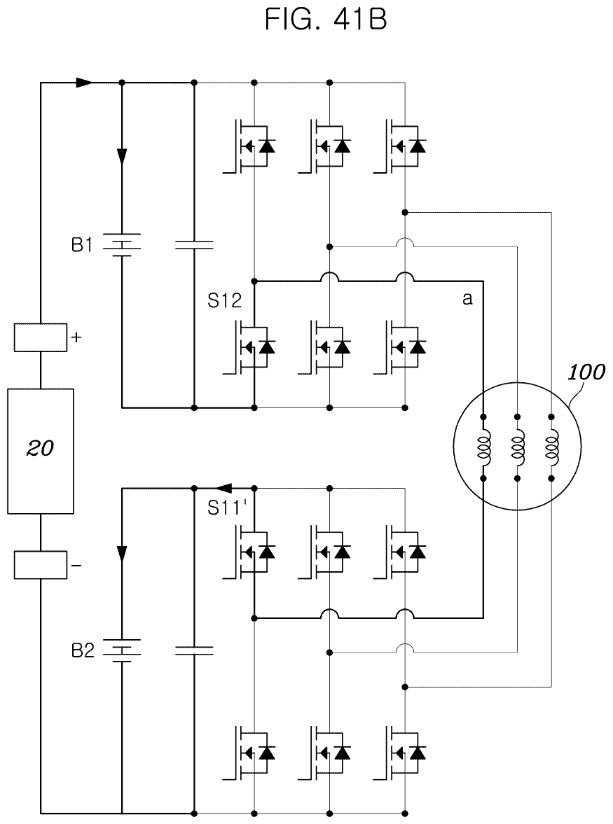

The switching state control method for this case is illustrated in FIG. 41A to FIG. 43B.

The controller 300 may control the switching states such that the top switching element S11 and the bottom switching element S12 of the first inverter 210 are turned on and turned off complimentarily, and turn-on of the top switching element S11′ of the second inverter 220 is maintained, and thus the first phase a charges both the first battery B1 and the second battery B2 with the proportion of charging the second battery B2 being greater than the proportion of charging the first battery B1, as illustrated in FIG. 41A and FIG. 41B.

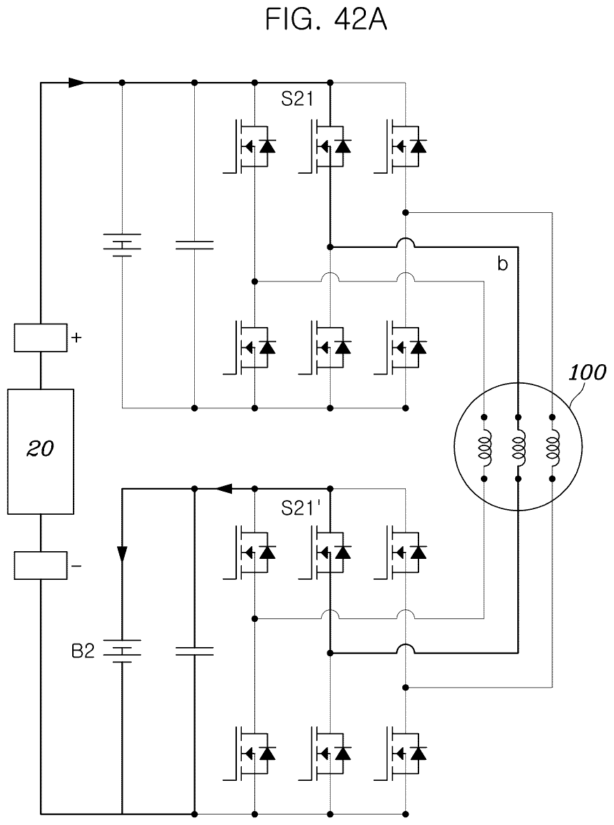

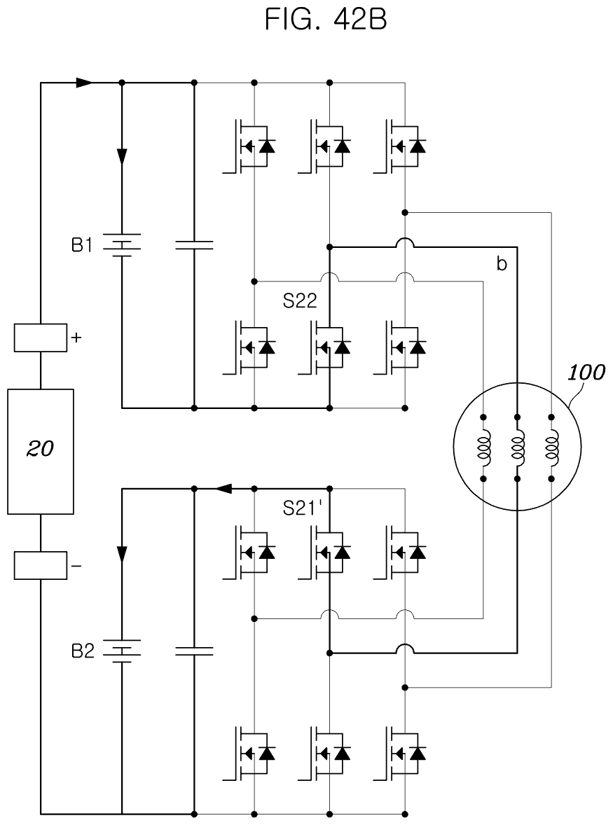

The controller 300 may control the switching states such that the top switching element S21 and the bottom switching element S22 of the first inverter 210 are turned on and turned off complimentarily, and turn-on of the top switching element S21′ of the second inverter 220 is maintained, and thus the second phase b charges both the first battery B1 and the second battery B2 with the proportion of charging the second battery B2 being greater than the proportion of charging the first battery B1, as illustrated in FIGS. 42A and 42B.

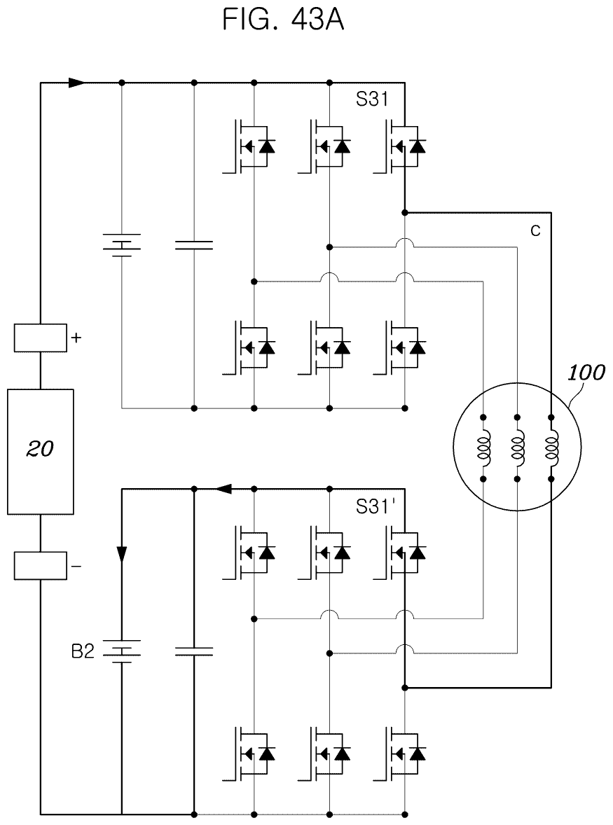

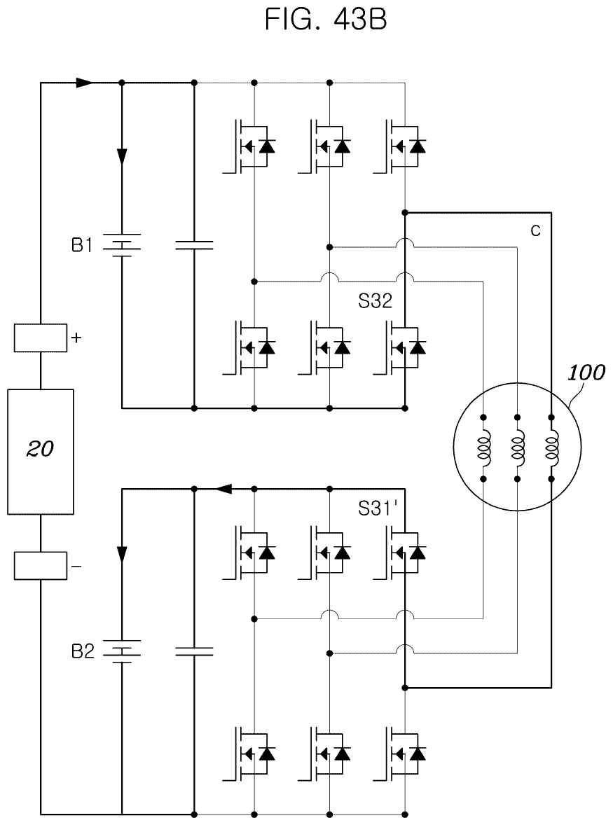

The controller 300 may control the switching states such that the top switching element S31 and the bottom switching element S32 of the first inverter 210 are turned on and turned off complimentarily, and turn-on of the top switching element S31′ of the second inverter 220 is maintained, and thus the third phase c charges both the first battery B1 and the second battery B2 with the proportion of charging the second battery B2 being greater than the proportion of charging the first battery B1, as illustrated in FIGS. 43A and 43B.

According to the above control, even if the charging conditions of the first battery B1 and the second battery B2 are different, both the first battery B1 and the second battery B2 can be charged by switching only six elements per cycle.

According to various embodiments of the present disclosure as described above, (e.g., even) when charging conditions of a plurality of batteries serving as a dual voltage source for an electrified vehicle are different, it is possible to charge (e.g., all of) the plurality of batteries with a single power source.

Furthermore, in various charging scenarios according to the charging conditions of the plurality of batteries, battery charging may be performed with (e.g., optimal) efficiency.

The effects that can be obtained from the present disclosure are not limited to the effects mentioned above, and other effects that are not mentioned may be understood by those skilled in the art from the description herein.

Although the present disclosure has been illustrated and described with respect to specific embodiments as described above, it will be apparent to those skilled in the art that the present disclosure can be improved and changed in various manners without departing from the technical spirit of the present disclosure provided by the claims.

What is claimed is:

1. An electrified vehicle comprising:
a motor including a plurality of windings corresponding to a first phase, a second phase, and a third phase;
a first inverter including a first DC link and a plurality of legs connected to one end of each of the plurality of windings;
a second inverter including a second DC link and a plurality of legs connected to the other end of each of the plurality of windings;
a first battery and a second battery respectively connected to the first DC link and the second DC link;
a charging terminal including one electrode connected to a corresponding electrode of the first DC link and another electrode connected to a corresponding electrode of the second DC link; and
a controller configured to control switching states of the first inverter and the second inverter based on a maximum charging voltage applicable to the charging terminal and at least one of voltages and charging current commands of the first battery and the second battery, and such that the first battery and the second battery are charged.

2. The electrified vehicle of claim 1, wherein the controller is configured to control the switching states of the first inverter and the second inverter based on relationships between the maximum charging voltage and the voltages of the first battery and the second battery.

3. The electrified vehicle of claim 2, wherein the controller is configured to control the switching states based on a first charging power of the first battery, a second charging power of the second battery, and a constant for the second charging power when both the voltages of the first battery and the second battery are equal to or higher than the maximum charging voltage,
wherein the first charging power is determined based on the voltage and charging current command of the first battery, and the second charging power is determined based on the voltage and charging current command of the second battery.

4. The electrified vehicle of claim 3, wherein the controller is configured to control the switching states such that the first phase and the second phase charge only the second battery, and the third phase charges the first battery and the second battery in equal proportions when a condition expressed by
$${P}_{1}^{*} < {P}_{2}^{*} / a$$
is satisfied, wherein P₁* is the first charging power, P₂* is the second charging power, and a is a constant for the second charging power.

5. The electrified vehicle of claim 3, wherein the controller is configured to control the switching state such that the first phase charges only the first battery, the second phase charges only the second battery, and the third phase charges the first battery and the second battery in equal proportions when a condition expressed by
$${P}_{2}^{*} / a \leq {P}_{1}^{*} < {aP}_{2}^{*}$$
is satisfied, wherein P₁* is the first charging power, P₂* is the second charging power, and a is a constant for the second charging power.

6. The electrified vehicle of claim 3, wherein the controller is configured to control the switching states such that the first phase and the second phase charge only the first battery, and the third phase charges the first battery and the second battery in equal proportions when a condition expressed by
$${aP}_{2}^{*} \leq {P}_{1}^{*}$$
is satisfied, wherein P₁* is the first charging power, P₂* is the second charging power, and a is a constant for the second charging power.

7. The electrified vehicle of claim 2, wherein the controller is configured to control the switching states based on the first charging power of the first battery, the second charging power of the second battery, and a voltage parameter for the second charging power when the voltage of the first battery is equal to or higher than the maximum charging voltage and the voltage of the second battery is less than the maximum charging voltage,
wherein the first charging power is determined based on the voltage and charging current command of the first battery, and the second charging power is determined based on the voltage and charging current command of the second battery.

8. The electrified vehicle of claim 7, wherein the controller is configured to control the switching states such that the first phase, the second phase, and the third phase charge both the first battery and the second battery with a proportion of charging the second battery being greater than a proportion of charging the first battery when a condition expressed by
$${P}_{1}^{*} < ( ( {V}_{max} - {V}_{2} ) / {V}_{2} ) {P}_{2}^{*}$$
is satisfied, wherein P₁* is the first charging power, P₂* is the second charging power, (Vₘₐₓ−V₂)/V₂ is the voltage parameter for the second charging power, Vₘₐₓ is the maximum charging voltage, and V₂ is the voltage of the second battery.

9. The electrified vehicle of claim 7, wherein the controller is configured to control the switching states such that the first phase, the second phase, and the third phase charge both the first battery and the second battery, the first phase and the second phase charge the second battery in a greater proportion than a proportion of charging the first battery, and the third phase charges the first battery and the second battery in equal proportions when a condition expressed by
$$( ( {V}_{max} - {V}_{2} ) / {V}_{2} ) {P}_{2}^{*} \leq {P}_{1}^{*} < ( ( {bV}_{max} - {V}_{2} ) / {V}_{2} ) {P}_{2}^{*}$$
is satisfied, wherein P₁* is the first charging power, P₂* is the second charging power, (Vₘₐₓ−V₂)/V₂ and (bVₘₐₓ−V₂)/V₂ are voltage parameters for the second charging power, Vₘₐₓ is the maximum charging voltage, V₂ is the voltage of the second battery, and b is a constant.

10. The electrified vehicle of claim 7, wherein the controller is configured to control the switching states such that the first phase charges only the first battery, the second phase and the third phase charge both the first battery and the second battery, the second phase charges the second battery in a greater proportion than a proportion of charging the first battery, and the third phase charges the first battery and the second battery in equal proportions when a condition expressed by
$$( ( {bV}_{max} - {V}_{2} ) / {V}_{2} ) {P}_{2}^{*} \leq {P}_{1}^{*} < ( ( {cV}_{max} - {V}_{2} ) / {V}_{2} ) {P}_{2}^{*}$$
is satisfied, wherein P₁* is the first charging power, P₂* is the second charging power, (bVₘₐₓ−V₂)/V₂ and (cVₘₐₓ−V₂)/V₂ are voltage parameters for the second charging power, Vₘₐₓ is the maximum charging voltage, V₂ is the voltage of the second battery, b and c are constants, and c is a value greater than b.

11. The electrified vehicle of claim 7, wherein the controller is configured to control the switching states such that the first phase and the second phase charge only the first battery, and the third phase charges the first battery and the second battery in equal proportions when a condition expressed by
$$( ( {cV}_{max} - {V}_{2} ) / {V}_{2} ) {P}_{2}^{*} \leq {P}_{1}^{*}$$
is satisfied, wherein P₁* is the first charging power, P₂* is the second charging power, (cVₘₐₓ−V₂)/V₂ is voltage parameters for the second charging power, Vₘₐₓ is the maximum charging voltage, V₂ is the voltage of the second battery, and c is a constant.

12. The electrified vehicle of claim 2, wherein the controller is configured to control the switching states based on the first charging power of the first battery, the second charging power of the second battery, and a voltage parameter for the second charging power when both the voltage of the first battery and the voltage of the second battery are equal to or less than the maximum charging voltage, and a sum of the voltages of the first battery and the second battery is equal to or higher than the maximum charging voltage,
wherein the first charging power is determined based on the voltage and charging current command of the first battery, and the second charging power is determined based on the voltage and charging current command of the second battery.

13. The electrified vehicle of claim 12, wherein the controller is configured to control the switching states such that the first phase, the second phase, and the third phase charge both the first battery and the second battery with a proportion of charging the second battery being greater than a proportion of charging the first battery when a condition expressed by
$${P}_{1}^{*} < ( ( {V}_{max} - {V}_{2} ) / {V}_{2} ) {P}_{2}^{*}$$
is satisfied, wherein P₁* is the first charging power, P₂* is the second charging power, (Vₘₐₓ−V₂)/V₂ is a voltage parameter for the second charging power, Vₘₐₓ is the maximum charging voltage, and V₂ is the voltage of the second battery.

14. The electrified vehicle of claim 12, wherein the controller is configured to control the switching states such that the first phase, the second phase, and the third phase charge both the first battery and the second battery, the first phase and the second phase charge the second battery in a greater proportion than a proportion of charging the first battery, and the third phase charges the first battery and the second battery in equal proportions when a condition expressed by
$$( ( {V}_{max} - {V}_{2} ) / {V}_{2} ) {P}_{2}^{*} \leq {P}_{1}^{*} < ( ( {dV}_{max} + {V}_{1} - {dV}_{2} ) / ( {V}_{max} - {V}_{1} + {dV}_{2} ) ) {P}_{2}^{*}$$
is satisfied, wherein P₁* is the first charging power, P₂* is the second charging power, (Vₘₐₓ−V₂)/V₂ and (dVₘₐₓ+V₁−dV₂)/(Vₘₐₓ−V₁+dV₂) are voltage parameters for the second charging power, Vₘₐₓ is the maximum charging voltage, V₁ is the voltage of the first battery, V₂ is the voltage of the second battery, and d is a constant.

15. The electrified vehicle of claim 12, wherein the controller is configured to control the switching states such that the first phase, the second phase, and the third phase charge both the first battery and the second battery, the first phase charges the second battery in a greater proportion than a proportion of charging the first battery, the second phase charges the first battery in a greater proportion than a proportion of charging the second battery, and the third phase charges the first battery and the second battery in equal proportions when a condition expressed by
$$( ( {dV}_{max} + {V}_{1} - {dV}_{2} ) / ( {V}_{max} - {V}_{1} + {dV}_{2} ) ) {P}_{2}^{*} \leq {P}_{{1}^{*}} < ( ( {V}_{max} + {dV}_{1} - {V}_{2} ) / ( {dV}_{max} - {dV}_{1} + {V}_{2} ) ) {P}_{2}^{*}$$
is satisfied, wherein P₁* is the first charging power, P₂* is the second charging power, (dVₘₐₓ+V₁−dV₂)/(Vₘₐₓ−V₁+dV₂) and (Vₘₐₓ+dV₁−V₂)/(dVₘₐₓ−dV₁+V₂) are voltage parameters for the second charging power, Vₘₐₓ is the maximum charging voltage, V₁ is the voltage of the first battery, V₂ is the voltage of the second battery, and d is a constant.

16. The electrified vehicle of claim 12, wherein the controller is configured to control the switching states such that the first phase, the second phase, and the third phase charge both the first battery and the second battery are charged, the first phase and the second phase charge the first battery in a greater proportion than a proportion of charging the second battery, and the third phase charges the first battery and the second battery in equal proportions when a condition expressed by
$$( ( {V}_{max} + {dV}_{1} - {V}_{2} ) / ( {dV}_{max} - {dV}_{1} + {V}_{2} ) ) {P}_{2}^{*} \leq {P}_{1}^{*} < ( {V}_{1} / ( {V}_{max} - {V}_{1} ) ) {P}_{2}^{*}$$
is satisfied, wherein P₁* is the first charging power, P₂* is the second charging power, (Vₘₐₓ+dV₁−V₂)/(dVₘₐₓ−dV₁+V₂) and V₁/(Vₘₐₓ−V₁) are voltage parameters for the second charging power, Vₘₐₓ is the maximum charging voltage, V₁ is the voltage of the first battery, V₂ is the voltage of the second battery, and d is a constant.

17. The electrified vehicle of claim 12, wherein the controller is configured to control the switching states such that the first phase, the second phase, and the third phase charge both the first battery and the second battery with a proportion of charging the first battery being greater than a proportion of charging the second battery when a condition expressed by
$$( {V}_{1} / ( {V}_{max} - {V}_{1} ) ) {P}_{2}^{*} \leq {P}_{1}^{*}$$
is satisfied, wherein P₁* is the first charging power, P₂* is the second charging power, V₁/(Vₘₐₓ−V₁) is a voltage parameter for the second charging power, Vₘₐₓ is the maximum charging voltage, V₁ is the voltage of the first battery, and V₂ is the voltage of the second battery.

18. The electrified vehicle of claim 2, wherein the controller is configured to control the switching states based on the charging current commands of the first battery and the second battery when both the voltage of the first battery and the voltage of the second battery are equal to or less than the maximum charging voltage, and a sum of the voltage of the first battery and the voltage of the second battery is equal to or less than the maximum charging voltage.

19. The electrified vehicle of claim 18, wherein the controller is configured to control the switching states such that the first phase, the second phase, and the third phase charge both the first battery and the second battery with a proportion of charging the first battery being greater than a proportion of charging the second battery when a value of the charging current command of the first battery is equal to or greater than a value of the charging current command of the second battery.

20. The electrified vehicle of claim 18, wherein the controller is configured to control the switching states such that the first phase, the second phase, and the third phase charge both the first battery and the second battery with a proportion of charging the second battery being greater than a proportion of charging the first battery when a value of the charging current command of the first battery is less than a value of the charging current command of the second battery.
